(19) United States
(12) Patent Application Publication
(10) Pub. No.: US 2025/0047343 A1
(43) Pub. Date: Feb. 6, 2025

(54) COMMUNICATION APPARATUS AND COMMUNICATION METHOD FOR PARTIAL CHANNEL STATE INFORMATION FEEDBACK

(71) Applicant: Panasonic Intellectual Property Corporation of America, Torrance, CA (US)

(72) Inventors: Rojan CHITRAKAR, Singapore (SG); Yoshio URABE, Nara (JP)

(21) Appl. No.: 18/704,238

(22) PCT Filed: Oct. 6, 2022
(86) PCT No.: PCT/SG2022/050716

§ 371 Date: Apr. 24, 2024

(30) Foreign Application Priority Data
Nov. 5, 2021 (SG) 10202112324U
Nov. 30, 2021 (SG) 10202113336U

(51) Int. Cl. H04B 7/06; H04W 24/10

(52) U.S. Cl. CPC H04B 7/0626; H04W 24/10

(57) ABSTRACT

The present disclosure provides communication apparatuses and methods for partial channel state information (CSI) feedback, the communication apparatus comprising: a receiver, which in operation, receives a measurement signal; circuitry, which in operation, is configured to measure CSI of the received measurement signal; and a transmitter, which in operation, transmits a report frame including information of a sub-component of the CSI.

### TECHNICAL FIELD

The present embodiments generally relate to communication apparatuses and methods for wireless local area network sensing, and more particularly relate to methods and apparatuses for initiating and/or reporting partial channel state information feedback.

### BACKGROUND

Channel state information (CSI), that is, the channel measured during the training symbols of a received physical protocol data unit (PPDU) is a type of sensing measurement result for sub-7 GHz wireless local area network (WLAN) sensing. Recent contributions in 802.11bf proposed to simply 802.11n channel state information (CSI) quantization scheme in order to simplify the implementation complexity and/or to reduce CSI reporting signaling overhead.

However, the overhead of CSI feedback, as compared to compressed beamforming feedback, can be as big as 41%-68% higher).

There is thus a need for a communication apparatus and a communication method for partial channel state information feedback to further reduce the overhead of CSI feedback in a format suitable for the needs of wireless local area network sensing application. Furthermore, other desirable features and characteristics will become apparent from the subsequent detailed description and the appended claims, taken in conjunction with the accompanying drawings and this background of the disclosure.

### SUMMARY

Non-limiting and exemplary embodiments facilitate providing communication apparatuses and communication methods for partial CSI feedback.

In a first aspect, the present disclosure provides a reporting communication apparatus comprising: a receiver, which in operation, receives a measurement signal; circuitry, which in operation, is configured to measure channel state information (CSI) of the received measurement signal; and a transmitter, which in operation, transmits a report frame carrying partial CSI (i.e., information of a sub-component of the CSI).

In a second aspect, the present disclosure provides a reporting communication method comprising: measuring channel state information of a measurement signal received from an initiating communication apparatus; and transmitting a report frame carrying partial CSI (i.e., information of a sub-component of the CSI) to the initiating communication apparatus.

In a third aspect, the present disclosure provides an initiating communication apparatus comprising: circuitry, which in operation, generates a frame carrying a report type indication indicating a sub-component of a CSI to a reporting communication apparatus; and a receiver, which in operation, receives a report frame carrying information of the sub-component of the CSI of a measurement signal from the reporting communication apparatus.

In a fourth aspect, the present disclosure provides an initiating communication method comprising: generating a frame carrying a report type indication indicating a sub-component of a CSI to a reporting communication apparatus; receiving a report frame carrying information of the sub-component of the CSI of a measurement signal from the responding communication apparatus.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to illustrate various embodiments and to explain various principles and advantages in accordance with present embodiments.

FIG. 1 shows magnitude and phase information of a received channel state information (CSI) in 802.11ac 80 MHz channel with two transmitter antennas and two receiver antenna.

FIG. 2 shows a graph illustrating a relationship of magnitude and phase sub-components of CSI information.

FIG. 3A shows a flow chart illustrating a method of transmitting partial channel state information feedback according to various embodiments of the present disclosure.

FIG. 3B shows a flow chart illustrating a method of receiving partial channel state information feedback according to various embodiments of the present disclosure.

FIG. 4 shows a schematic diagram illustrating an example configuration of a communication apparatus in accordance various embodiments of the present disclosure.

FIG. 5 shows a flow diagram illustrating first exemplary communication for obtaining CSI sub-component information according to various embodiments of the present disclosure.

FIG. 6 shows a flow diagram illustrating second exemplary communication for obtaining CSI sub-component information from two Responder STAs according to various embodiments of the present disclosure.

FIG. 7 shows a flow diagram illustrating first exemplary communication for performing sensing measurements to obtain CSI sub-component information according to a first embodiment of the present disclosure.

FIG. 8 shows a flow diagram illustrating second exemplary communication for performing sensing measurements to obtain CSI sub-component information according to the first embodiment of the present disclosure.

FIG. 9 shows an example Sensing Measurement Setup Request frame according to the first embodiment of the present disclosure.

FIG. 10 shows an example Sensing Measurement Setup Response according to the first embodiment of the present disclosure.

FIG. 11 shows an example amplitude matrix code structure according to the first embodiment of the present disclosure.

FIG. 12 shows a graph illustrating a simulation result of amplitude values recovered from CSI of a measurement signal according to the first embodiment of the present disclosure.

FIG. 13 shows a graph illustrating another simulation result of amplitude values recovered from CSI of a measurement signal with higher feedback bit size according to the first embodiment of the present disclosure.

FIG. 14 shows an example phase matrix code structure according to the first embodiment of the present disclosure.

FIG. 15 shows a typical I-Q graph.

FIG. 16 shows a graph illustrating the simulation result of phase values recovered from CSI of a measurement signal according to the first embodiment of the present disclosure.

FIG. 17 shows a graph illustrating another simulation result of phase values recovered from CSI of a measurement signal with higher feedback bit size according to the first embodiment of the present disclosure.

FIG. 18 shows an example Sensing Measurement Report frame according to the first embodiment of the present disclosure

FIG. 19 shows a flow diagram illustrating first exemplary communication for performing sensing measurements to obtain CSI sub-component information according to a second embodiment of the present disclosure.

FIG. 20 shows a flow diagram illustrating second exemplary communication for performing sensing measurements to obtain CSI sub-component information according to the second embodiment of the present disclosure.

FIG. 21 shows an example Sensing NDPA frame according to the second embodiment of the present disclosure.

FIG. 22 shows a graph illustrating a simulation result of amplitude values recovered from CSI of a measurement signal according to the second embodiment of the present disclosure.

FIG. 23 shows a graph illustrating another simulation result of amplitude values recovered from CSI of a measurement signal with higher feedback bit size according to the second embodiment of the present disclosure.

FIG. 24 shows an example phase matrix code structure according to the second embodiment of the present disclosure.

FIG. 25 shows a graph illustrating simulation results of phase values recovered from CSI of a measurement signal with and without scaling according to the second embodiment of the present disclosure

FIG. 26 shows a graph illustrating another simulation result of phase values recovered from CSI of a measurement signal with higher feedback bit size according to the second embodiment of the present disclosure.

FIG. 27 shows a flow diagram illustrating exemplary communication for performing sensing measurements to obtain CSI sub-component information according to a third embodiment of the present disclosure.

FIG. 28A shows an example simplified Q-I lookup table for amplitude and phase sub-components according to the third embodiment of the present disclosure.

FIG. 28B shows another example simplified Q-I lookup table for amplitude and phase sub-components according to the third embodiment of the present disclosure.

FIG. 29 shows an example amplitude lookup table according to the third embodiment of the present disclosure.

FIG. 30 shows a graph illustrating a simulation result of phase values recovered from CSI of a measurement signal using bit shifting according to third embodiment of the present disclosure.

FIG. 31 shows an example phase lookup table according to the third embodiment of the present disclosure.

FIG. 32 shows a graph illustrating a simulation result of phase values recovered from CSI of a measurement signal with simplified bit shifting according to third embodiment of the present disclosure.

FIG. 33 shows an example combined lookup table according to a fourth embodiment of the present disclosure.

FIG. 34 shows an example codebook matrix code structure according to the fourth embodiment of the present disclosure.

FIG. 35 shows an example Sensing Session Setup Request frame for codebook size negotiation according to the fourth embodiment of the present disclosure.

FIG. 36 shows an example Sensing Session Setup Response frame for codebook size negotiation according to the fourth embodiment of the present disclosure.

FIG. 37 shows a flow diagram illustrating exemplary communication for performing trigger-based sensing measurements to obtain CSI sub-component information according to a fifth embodiment of the present disclosure.

FIG. 38 shows a graph illustrating a result of phase values recovered from CSI of a measurement signal plotted according to subcarriers for a 3×3 MIMO system comprising 3 Tx antennas and 3 Rx antennas that has a total of 9 Tx-Rx antenna pairs.

FIG. 39 shows another graph illustrating the same phase values recovered from CSI of the measurement signal of FIG. 38 plotted according to Tx-Rx antenna pair indices in accordance with the embodiment.

FIG. 40 shows an example phase matrix code structure according to the sixth embodiment of the present disclosure.

FIG. 41 shows an example Sensing Measurement Report frame according to the sixth embodiment of the present disclosure.

FIG. 42 shows a graph illustrating a simulation result of quantized phase values of CSI of a measurement signal where scaling per subcarrier is applied according to 802.11n method.

FIG. 43 shows a graph illustrating a simulation result of quantized phase values of CSI of a measurement signal where scaling per Tx-Rx antenna pair is applied according to the sixth embodiment of the present disclosure.

FIG. 44 show a graph illustrating a simulation result of phase values recovered from CSI of a measurement signal and scaled per Tx-Rx pair according to the sixth embodiment of the present disclosure.

FIG. 45 show a graph illustrating a simulation result of phase values recovered from CSI of a measurement signal and scaled per Tx-Rx pair with higher feedback bit size according to the sixth embodiment of the present disclosure.

FIG. 46 shows a graph illustrating results of unwrapped phase sub-components of FIG. 39 according to the embodiment.

FIG. 47 shows a graph illustrating mean values of unwrapped phase values of FIG. 46 and phases differences from the mean values according to the embodiment.

FIG. 48 shows a graph illustrating a simulation result of phase values recovered from CSI of a measurement signal using differential encoding scheme according to the seventh embodiment of the present disclosure.

FIG. 49 shows a graph illustrating another simulation result of phase values recovered from CSI of a measurement signal using differential encoding scheme according to the seventh embodiment of the present disclosure.

FIG. 50 shows a graph illustrating original amplitude values recovered from CSI of a measurement signal per subcarrier.

FIG. 51 shows a graph illustrating of original amplitude values recovered from CSI of a measurement signal per Tx-Rx pair according to the seventh embodiment of the present disclosure.

FIG. 52 shows a configuration of a communication apparatus, for example an initiating communication apparatus and a reporting communication apparatus according to various embodiments of the present disclosure.

Skilled artisans will appreciate that elements in the figures are illustrated for simplicity and clarity and have not necessarily been depicted to scale. For example, the dimensions of some of the elements in the illustrations, block diagrams or flowcharts may be exaggerated in respect to other elements to help an accurate understanding of the present embodiments.

### DETAILED DESCRIPTION

The following detailed description is merely exemplary in nature and is not intended to limit the embodiments or the application and uses of the embodiments. Furthermore, there is no intention to be bound by any theory presented in the preceding Background or this Detailed Description. Furthermore, other desirable features and characteristics will become apparent from the subsequent detailed description and the appended claims, taken in conjunction with the accompanying drawings and this background of the disclosure.

In the context of IEEE 802.11 (Wi-Fi) technologies, a station, which is interchangeably referred to as a STA, is a communication apparatus that has the capability to use the 802.11 protocol. Based on the IEEE 802.11-2020 definition, a STA can be any device that contains an IEEE 802.11-conformant media access control (MAC) and physical layer (PHY) interface to the wireless medium (WM).

For example, a STA may be a laptop, a desktop personal computer (PC), a personal digital assistant (PDA), an access point or a Wi-Fi phone in a wireless local area network (WLAN) environment. The STA may be fixed or mobile. In the WLAN environment, the terms “STA”, “wireless client”, “user”, “user device”, and “node” are often used interchangeably.

Likewise, an AP, which may be interchangeably referred to as a wireless access point (WAP) in the context of IEEE 802.11 (Wi-Fi) technologies, is a communication apparatus that allows STAs in a WLAN to connect to a wired network. The AP usually connects to a router (via a wired network) as a standalone device, but it can also be integrated with or employed in the router.

As mentioned above, a STA in a WLAN may work as an AP at a different occasion, and vice versa. This is because communication apparatuses in the context of IEEE 802.11 (Wi-Fi) technologies may include both STA hardware components and AP hardware components. In this manner, the communication apparatuses may switch between a STA mode and an AP mode, based on actual WLAN conditions and/or requirements.

According to the present disclosure, an initiating communication apparatus refers to as Initiator, Sensing Initiator, Initiator STA or initiating STA, or a Sensing Transmitter; while a reporting communication apparatus refers to as Responder, Sensing Responder, Responder STA, responding STA, Reporter STA or reporting STA, or a Sensing Receiver.

In various embodiments below, the term “report type” may be used interchangeably with the term “measurement report type”. Similarly, the terms “report type indication” “measurement report type indication” and “Measurement Report Type field” may be used interchangeably.

In explicit feedback beamforming, channel sounding and the corresponding feedback is used to help the beamformer decide the steering matrix, Q, to be used for beamformed transmissions. In IEEE 802.11n, three types of channel sounding feedback are defined:
CSI matrices feedback (802.11n): beamformer receives the quantized MIMO channel matrix or coefficient, H_{eff}, from the beamformee;
Noncompressed beamforming feedback matrix (802.11n): beamforming feedback matrices, V, found by the beamformee are sent to the beamformer; and
Compressed beamforming feedback matrix (802.11n, 802.11ac, 802.11ax): beamforming feedback matrices, V, found by the beamformee are compressed in the form of angles (Ψ (Psi) and Φ (Phi)), which are sent to the beamformer.

While post 802.11n amendments such as 802.11ac, 802.11ax, 802.11be, only compressed beamforming feedback is supported.

In 802.11bf, for allowing channel state information (CSI) feedback, it is agreed that CSI, i.e., the channel measured during the training symbols of a received measurement signal (e.g., PPDU), is a type of sensing measurement result for sub-7 GHz WLAN sensing. Further, to enabled sub-7 GHz WLAN sensing, an RXVECTOR parameter CSI_ESTIMATE is defined which contains the channel measured during the training symbols of a received measurement signal (e.g., PPDU). The format of CSI_ESTIMATE is still under discussion.

In addition, for allowing CSI feedback in 802.11bf, a Sensing Measurement Report frame, which allows a sensing receiver to report sensing measurements, is defined. This frame contains at least a Measurement Report Control field which contains information necessary to interpret the measurement report field and a Measurement Report field which carries CSI measurements obtained by a sensing receiver. However, the exact format of the CSI feedback (quantization/compressed etc.) as well as the format of the Sensing Measurement Report frame is still under discussion.

In 802.11n, the following CSI Report format is used carry CSI feedback, namely the CSI matrix for each reported subcarrier requiring (3+2×N_{b}×N_{c}×Nᵣ) bits, as shown in Table 1, where N_{b} refers to number of bits for a real CSI sub-component I or an imaginary CSI sub-component Q with a range of values of {4, 5, 6, 8}, N_{c} refers to number of column with a range of values from 1 to 4, Nᵣ refers to number of rows with a range of values from 2 to 4. The Initiator transmits an NDP with N_{STS,NDP} space-time streams, where N_{STS,NDP} takes a value between 2 and 8. Based on this NDP, the Responder estimates the N_{RX}×N_{STS,NDP} channel, and based on that channel it determines a Nr×Nc CSI feedback matrix, where Nr and Nc satisfy the following equation (1):

$$Nr = {N}_{STS , NDP} , \qquad Equation ( 1 )$$

$$Nc <= min ( {N}_{STS , NDP} , {N}_{RX} )$$

Here, N_{RX} is the number of receiver chains used to receive the NDP

Additionally, grouping can be used to reduce the size of CSI Report field and thus the size of CSI feedback by reporting a single value for each group of subcarriers. In particular, in 802.11n a CSI field parameter N_{g} with a range of values of {1, 2, 4} is used for grouping, where every N_{g} adjacent subcarrier is grouped together.

TABLE 1
an example CSI report field (20 MHz channel)

| Field | Size (bits) | Meaning |
|---|---|---|
| SNR in receive | 8 | Signal-to-noise (SNR) |
| chain 1 | | ratio in the first receive |
| | | chain of the STA (chain 1) |
| | | sending the port |
| . . . | | |
| SNR in receive | 8 | Signal-to-noise (SNR) |
| chain Nᵣ | | ratio in the Nᵣ-th receive |
| | | chain of the STA (chain Nᵣ) |
| | | sending the port |
| . . . | | |
| CSI Matrix for | 3 + 2 × N_{b} × N_{c} × Nᵣ | CSI Matrix |
| carrier −28 | | |
| . . . | | |
| CSI Matrix for | 3 + 2 × N_{b} × N_{c} × Nᵣ | CSI Matrix |
| carrier −1 | | |
| CSI Matrix for | 3 + 2 × N_{b} × N_{c} × Nᵣ | CSI Matrix |
| carrier +1 | | |
| . . . | | |
| CSI Matrix for | 3 + 2 × N_{b} × N_{c} × Nᵣ | CSI Matrix |
| carrier 28 | | |

In order to signal the real and imaginary values using N_{b} bits, the following CSI matrixes feedback encoding (e.g., carried out by reporting communication apparatus) is used, namely:
The maxima of the real and imaginary parts of each element of the CSI matrix in each subcarrier k is calculated using equation (2.1) where the largest real/imaginary absolute value over H matrix for that subcarrier is calculated and used in the equation;
A scaling ratio is calculated for each reported subcarrier k based on a base-ten logarithm of a ratio of the largest m_{H}(k) over all subcarriers to the m_{H}(k) of this specific subcarrier k in decibel (dB) using equation (2.2) and quantized to 3 bits (0 to 7), and a linear scaler is given by equation (2.3) with the largest m_{H}(k) over all subcarriers in the numerator; and
The real (I) and imaginary (Q) parts/sub-components of each element in the matrix are quantized to N_{b} bits in 2s complement encoding according to equations (2.4) and (2.5) respectively.
   This results in the I and Q values being normalized to the range: −(2^{(Nb-1)}−1) and (2^{(Nb-1)}−1) For example, if N_{b} is 8, the I and Q values is normalized to a range of −127 to +127.

$${m}_{H} ( k ) = max \{ max \{ {\vert Re ( {H}_{eff ( m , l )} ( k ) ) \vert}_{m = 1 , l = 1}^{m = {N}_{r} , l = {N}_{c}} \} , max \{ {\vert Im ( {H}_{eff ( m , l )} ( k ) ) \vert}_{m = 1 , l = 1}^{m = {N}_{r} , l = {N}_{c}} \} \} \qquad Equation ( 2.1 )$$

$${M}_{H} ( k ) = min \{ 7 , ⌊ 20 {log}_{10} ( \frac{max {\{ {m}_{H} ( z ) \}}_{z = - {N}_{SR}}^{z = {N}_{SR}}}{{m}_{H} ( k )} ) ⌋ \} \qquad Equation ( 2.2 )$$

where a based-ten logarithm of a ratio of the largest m_{H}(k) over all subcarriers to the m_{H}(k) of this specific subcarrier k in decibel (dB) is calculated

$${M}_{H}^{lin} ( k ) = \frac{max {\{ {m}_{H} ( z ) \}}_{z = - {N}_{SR}}^{z = {N}_{SR}}}{1 {0}^{{M}_{H} ( k ) / 20}} \qquad Equation ( 2.3 )$$

$${H}_{eff ( m , l )}^{q ( R )} ( k ) = ⌊ \frac{Re \{ {H}_{eff ( m , l )} ( k ) \}}{{M}_{H}^{lin} ( k )} ( {2}^{{N}_{b} - 1} - 1 ) + 0.5 ⌋ \qquad Equation ( 2.4 )$$

$${H}_{eff ( m , l )}^{q ( I )} ( k ) = ⌊ \frac{Im \{ {H}_{eff ( m , l )} ( k ) \}}{{M}_{H}^{lin} ( k )} ( {2}^{{N}_{b} - 1} - 1 ) + 0.5 ⌋ \qquad Equation ( 2.5 )$$

For CSI matrixes feedback decoding (e.g., carried out by Initiator STA), each element in the matrix of subcarrier is scaled using the value in the Carrier Matrix Amplitude field (3 bits), and m_{H}(k) is interpreted as a positive integer, in decibel (dB) as follows:
A linear value r for each subcarrier k is calculated using equation (3.1); and
Decoded values of the real and imaginary parts of the matrix element is calculated using equations (3.2) and (3.3) respectively.
   The recovered CSI values remain normalized between −(2^{(Nb-1)}−1) and (2^{(Nb-1)}−1) and are not scaled back to its original CSI value range observed by the receiver.

$$r ( k ) = 1 {0}^{{M}_{H} ( k ) / 20} \qquad Equation ( 3.1 )$$

$$Re \{ {\tilde{H}}_{eff ( m , l )} ( k ) \} = \frac{{H}_{eff ( m , l )}^{q ( R )} ( k )}{r ( k )} \qquad Equation ( 3.2 )$$

$$Im \{ {\tilde{H}}_{eff ( m , l )} ( k ) \} = \frac{{H}_{eff ( m , l )}^{q ( I )} ( k )}{r ( k )} \qquad Equation ( 3.3 )$$

It is noted that scaling factor is different for different subcarriers. In particular, subcarriers with smaller maximum value will be scaled up more such that the maximum value is as close to (2^{(Nb-1)}−1) as possible. As per 802.11n decoding rules, the recovered CSI values remain normalized between −(2^{(Nb-1)}−1) and (2^{(Nb-1)}−1) and are not scaled back to the original CSI value range observed by the receiver.

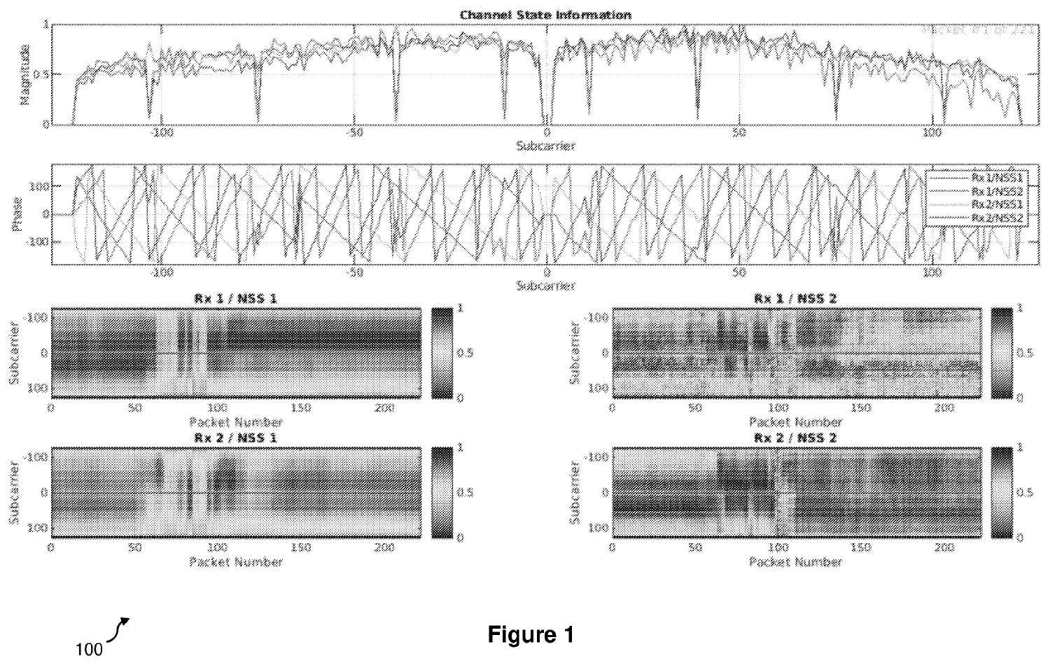

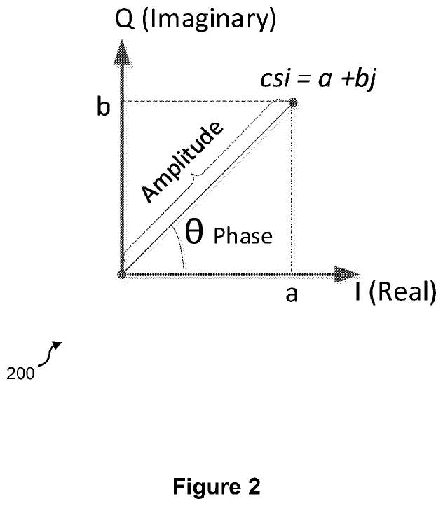

Conventionally, for WLAN sensing, amplitude (magnitude) and phase information of a received CSI is extracted from the real (I) and imaginary (Q) values, as shown in FIG. 2, and various techniques (e.g., statistical models, or Machine learning/Artificial Intelligence algorithms) are applied to perform the sensing. An example amplitude and phase sub-component information extracted from 802.11ac 80 MHz channel under 2×2 configuration (i.e., 2 transmitter (Tx) antennas and 2 receiver (Rx) antennas) is shown in FIG. 1.

In various embodiments below, an AP may be referred to as a base communication apparatus and a STA associated with an AP within a basic service set (BSS) may be referred to as an associated communication apparatus.

A recent contribution in 802.11bf has proposed to simplify the 802.11n CSI quantization scheme in order to simplify the implementation complexity and/or reduce the CSI report signaling overhead. Instead of using m_{H}(k) scaling, a simple power-of-two scaling to fit the I and Q values into N_{b} bits has been proposed since power-of-two scaling can be achieved by simple bits shifting and avoids dB to linear conversions. A single scaling factor M_{H}^{lin} for all subcarriers is also proposed, thereby saving 3 bits per subcarrier. This results in a total feedback size of 16+2×N_{b}×N_{c}×Nᵣ×Number of feedback subcarriers. The single scaling factor can be calculated using equation (4.1). The Initiator STA recovers I (and Q) value from the received CSI report as equation (4.2).

$${M}_{H}^{lin} = max {\{ {m}_{H} ( k ) \}}_{k = - {N}_{SR}}^{k = {N}_{SR}} \qquad Equation ( 4.1 )$$

$${\tilde{H}}_{eff ( m , l )}^{q ( R )} ( k ) = {\hat{H}}_{eff ( m , l )}^{q ( R )} ( k ) \times {M}_{H}^{lin} / ( {2}^{{N}_{b} - 1} - 1 ) \qquad Equation ( 4.2 )$$

It is noted that such simplified scaling factor reduces the overhead of CSI feedback but the overhead reduction is small, around 4.45% as compared to 802.11n scheme. It also causes around 2 to 4 dB performance degradation in terms of signal-to-quantization-noise ratio (SQNR) as compared to 802.11n scheme and the overhead of CSI feedback as compared to compressed beamforming feedback can be big (41-68% higher). Hence, there is thus a need for a communication apparatus and a communication method for partial channel state information feedback to further reduce the overhead of CSI feedback in a format suitable for the needs of wireless local area network sensing application as well as its related signaling such as its frame format and CSI feedback report format.

Further, it is noted that while sensing applications extracts CSI amplitude and phase sub-components from reported I and Q values (in the CSI report) to derive sensing results, most sensing applications do not directly make use of the reported I and Q values. Also, while many sensing applications make use of both amplitude and phase information, many others only use one of them, either amplitude or phase, but not both. For example, for simpler sensing applications such as human presence/occupancy detection, people counting, humidity estimation, gesture detection etc, amplitude information is sufficient, whereas for motion detection, fall detection etc., only phase information is used.

While 802.11bf may allow an Initiator STA to request a responder STA to transmit null data packets (NDP), and the Initiator STA computes the CSI itself, there are sensing applications where it makes more sense for the Initiator STA to transmit the NDP and solicit the CSI feedback report from the Responder STA. For example, in Gesture Recognition applications, it is better to use AP (Initiator) as the NDP transmitter instead of a smartphone (Responder) since the hand is much closer to the smartphone and also the smartphone may have slight movements, hence transmitting NDP by the smartphone may introduce artificial perturbations in the collected CSI. In this case, it makes more sense for the AP to transmit the NDP and collect the CSI feedback from the smartphone.

According to the present disclosure, an Initiator STA indicates the type of a sub-component (e.g., amplitude or phase) of channel state information (CSI) is to be reported by a Responder STA. The Responder STA receives a measurement PPDU (e.g., NDP) that is to be used to perform channel measurements (e.g., transmitted by the Initiator STA or by another STA) and the Responder STA then performs channel measurement on the received Measurement PPDU to obtain the indicated type of sub-component and reports to the Initiator STA with the information of the indicated sub-component type using a Measurement Report frame. Although various embodiments below are illustrated based on two sub-components, i.e., amplitude and phase sub-components, it is appreciated that, alternatively or additionally, other sub-components such as real part of CSI (i.e., I values) and/or imaginary part of CSI (i.e., Q values) can be indicated, and the information of the I and/or Q values of the CSI is obtained from a Measurement signal/frame and included in the Measurement Report frame.

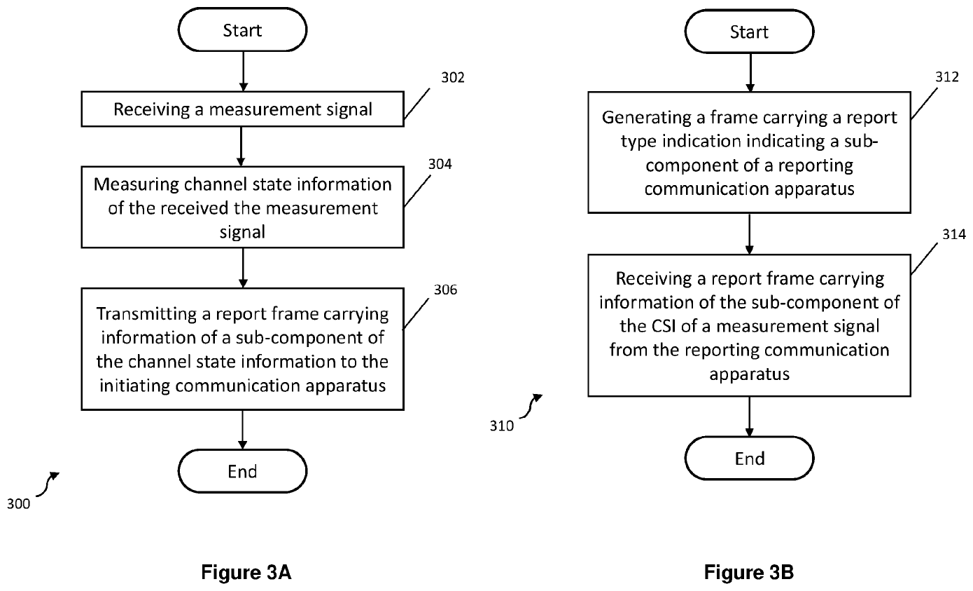

FIG. 3A shows a flow chart 300 illustrating a method of transmitting partial channel state information feedback according to various embodiments of the present disclosure. In step 302, a step of receiving a measurement signal is carried out. In step 304, a step of measuring channel state information of the received measurement signal (and optionally a step of extracting/computing a sub-component of the measured CSI) is carried out. In step 306, a step of transmitting a reporting frame carrying information of a sub-component of the channel state information is carried out. In one embodiment, the STA that transmits the measurement signal and the STA to which the report frame is transmitted are different.

FIG. 3B shows a flow chart 310 illustrating a method of receiving partial channel state information feedback according to various embodiments of the present disclosure. In step 312, a step of generating a frame carrying a report type indication indicating a sub-component of a reporting communication is carried out. In step 314, a step of receiving a report frame carrying information of the sub-component of the CSI of a measurement signal from the reporting communication apparatus is carried out.

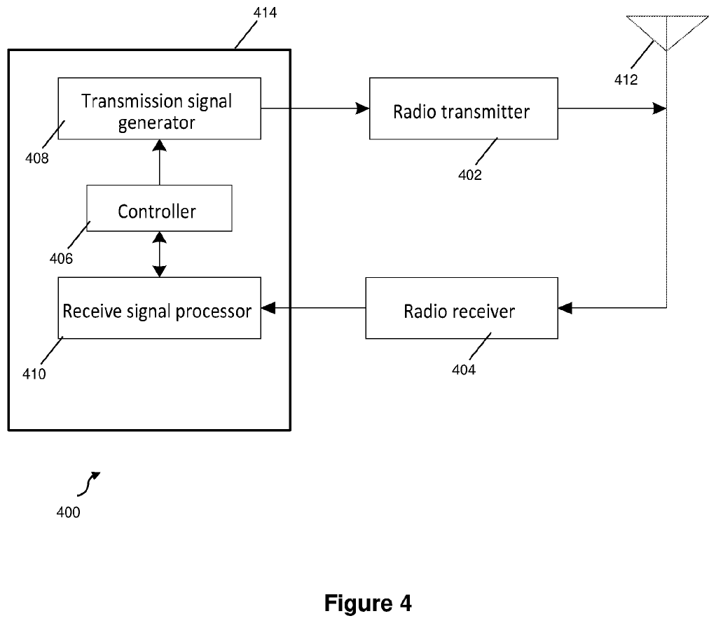

FIG. 4 shows a schematic diagram 400 illustrating an example configuration of a communication apparatus for partial CSI feedback in accordance various embodiments of the present disclosure. The communication apparatus 400 may be implemented as a Sensing Initiator or a Sensing Responder and configured for partial CSI feedback in accordance with the present disclosure. As shown in FIG. 4, the communication apparatus 400 may include circuitry 414, at least one radio transmitter 402, at least one radio receiver 404, and at least one antenna 412 (for the sake of simplicity, only one antenna is depicted in FIG. 4 for illustration purposes). The circuitry 414 may include at least one controller 406 for use in software and hardware aided execution of tasks that the at least one controller 406 is designed to perform, including control of communications with one or more other communication apparatuses in a multiple input and multiple output (MIMO) wireless network. The circuitry 414 may furthermore include at least one transmission signal generator 408 and at least one receive signal processor 410. The at least one controller 406 may control the at least one transmission signal generator 408 for generating PPDU (for example physical layer protocol data unit (PPDU), e.g., Sounding PPDU (NDP), NDP Announcement frame, PPDU comprising a Request frame or an Announcement frame) or MAC frame (for example Data frames, Management frame, Action frames, Trigger frame) to be sent through the at least one radio transmitter 402 and the at least one receive signal processors 410 for processing PPDU (for example physical layer protocol data unit (PPDU), e.g., Sounding PPDU (NDP), NDP Announcement frame, PPDU comprising a Request frame or an Announcement frame) or MAC frame (for example Data frames, Management frame, Action frames, Trigger frame) received through the at least one radio receiver 404 from the one or more other communication apparatuses. The at least one transmission signal generator 408 and the at least one receive signal processor 410 may be stand-alone modules of the communication apparatus 400 that communicate with the at least one controller 406 for the above-mentioned functions, as shown in FIG. 4. Alternatively, the at least one transmission signal generator 408 and the at least one receive signal processor 410 may be included in the at least one controller 406. It is appreciable to those skilled in the art that the arrangement of these functional modules is flexible and may vary depending on the practical needs and/or requirements. The data processing, storage and other relevant control apparatus can be provided on an appropriate circuit board and/or in chipsets. In various embodiments, when in operation, the at least one radio transmitter 402, at least one radio receiver 404, and at least one antenna 412 may be controlled by the at least one controller 406.

The communication apparatus 400, when in operation, provides functions required for partial CSI feedback. For example, the communication apparatus 400 may be a Sensing Responder, and the at least one radio receiver 404 may, in operation, receive a measurement signal (e.g., Measurement PPDU). The circuitry 414 (for example the at least one receive signal processor 410 of the circuitry 814) may, in operation, be configured to process the measurement signal and measure CSI of the measurement signal. The circuitry 414 (for example the at least one transmission signal generator 408 of the circuitry 414) may then generate a report frame carrying information of a sub-component of the CSI. The at least one radio transmitter 402 may, in operation, transmit the report frame.

In various embodiments, The at least one radio receiver 404 may receive a frame from a Sensing Initiator carrying a report type indication indicating a sub-component of the CSI, and accordingly, the circuitry 414 (for example the at least one receive signal processor 410 of the circuitry 814) may, in operation, be configured to generate a report frame carrying the information of the indicated sub-component of the CSI, and the at least one radio transmitter 402 may then transmit such report frame to the Sending Initiator.

In one embodiment, the at least one radio transmitter 402 transmits the report frame carrying information of the CSI sub-component immediately after receiving a short interframe space (SIFS) of the measurement signal. In another embodiment, the at least radio transmitter 402 transmits the report frame carrying information of the CSI sub-component at a time delay after the measurement signal is received, for example a SIFS after receiving a subsequent measurement signal or in a subsequent transmission opportunity (TXOP).

In one embodiment, the at least one radio receiver 404 may receive a request frame from the Sensing Initiator during a sensing setup phase to set up a maximum time delay to transmit a report frame after a measurement signal is received, and the circuitry 414 (for example the at least one receive signal processor 410 may process the request frame. The circuitry 414 (for example the at least one transmission 408 of the circuitry 414) may then generate a response frame. The at least one radio transmitter 402 may, in operation, transmit the response frame to the Sensing Initiator to complete the setup of the maximum time delay.

Yet in another embodiment, the at least one radio receiver 404 may receive a first frame from the Sensing Initiator during a sensing session setup phase or a sensing measurement setup phase, the first frame carrying a coarse report type indication indicating whether a full CSI or a partial CSI is to be reported, and a second frame during a measurement instance carrying a fine report type indication indicating whether the full CSI being compressed/uncompressed or a sub-component of the partial CSI. The circuitry 414 (for example the at least one transmission signal generator 408 of the circuitry 414) may then generate a report frame carrying information of the indicated compressed/uncompressed full CSI or the indicated sub-component of the partial CSI in accordance with the indications. The at least one radio transmitter 402 may, in operation, transmit the report frame carrying the information compressed/uncompressed full CSI or the indicated sub-component of the partial CSI.

For example, the communication apparatus 400 may be a Sensing Initiator, and the circuitry 414 (for example the at least one transmission signal generator 408 of the circuitry 414) may, in operation, generate a frame carrying a report type indication indicating a sub-component of CSI. The at least one transmitter 402 may, in operation, transmit the frame to a Sensing Responder. The at least one radio receiver 404 may, in operation, receive a report frame carrying information of the indicated sub-component of the CSI of a measurement signal (e.g., Measurement PPDU).

In one embodiment, the circuitry 414 (for example the at least one transmission signal generator 408 of the circuitry 414) may, in operation, generate a request frame during a sensing setup phase to set up a maximum time delay to transmit a report frame after a measurement signal is received. The at least one transmitter 402 may transmit the request frame to a Sensing Responder. The at least one radio transmitter 402 may, in operation, receive a response frame to the Sensing Initiator. The circuitry 414 (for example the at least one receive signal processor 410 may then process the response frame and complete the setup of the maximum time delay.

Yet in another embodiment, the circuitry 414 (for example the at least one transmission signal generator 408 of the circuitry 414) may, in operation, generate a first frame during a sensing session setup phase or a sensing measurement setup phase, the first frame carrying a coarse report type indication indicating whether a full CSI or a partial CSI is to be reported, and a second frame during a measurement instance carrying a fine report type indication indicating whether the full CSI being compressed/uncompressed or a sub-component of the partial CSI. The at least one radio transmitter 402 may, in operation, transmit the first and second frames carrying the coarse report type indication and the fine report type indication during a sensing session/measurement setup phase and a measurement instance to a Sensing Responder respectively.

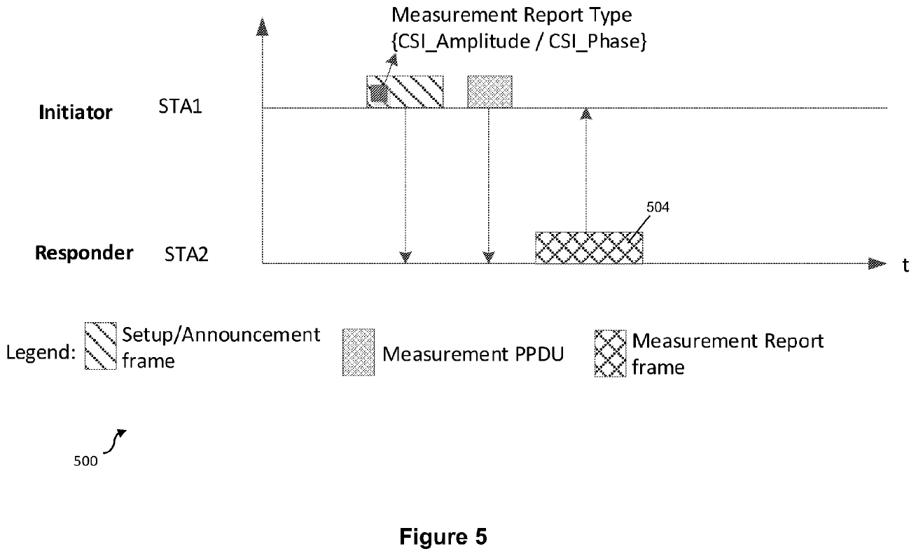

FIG. 5 shows a flow diagram 500 illustrating first exemplary communication for obtaining CSI sub-component information according to various embodiments of the present disclosure. An Initiator STA (STA1) first transmits a Setup frame or Announcement frame to a Responder STA (STA2), the Setup frame or Announcement frame carrying a report type indication indicating a sub-component (e.g., amplitude or phase) of CSI. STA1 further transmits a Measurement PPDU to STA2. STA2 which receives the measurement PPDU then performs channel measurements on the Measurement PPDU to obtain the indicated CSI sub-component information and transmits a Measurement Report frame to STA1.

A Sensing Initiator may decide whether to solicit full CSI feedback, or a partial CSI feedback (i.e., only one of the CSI sub-component, either Amplitude or Phase) based on the Sensing application that uses the CSI feedback data. For example, for sensing applications that only use amplitude information, the Sensing Initiator may then solicit only the amplitude sub-component; for sensing applications that only use phase information, the Sensing Initiator may then solicit only the phase sub-component; while for sensing applications that use both amplitude and phase information, full CSI feedback is solicited.

It is also observed that the range of the CSI measurement (i.e., the I and Q, or in some cases the amplitude and phase, reported by different 802.11 chip vendors/module may vary quite a lot. Since the range of phase is always bounded within −180, 180 degrees, it is not an issue, but the range of the amplitude can vary widely between vendors. Therefore, in cases where the I and Q range (or the amplitude range) is not standardized in 802.11bf, and there are multiple sensing initiator (or transmitter) or responder (or receiver) pairs, or the same sensing initiator is collecting channel measurement from multiple sensing responders, the relative amplitude among STAs may be less reliable than the phase sub-component of CSI and therefore the Sensing Initiator may be configured to solicit the phase sub-component of CSI.

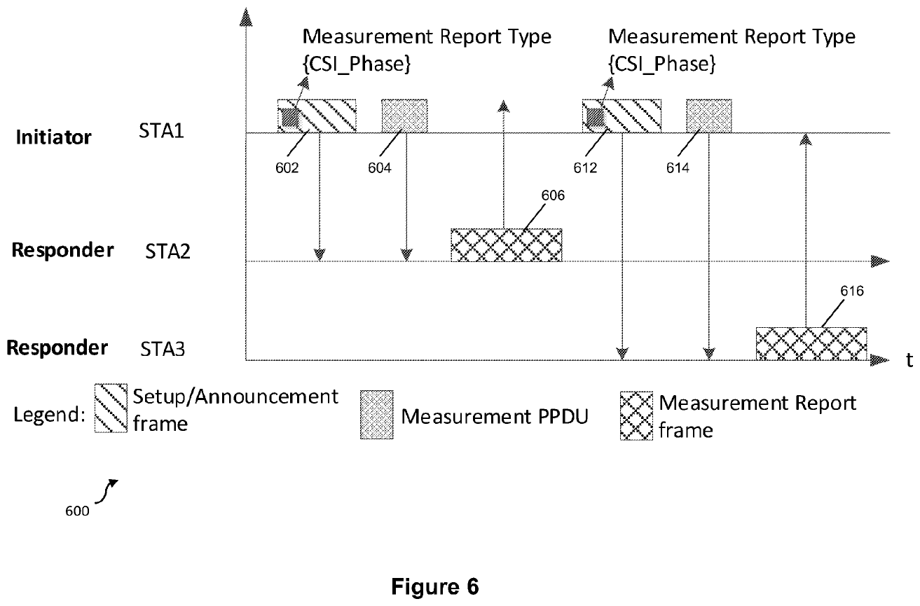

An Initiator STA may solicit different CSI feedbacks from different STAs. FIG. 6 shows a flow diagram 600 illustrating second exemplary communication for obtaining CSI sub-component information from two Responder STAs according to various embodiments of the present disclosure. An Initiator STA (STA1) first transmits a Setup frame or Announcement frame 602 to a Responder STA (STA2), the Setup frame or Announcement frame 602 carrying a report type indication indicating a sub-component (in this case, phase sub-component) of CSI. STA1 further transmits a Measurement PPDU 604 to STA2. STA2 which receives the measurement PPDU 604 then performs channel measurements on the Measurement PPDU 604 to obtain the indicated CSI sub-component information and transmit a Measurement Report frame 606 to STA1. STA1 may then transmit another Setup frame or Announcement frame 612 to another Responder STA (STA3), the Setup frame or Announcement frame 612 carrying a report type indication indicating a sub-component (in this case, phase sub-component) of CSI. STA1 further transmits a Measurement PPDU 614 to STA3. Similarly, STA3 which receives the Measurement PPDU 614 then performs channel measurements on the Measurement PPDU 614 to obtain the indicated CSI sub-component information and transmit a Measurement Report frame 616 to STA1.

In the following paragraphs, a first embodiment of the present disclosure which relates to a report type indication indicated during Sensing Setup phase using Measurement Setup Request/Response frame is explained.

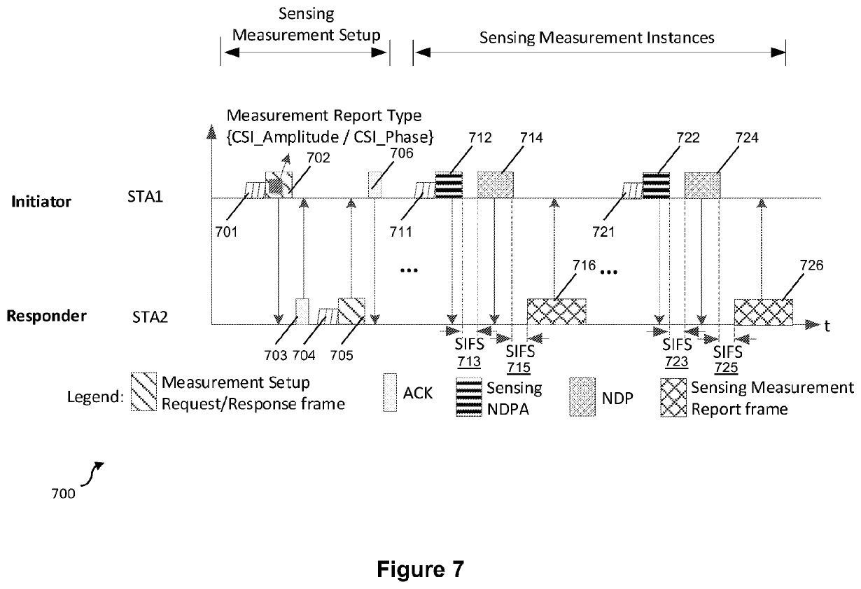

In this first embodiment, a Sensing Initiator is also a Sensing Transmitter, while a Sensing Responder is also a Sensing Receiver. FIG. 7 shows a flow diagram 700 illustrating first exemplary communication for performing sensing measurements to obtain CSI sub-component information according to the first embodiment of the present disclosure. Contention based channel access procedures, e.g., Enhanced Distributed Channel Access (EDCA) procedures, illustrated by blocks 701, 704, 711, 721 are carried out prior to transmission of Measurement Setup Request/Response frames and Sensing null data packet (NDP) Announcement (NDPA) frames. During Sensing Measurement Setup phase, a Sensing Initiator (STA1) transmits a Sensing Measurement Setup Request frame 702 to indicate a measurement report type (e.g., amplitude, phase, I, Q or full CSI (I and Q)) to be reported by a Sensing Responder (STA2). STA2 which receives the Sensing Measurement Setup Request frame 702 transmits an Acknowledgement (ACK) frame 703 and then a Sensing Measurement Setup Response frame 705 back to STA1. Subsequently, at each sensing measurement instance, STA1 transmits a Sensing NDPA frame 712, 722, followed by a Sensing Measurement PPDU (in this case, an NDP 714, 724) after a Short Interframe Spacing (SIFS) 713, 723. STA2 which receives the Sensing NDPA frame 712, 722 and the Sensing Measurement PPDU 714, 724 then performs sensing measurements to obtain the CSI. If a sub-component is indicated as the Measurement Report Type, the Sensing Responder computes the indicated sub-component (Amplitude or Phase or I or Q) from the measured CSI and reports to the Sensing Initiator in the Sensing Measurement Report frame, else full CSI is reported.

After a SIFS 715, 725 following the reception of the NDP 714, 724 by STA2, STA2 transmits a Sensing Measurement Report frame 716, 726 to STA1. In this case, two sensing measurement instances are illustrated in FIG. 7. In this embodiment, the same sub-component is reported for all measurement instances corresponding to that measurement report type indicated during the Measurement Setup Phase, Measurement Setup corresponding to the measurement instances being identified by a Measurement Setup ID.

Alternatively, the measurement report type may be indicated during Sensing Session Setup phase, for example using Session Setup Request/Response frame, instead of during Measurement Setup Phase as illustrated in FIG. 7. In such case, the same sub-component is reported for all measurement instances corresponding to the measurement report type indicated during Sensing Session Setup phase.

In one alternative implementation, when supported/allowed, it is also possible that the Sensing Measurement Report frame carrying the CSI/Amplitude/Phase feedback for a Measurement Instance is not required to be transmitted immediately (after SIFS) after reception of the Measurement PPDU but may be allowed to be transmitted after a delay, for example, SIFS after receiving the Measurement PPDU for the next measurement instance or even in the Responder STA's own transmission opportunity (TXOP).

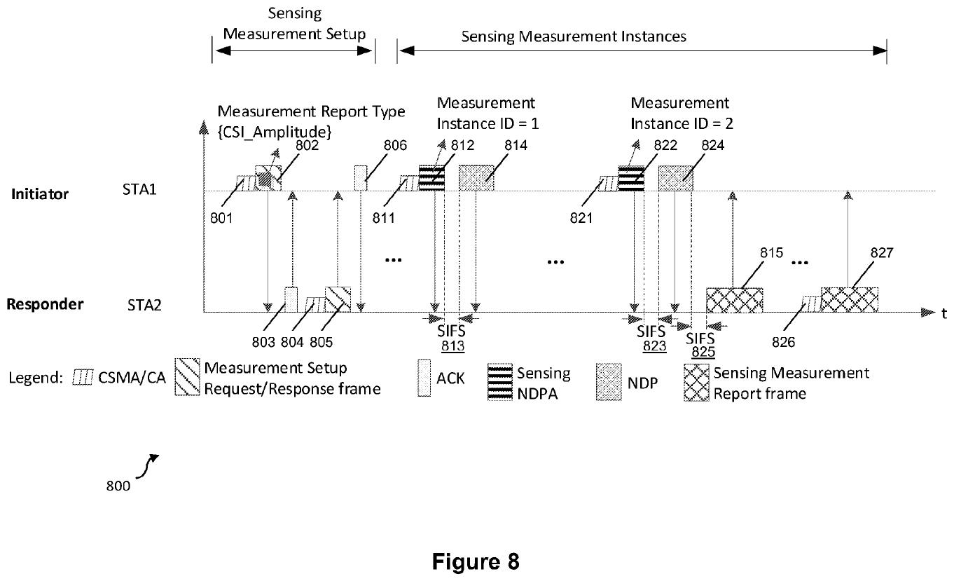

FIG. 8 shows a flow diagram 800 illustrating second exemplary communication for performing sensing measurements to obtain CSI sub-component information according to the first embodiment of the present disclosure. Contention based channel access procedures, e.g., EDCA procedures, illustrated by blocks 801, 804, 811, 821 are carried out prior to transmission of Measurement Setup Request/Response frames and Sensing NDPA frame. During Measurement Setup phase, a Sensing Initiator (STA1) transmits a Sensing Measurement Setup Request frame 802 to indicate a measurement report type (e.g., amplitude, phase, I, Q or full CSI (I and Q)) to be reported by a Sensing Responder (STA2). STA2 which receives the Sensing Measurement Setup Request frame 8002 transmits an Acknowledgement (ACK) frame 803 and then a Sensing Measurement Setup Response frame 805 back to STA1. Subsequently, at each sensing measurement instance, STA1 transmits a Sensing NDPA frame 812, 822, followed by a Sensing Measurement PPDU (in this case, an NDP 814, 824) after a SIFS 813, 823. Each Sensing NDPA frame 812, 822 indicates a Measurement Instance ID (1 or 2) identifying the sensing measurement instance corresponding to the NDPA frames 812, 822. The Sensing NDPA frames also indicate the Measurement Setup ID of the corresponding Sensing Measurement Setup.

STA2 which receives the Sensing NDPA frame 812, 822 and the Sensing Measurement PPDU 814, 824 then performs sensing measurements to obtain the CSI. If a sub-component is indicated as the Measurement Report Type, the Sensing Responder computes the indicated sub-component (Amplitude or Phase or I or Q) from the measured CSI and reports to the Sensing Initiator in the Sensing Measurement Report frame, else full CSI is reported.

Instead of transmitting a Sensing Measurement Report frame immediately (after SIFS) after reception of the Sensing Measurement PPDU 814, 824, STA2 transmits the Sensing Measurement Report frame 815 for the first measurement instance (Measurement Instance ID=1) is transmitted after a SIFS following the reception of the NDP for the second measurement instance (Measurement Instance ID=2). The Sensing Measurement Report frame 827 for the second measurement instance (Measurement Instance ID=2) is transmitted after the Sensing Measurement Report frame 815 for the first measurement instance is transmitted. A contention based channel access procedure, e.g. EDCA procedure, is carried out prior to the transmission of the Sensing Measurement Report frame 827.

In one embodiment, the maximum report delay, i.e., the maximum time allowed between the reception of a Measurement PPDU (e.g., NDP) and the transmission of the corresponding Measurement Report frame may be negotiated during Sensing Session Setup and indicated using a Maximum Report Delay field in Sensing Session Setup Request/Response frame.

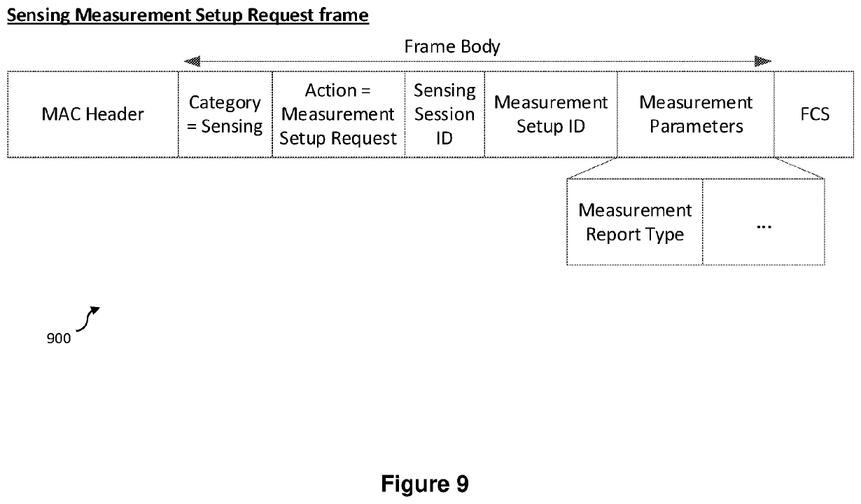

FIG. 9 shows an example Sensing Measurement Setup Request frame 900 according to the first embodiment of the present disclosure. As illustrated in FIGS. 7 and 8 using blocks 702, 802, such Sensing Measurement Setup Request frame 900 may be used by a Sensing Initiator to indicate a measurement report type or report type indication indicating a sub-component CSI (e.g., Amplitude or Phase or CSI (I and Q) to be reported by a Sensing Responder. The Sensing Measurement Setup Request frame 900 comprises a Media Access Control (MAC) Header, a Category field (set to “Sensing”), an Action field (set to “Measurement Setup Request”), a Sensing Session ID field, a Measurement Setup ID field, a Measurement Parameters field and a Frame Check Sequence (FCS) field. The Sensing Session ID field may be omitted if other identifiers (e.g., MAC address, AID) of peer STAs are used to identify a sensing session. The Measurement Setup ID field carries the ID of the corresponding Measurement Setup. The Measurement Parameters field further comprises a Measurement Report Type field which indicates a measurement report type.

TABLE 2
various measurement report types corresponding
to the Measurement Report Type field values of
the Sensing Measurement Setup Request frame 900

| Measurement | |
|---|---|
| Report Type | Meaning |
| 0 | CSI (uncompressed) |
| 1 | CSI_Amplitude (only amplitude |
| | sub-component of CSI) |
| 2 | CSI_Phase (only phase sub-component of CSI) |
| 3 | Compressed CSI |

The CSI_Amplitude or CSI_Phase feedback report may be referred as partial CSI feedback report, since the feedback only carries one sub-component of the CSI (either amplitude or phase). Partial CSI here refers to the breakdown of each entry of the CSI matrix into sub-components (e.g., amplitude and phase sub-components, or could also refer to the I and Q sub-components), but does not refer to selective feedback based on other parameters, for example partial bandwidth feedback where CSI feedback is only reported for a sub-section of the frequency range of the measured channel. Each CSI matrix can be measured, determined on each subcarrier (also known as tone in 802.11); the CSI matrix on a tone consists of many elements (Nᵣ×N_{c} elements, each elements consists of I and Q sub-components (or amplitude and phase sub-components)).

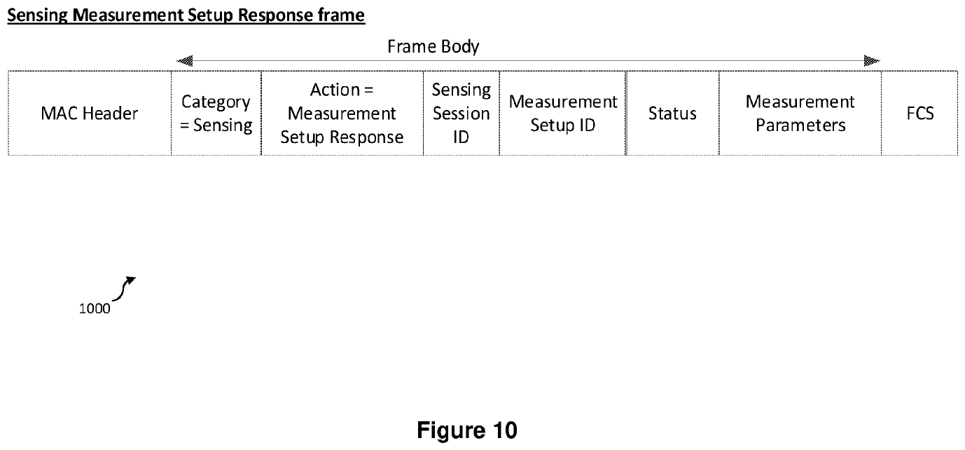

Optionally, the Sensing Responder may accept/reject the request using a Sensing Measurement Setup Response frame. FIG. 10 shows an example Sensing Measurement Setup Response 1000 according to the first embodiment of the present disclosure. As illustrated in FIGS. 7 and 8 using blocks 705, 805, The Sensing Measurement Setup Response 1000 comprises a MAC Header, a Category field (set to “Sensing”), an Action field (set to “Measurement Setup Response”), a Measurement ID field, a Status field, a Measurement Parameters field and a FCS field. The Measurement Setup ID field carries the Measurement Setup ID of the Sensing Measurement Setup Request frame 900. By using the Sensing Measurement Setup Request/Response frame to indicate a measurement report type, and the corresponding Sensing Measurement Report frames only carrying feedback for the indicated CSI sub-component, large reduction in feedback signaling overhead can be achieved.

The following paragraphs explain the Sensing Receiver operation for amplitude reporting according to the first embodiment of the present disclosure.

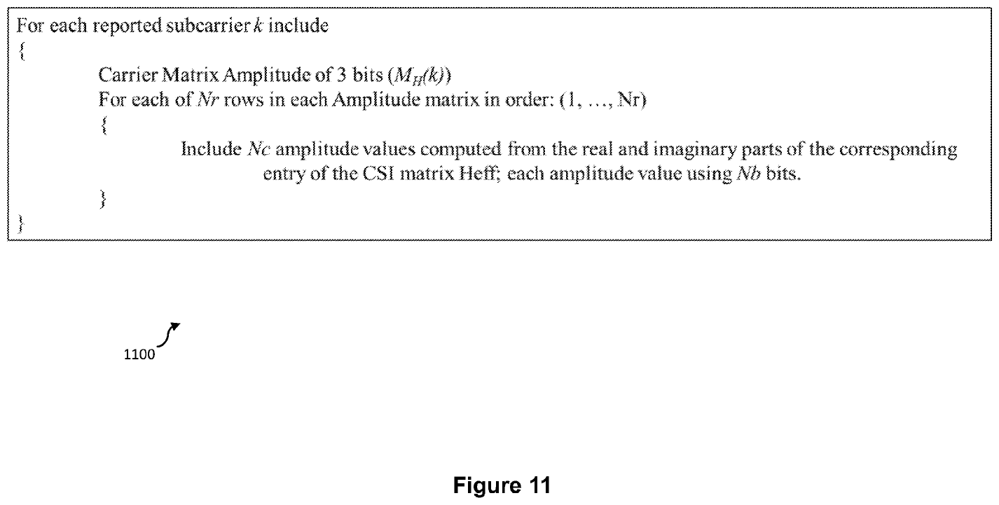

Upon receiving the Measurement PPDU (e.g., NDP), the receiver determines the CSI matrix H_{eff}, each element of which is a complex number comprising a real (I) and imaginary (Q) parts. The real and imaginary parts of element in the m^{th} row and l^{th} column of the CSI matrix for subcarrier k may be represented as Re(Heff(m, l)(k)) and Im(Heff(m, l)(k)), respectively. The amplitude value corresponding to the entry in the m^{th} row and l^{th} column of the CSI matrix for subcarrier k is computed using equation (5.1). The code structure of amplitude matrix A^{q}(k) for subcarrier k is illustrated in FIG. 11.

$${A}_{( m , l )} ( k ) = \sqrt{Re {( Heff ( m , l ) ( k ) )}^{2} + {Im ( Heff ( m , l ) ( k ) )}^{2}} \qquad Equation ( 5.1 )$$

If the receiver's physical layer (PHY) directly provides the CSI Amplitude and Phase instead of the real and imaginary parts of the CSI, equation (5.1) may be skipped. Since different device implementations may report the CSI Amplitude in different ranges, it is also advantageous to define a fixed range in 802.11bf (e.g., 0 to 1000 etc.) such that the Amplitude values reported by different devices have the same meaning. Alternatively, it is also possible that instead of computing the amplitude based on the I and Q parts of the CSI, the observed power level at each reported subcarrier k may be used as representative of the amplitude, if the PHY supports such power level reporting per subcarrier. The observed power level at each reported subcarrier k may be calculated using equation (5.2). Equation (5.2) may also be seen as square of the amplitude values computed using equation (5.1). This may have the advantageous effect of saving the square root operation during the amplitude computation using equation (5.1).

$${A}_{alt ( m , l )} ( k ) = {Re ( Heff ( m , l ) ( k ) )}^{2} + {Im ( Heff ( m , l ) ( k ) )}^{2} \qquad Equation ( 5.2 )$$

For amplitude value encoding and in order to signal the amplitude values using N_{b} bits, the following amplitude matrices feedback encoding is used, namely:
Maximum amplitude values of the amplitude matrix in each subcarrier k are calculated using equation (6.1), where the largest real/imaginary absolute value over H matrix for that subcarrier is calculated and used in the equation;
A scaling ratio is calculated for each reported subcarrier k based on a base-ten logarithm of a ratio of the largest m_{H}(k) over all subcarriers to the m_{H}(k) of this specific subcarrier k in decibel (dB) using equation (6.2) and quantized to 3 bits (0 to 7), and a linear scaler is given by equation (6.3) with the largest m_{H}(k) over all subcarriers in the numerator; and
Each element in the amplitude matrix is quantized to N_{b} bits as unsigned integers (i.e., positive integers) according to equation (6.4).

$${m}_{H} ( k ) = max \{ {{A}_{( m , l )} ( k )}_{m = 1 , l = 1}^{m = Nr , l = Nc} \} \qquad Equation ( 6.1 )$$

$${M}_{H} ( k ) = min \{ 7 , ⌊ 20 log 10 ( \frac{max {\{ {m}_{H} ( z ) \}}_{z = - {N}_{SR}}^{z = {N}_{SR}}}{mH ( k )} ) ⌋ \} \qquad Equation ( 6.2 )$$

N_{SR} indicates half the size of reported subcarriers excluding Nulls

$${M}_{H}^{lin} ( k ) = \frac{max {\{ {m}_{H} ( z ) \}}_{z = - {N}_{SR}}^{z = {N}_{SR}}}{1 {0}^{{M}_{H} ( k ) / 20}} \qquad Equation ( 6.3 )$$

$${A}_{( m , l )}^{q} ( k ) = ⌊ \frac{{A}_{( m , l )} ( k )}{{M}_{H}^{lin} ( k )} ( {2}^{Nb} - 1 ) + 0.5 ⌋ \qquad Equation ( 6.4 )$$

Since the amplitude values are always positive and unsigned integers are used (instead of 2s complement encoding), the quantized amplitude values are normalized to the range of 0 to (2^{Nb}−1), leading to an 1 bit resolution gain as compared to 802.11n encoding rules where the quantized I and Q values are normalized to the range of −(2^{(Nb-1)}−1) to (2^{(Nb-1)}−1) If equation (5.2) was used for the amplitude computation instead of equation (5.1), the values are expected to be much larger and a larger value of Nb may be used in this case.

Alternatively, the same resolution can also be maintained by quantizing the amplitude values by normalized to the range of 0 to (2^{(Nb-1)}−1) which can lead to a further saving of 1 bit per entry of the amplitude matrix. It is also possible to use 2s complement encoding (i.e., same as 802.11n) to unify the encoding/decoding. However, the quantized values of amplitude will be normalized to the range of (2^{(Nb-1)}−1) to (2^{(Nb-1)}−1) and hence there is no gain in resolution.

According to this embodiment of the present disclosure, each amplitude matrix is encoded using (3+N_{b}×N_{c}×Nᵣ) bits, as shown in Table 3, as compared to (3+2×N_{b}×N_{c}×Nᵣ) for 802.11n encoding rules, N_{c} and Nᵣ are the number of rows and columns, respectively, in the channel matrix estimate computed by the Sensing receiver.

Alternatively, if (N_{b}−1) bits are used to quantize each entry of the amplitude matrix, (3+(N_{b}−1)×N_{c}×Nᵣ) bits are required for each Amplitude matrix, leading to further overhead saving at a similar accuracy as 802.11n scheme.

Maximum Amplitude (Max_A)=max{m_{H}(z)}_{z=-N}_{_{SR}}^{z=N}^{_{SR}} in equations (6.2) and (6.3), is quantized as two unsigned integers (first 14-bits to carry the decimal part and second 10-bits to carry the fractional part rounded to 3 digits). 14-bits unsigned integer allows indication up to a value of (2¹⁴−1)=16383. Any larger amplitude value is indicated as 16383. 10-bits unsigned integer value allows indication of up to 3 digits of fractional part, up to 999. The fractional part is rounded to 3 digits, for example, a maximum amplitude value of 203.5927 is indicates as 203 and 593.

TABLE 3
an example Measurement Report field (Amplitude), where scidx(n) is
defined to indicate the exact subcarrier index corresponding to the reported
subcarrier n; and Nₛ is the number of subcarriers for which
the Amplitude matrix is reported and is a function of the grouping
parameter N_{g} (every N_{g} adjacent subcarrier is grouped
and a single value for each group of N_{g} adjacent subcarriers)

| Field | Size (bits) | Meaning |
|---|---|---|
| SNR in receive chain 1 | 8 | SNR ratio in the first receive |
| | | chain of the STA (chain 1) |
| | | sending the port |
| . . . | | |
| SNR in receive | 8 | SNR ratio in the Nᵣ -th |
| chain Nᵣ | | receive chain of the STA |
| | | (chain Nᵣ) sending the port |
| . . . | | |
| Maximum Amplitude | 14 + 10 = 24 | Maximum value over all |
| | | reported Amplitude values |
| | | (Max_A) quantized as two |
| | | unsigned integers (first 14- |
| | | bits to carry the decimal part |
| | | and second 10-bits to carry |
| | | the fractional part rounded to |
| | | 3 digits). |
| Amplitude matrix for | 3 + N_{b} × N_{c} × Nᵣ | Amplitude matrix according |
| subcarrier k = scidx(0) | | to FIG. 11 |
| . . . | | |
| Amplitude matrix for | 3 + N_{b} × N_{c} × Nᵣ | Amplitude Matrix |
| subcarrier k = | | |
| scidx(Nₛ − 1) | | |

The 802.11n CSI Report can also be modified in similar manner such that instead of the Maximum Amplitude, it carries the max{m_{H}(z)}_{z=-N}_{_{SR}}^{z=N}^{_{SR}} (=Maximum of all m_{H}(k) over all subcarriers, m_{H}(k) being the maximum of the absolute values of I and Q over all m in 1 to Nr and l in 1 to Nc) (e.g., using 24 bits) and used to scaled back the recovered real and imaginary CSI values to the original CSI value range observed by the receiver.

Since different device implementations may report the CSI Amplitude in different ranges, it is also advantageous to define a fixed Maximum Amplitude value in 802.11bf (e.g., 1000 etc.) such that the Amplitude values reported by different devices are in the same range. However, if the scale/unit/dimension of the Maximum Amplitude is left as implementation dependent, the Responder STA shall not change the scale among the feedback reports within a sensing session, or at least within measurement instances with the same measurement setup ID, so the Initiator STA can compare amplitudes between the feedback reports from the same STA or periodic reports from the same STA etc.

Regarding subcarrier grouping in the Sensing Measurement feedback report, it is noted that the recent 802.11 amendments (HE, EHT) use a limited values of N_{g} (4 and 16) and the corresponding set of subcarrier indices for the compressed beamforming feedback matrix reporting. However, for CSI feedback reporting, a more dynamic range may be desired, which is different from the values used for the compressed beamforming feedback matrix reporting, such that the feedback overhead can be adjusted more accurately based on the characteristics of the channel being sensed. For example, using 3 bits for N_{g}, 8 different values of N_{g} can be signalled. An example set of reported subcarriers for 320 MHz channel is shown in Table 4. It is noted that the subcarrier indices for other applicable channel widths may be similarly derived. It is further noted that the larger values of N_{g} (32, 64, 128) may be applicable for wider channels only (e.g., 320 MHz).

Alternatively, dynamic grouping may be used if it can be supported by both the initiator and the responder. In dynamic grouping, instead of using fixed grouping of the subcarriers with a give value of N_{g}, the feedback may be based on dynamic grouping of the subcarriers in which the distance between the subcarriers may vary based on the characteristics of the channel feedback.

TABLE 4
various N_{g} values and their corresponding example
sets of reported subcarriers for 320 MHz channel

| N_{g} | Superset of subcarrier indices (scidx) |
|---|---|
| 1 | −2036, −2035, −2034, −2033, −2032, −2031, . . . , −1, 1, . . . , |
| | 2031, 2032, 2033, 2034, 2035, 2036 |
| 2 | −2036, −2034, −2032, −2030, −2028, −2026, . . . , −2, 2, . . . , |
| | 2026, 2028, 2030, 2032, 2034, 2036 |
| 4 | −2036, −2032, −2028, −2024, −2020, −2016, . . . , −4, 4, . . . , |
| | 2016, 2020, 2024, 2028, 2032, 2036 |
| 8 | −2036, −2028, −2020, −2012, −2004, −1996, . . . , −8, 8, . . . , |
| | 1996, 2004, 2012, 2020, 2028, 2036 |
| 16 | −2036, −2020, −2004, −1988, −1972, −1956, . . . , −16, 16, |
| | . . . , 1956, 1972, 1988, 2004, 2020, 2036 |
| 32 | −2036, −2004, −1972, −1940, −1908, −1876, . . . , −32, 32, |
| | . . . , 1876, 1908, 1940, 1972, 2004, 2036 |
| 64 | −2036, −1972, −1908, −1844, −1780, −1716, . . . , −64, 64, |
| | . . . , 1716, 1780, 1844, 1908, 1972, 2036 |
| 128 | −2036, −1908, −1780, −1652, −1524, −1396, . . . , −128, |
| | 128, . . . , 1396, 1524, 1652, 1780, 1908, 2036 |

The following paragraphs explain the Sensing Initiator operation for Amplitude value decoding according to the first embodiment of the present disclosure.

For amplitude value decoding, the received, quantized amplitude matrix A^{q}(k) is decoded, as follows:
The decimal and fractional parts of the Maximum Amplitude indicated in the Measurement Report field are decoded as positive integers and the Maximum Amplitude ( [symbol] ) is recovered by combining the decimal and fractional parts;
Each element of the Amplitude Matrix, A_{(m,l)}^{q}(k), is decoded as a positive integer, where 1≤m≤Nᵣ and 1≤l≤N_{c}; and
Each element of the Amplitude Matrix, A_{(m,l)}^{q}(k), is then scaled using the value in the carrier matrix amplitude field (3 bits), M_{H}(k), interpreted as a positive integer, in dB, by calculating a linear value according to equation (7.1) and a decoded value of the Amplitude matrix element according to equation (7.2).

$$r ( k ) = 1 {0}^{{M}_{H} ( k ) / 20} \qquad Equation ( 7.1 )$$

$${\tilde{A}}_{( m , l )}^{q} ( k ) = \frac{{A}_{( m , l )} ( k )}{r ( k )} \times \frac{( {2}^{N} b - 1 )}{} \qquad Equation ( 7.2 )$$

For example, if the decimal and fractional parts of the Maximum Amplitude are 203 and 593, respectively, they are combined to obtain the Maximum Amplitude as 203.593. It is noted that, according to 802.11n decoding rules, the recovered CSI values (I and Q) remain normalized between −(2^{(Nb-1)}−1) and (2^{(Nb-1)}−1) and are not scaled back to the original CSI value range observed by the receiver. Similar to equation (7.2), the 802.11n CSI matrices decoding scheme can also be modified in similar manner such that the max{m_{H}(z)}_{z=-N}_{_{SR}}^{z=N}^{_{SR}}=Maximum of all Mₕ(k) over all subcarriers (e.g., using 24 bits) is used to scaled back the recovered real and imaginary CSI values to the original CSI value range observed by the receiver, except that max{m_{H}(z)}_{z=-N}_{_{SR}}^{z=N}^{_{SR}} is divided by (2^{N}^{_{b}}⁻¹-1) instead of (2^{Nb}−1). Alternatively, each element of the Amplitude Matrix, A_{(m,l)}^{q}(k), is decoded as a 2s complement number if 2s complement encoding is used by the Responder to encode the Amplitude Matrix. If equation (5.2) was used for the amplitude computation instead of equation (5.1) by the responder, the initiator (or the sensing application running on the initiator) performs the square root operation to recover the amplitude values.

In a simulation according to this embodiment which results are shown in Table 5, the 802.11n based decoding scheme is modified such that the recovered real (and imaginary) values are scaled according to the equation (8). It is noted that 24 bits are used to signal Max_m_{H}=max{m_{H}(z)}_{z=-N}_{_{SR}}^{z=N}^{_{SR}}.

TABLE 5
simulation results for amplitude values recovered from original CSI of a
measurement signal transmitted in 20 MHz channel (56 subcarriers) with 3 columns and
3 rows (N_{c} = 3, Nᵣ = 3) and Ng = 1 using the amplitude recovery
scheme as described in the first embodiment of the present disclosure

| | 802.11n rules based with | | | | | |
|---|---|---|---|---|---|---|
| | max(M_{H}(k)) scaling | | | | | |
| | | Total size of | This embodiment | | | |
| | | Feedback Bits | | Total size of | Difference | |
| | | 8 × Nᵣ + 24 + (3 + | | Feedback Bits | | Feedback |
| Feedback | SQNR | 2 × N_{b} × N_{c} × | SQNR | 8 × Nᵣ + 24 + (3 + | SQNR | Bit size |
| Bit size N_{b} | (dB) | Nᵣ) × Nₛ | (dB) | N_{b} × N_{c} × Nᵣ) × Nₛ | gain (dB) | reduction |
| 4 | 24.759 | 4248 | 31.035 | 2232 | 6.276 | 47.46 |
| 6 | 37.739 | 6264 | 43.520 | 3240 | 5.781 | 48.28 |
| 8 | 50.359 | 8280 | 55.479 | 4248 | 5.12 | 48.70 |

$${\tilde{H}}_{e f f ( m , l )}^{q ( R )} ( k ) = \frac{{\hat{H}}_{e f f ( m , l )}^{q ( R )} ( k )}{r ( k )} * \frac{( {2}^{{N}_{b} - 1} - 1 )}{} \qquad Equation ( 8 )$$

Signal-to-quantization-noise ratio (SQNR) is a measure of the quality of the quantization, or digital conversion of an analog signal. It may be defined as normalized signal power divided by normalized quantization noise power and is expressed as 10 log(Σx²/Σq²) (dB), where Y indicates the sum of all the values in the data, x is the source data (amplitude computed from the raw CSI) and q is the quantization noise (difference between x in the responder and the recovered quantized amplitude values in the initiator).

It is observed that by only reporting the amplitude sub-component as described in this embodiment of the present disclosure, a feedback bit size reduction of close to 50% and a 5-6 dB gain in SQNR can be achieved.

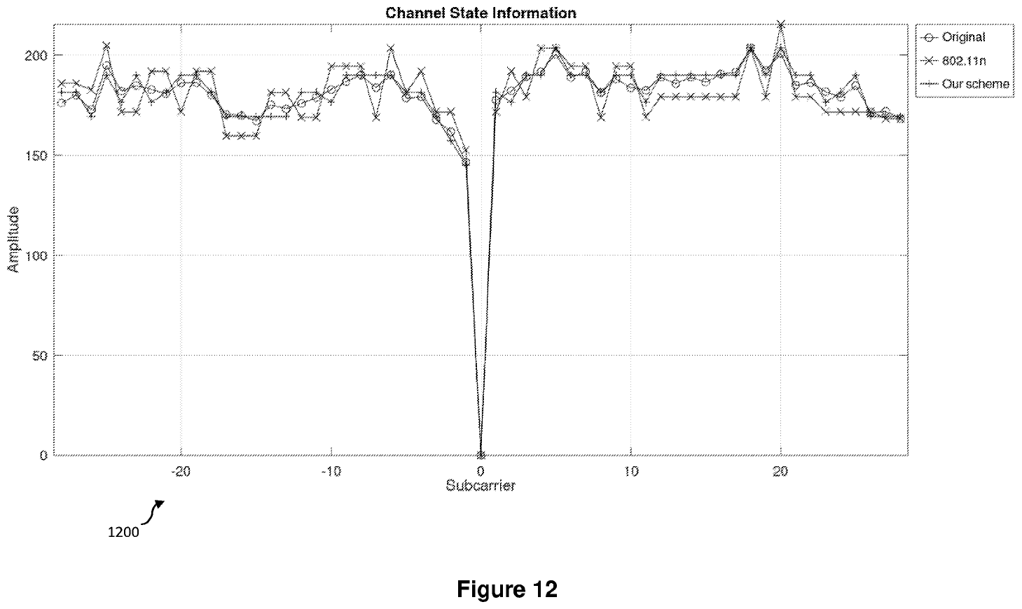

FIG. 12 shows a graph 1200 illustrating a simulation result of amplitude values recovered from CSI of a measurement signal according to the first embodiment of the present disclosure. The original CSI curve and the CSI curve recovered using conventional 802.11n rules (based with max(M_{H}(k)) scaling) with feedback bit size of 4248 are also shown. The number of bits (N_{b}) for each quantized value (I and Q for 802.11n, and amplitude values for our scheme) is 4. The amplitude curve (i.e., amplitude values over all 56 subcarriers) recovered from CSI according to the amplitude recovery scheme described in this embodiment has a feedback bit size of 2232 and is closer to the original curve as compared to the CSI curve recovered using 802.11n scheme. In general, it is noted that for a given feedback bit size (in this case, a reduced feedback bit size of 2232), the amplitude recovery scheme described this embodiment provides twice the number of bits (2*N_{b}) per entry compared to 802.11n scheme (N_{b}). For example, for the same feedback bit size of 8280, while 802.11n scheme uses Nb=8 for the real and imaginary parts of each entry of the CSI matrices, the amplitude recovery scheme described this embodiment can use Nb=16 bits for each entry of the amplitude matrices, thereby providing twice the resolution.

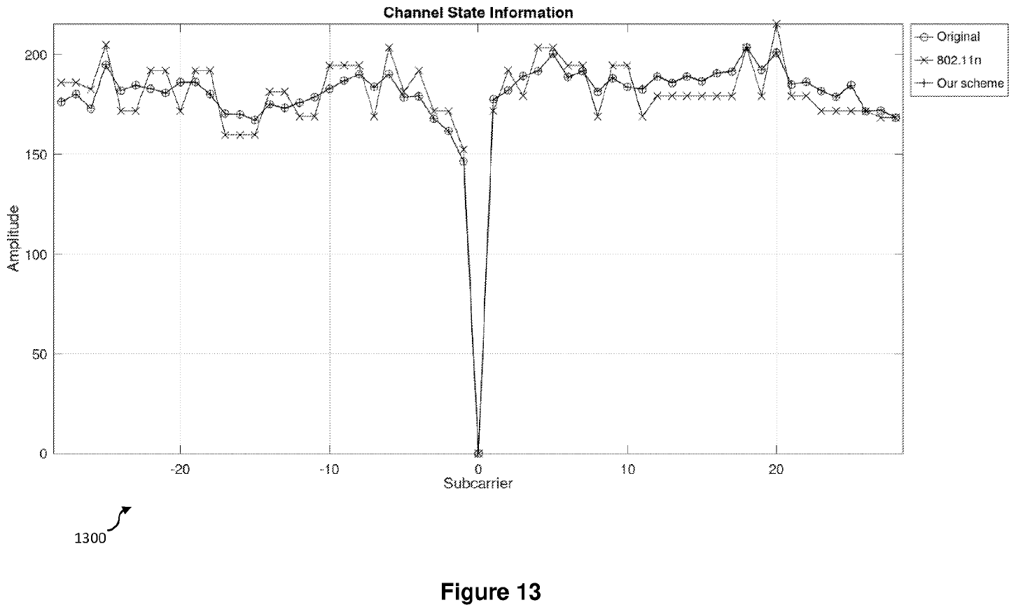

FIG. 13 shows a graph 1300 illustrating another simulation result of amplitude values recovered from CSI of a measurement signal with higher feedback bit size according to the first embodiment of the present disclosure. Following the simulation result in FIG. 12, if the feedback bit size of the amplitude sub-component recovered using the amplitude recovery scheme described this embodiment is increased to 4248, matching that of 802.11n scheme, while 802.11n scheme uses N_{b}=4 for the real and imaginary parts of each entry of the CSI matrices, the amplitude recovery scheme described this embodiment can use N_{b}=8 bits for each entry of the amplitude matrices. For this given feedback size of 4248, the amplitude sub-component recovery scheme of this embodiment generates an amplitude curve that is almost identical to the original CSI curve and achieves 30.72 dB gain in SQNR over the 802.11n scheme.

The following paragraphs explain the Sensing Initiator operation for phase value decoding according to the first embodiment of the present disclosure.

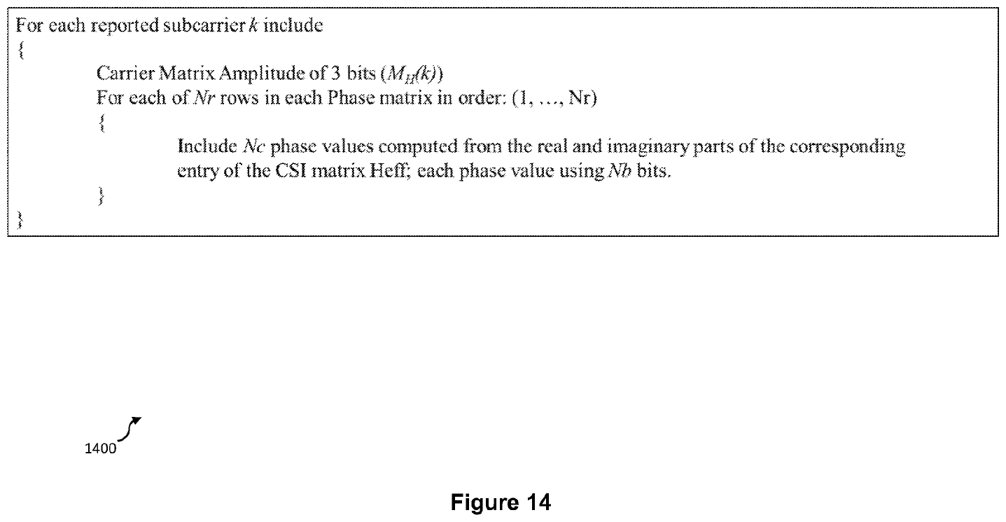

Upon receiving the Measurement PPDU (e.g., NDP), the receiver determines the CSI matrix H_{eff}, each element of which is a complex number comprising a real (I) and imaginary (Q) parts. The real and imaginary parts of element in the m^{th} row and l^{th} column of the CSI matrix for subcarrier k may be represented as Re(Heff(m, l)(k)) and Im(Heff(m, l)(k)), respectively. The phase value (in degrees) corresponding to the entry in the m^{th} row and l^{th} column of the CSI matrix for subcarrier k is computed using equation (9). The code structure of phase matrix P^{q}(k) for subcarrier k is illustrated in FIG. 14.

### Equation (9):

$${P}_{( m , l )} ( k ) = {tan}^{- 1} ( \frac{\vert Im ( Heff ( m , l ) ( k ) \vert}{\vert Re ( Heff ( m , l ) ( k ) ) \vert} )$$

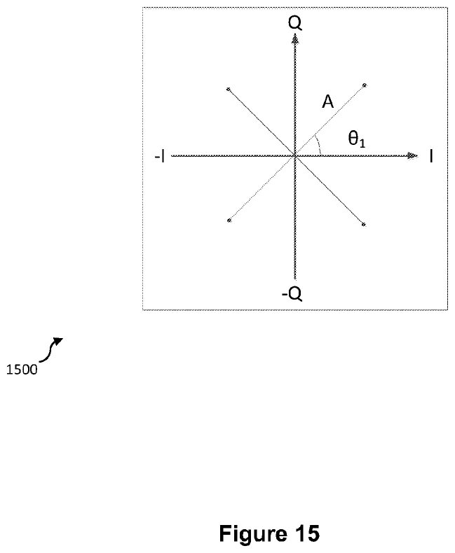

Equation (9) returns a phase value within a range of 0° to 90° corresponding to the top left quadrant of I-Q graph as illustrated in FIG. 15 is calculated. Therefore, adjustments to the phase values calculated from equation (9) to their correct quadrant are required based on the following conditions such that the phase value is in the range of −180° to 180°:
If Re (H_{eff}(m, l)(k)) is negative and Im (H_{eff}(m, l)(k)) is positive, P_{(m,l)}(k)=P_{(m,l)}(k)+90°; else
If Re (H_{eff}(m,l)(k)) is negative and Im(H_{eff}(m,l)(k)) is negative, P_{(m,l)}(k)=P_{(m,l)}(k)−180°; else
If Re (H_{eff}(m, l)(k)) is positive and Im (H_{eff}(m, l)(k)) is negative, P_{(m,l)}(k)=P_{(m,l)}(k)−90°.

The phase values may also be expressed in radians, in which case they will be in the range of −Pi to +Pi. If alternate functions are used to compute the phase instead of equation (9), and the return range is in −180 to 180, the phase adjustments are not required. For example, if equation (9) is expressed as P_{(m,l)}(k)=a tan 2 (Im(Heff(m, l)(k)), Re(Heff(m, l)(k))) which returns the phase values in the range of −180° to 180°, in which case no further phase value adjustment is required, whereas if equation (9) is expressed as

$${P}_{( m , l )} ( k ) = {tan}^{- 1} ( \frac{Im ( H e f f ( m , l ) ( k ) )}{Re ( H e f f ( m , l ) ( k ) )} ) ,$$

i.e., without performing absolute values of I and Q, since tan function returns angles in the range −90° to 90° and not in the range 0° to 90°, the phase value adjustment logic needs to be adjusted accordingly. Yet another alternative to equation (9) is not do the arctan function and only report the argument (i.e., the ratio of the magnitude of the imaginary part to the magnitude of the real part,

$$( \frac{Im ( H e f f ( m , l ) ( k ) )}{Re ( H e f f ( m , l ) ( k ) )} ) ) .$$

In this case the quadrant also needs to be reported, e.g., using 2 bits.

A two bits variable that represents the I/Q quadrant, q(k), is computed as:
If +ve Re(Heff(m, l)(k)) and +ve Im(Heff(m, l)(k)), q(k)=‘b00’; else
If −ve Re(Heff(m, l)(k)) and +ve Im(Heff(m, l)(k)), q(k)=‘b01’; else
If −ve Re(Heff(m, l)(k)) and −ve Im(Heff(m, l)(k)), q(k)=‘b10’; else
If +ve Re(Heff(m, l)(k)) and −ve Im(Heff(m, l)(k)), q(k)=‘b11’.

Since the Q/I ratio can take values in the range −Infinity to +Infinity, a sigmoid function with lesser computation complexity than arctan (e.g., logistic function f(x)=(1/(1+e^{x}))) may be used to bound the ratio values to a fixed range (e.g., 0 to 1).

Then the initiator (or the Sensing application running on the initiator) could use that ratio and quadrant, or it could perform the arctan function on the ratio if it really needs the angle in radians (or degrees). Also, if the ratio was processed with a sigmoid function at the responder side, the reverse sigmoid function (e.g., inverse logistic function x=ln(y/(1−y))) need to applied at the initiator side to recover the original ratio value.

If the receiver's physical layer (PHY) directly provides the CSI Amplitude and Phase instead of the real and imaginary parts of the CSI, equation (9) may be skipped. However, phase adjustment may be required to ensure phase is in the range −180° to 180°.

For phase value encoding and in order to signal the phase values using N_{b} bits, the following phase matrices feedback encoding is used, namely:
Maximum phase values of the phase matrix in each subcarrier k are calculated using equation (10.1), where the largest phase value over phase matrix for that subcarrier is calculated and used in the equation;
A scaling ratio is calculated for each reported subcarrier k based on a base-ten logarithm of a ratio of the largest m_{H}(k) over all subcarriers to the m_{H}(k) of this specific subcarrier k in decibel (dB) using equation (10.2) and quantized to 3 bits (0 to 7), and a linear scaler is given by equation (10.3) with the largest m_{H}(k) over all subcarriers in the numerator; and
Each element in the phase matrix is quantized to N_{b} bits in 2s complement encoding according to equation (10.4).

$${m}_{H} ( k ) = max \{ {\vert {P}_{( m , l )} ( k ) \vert}_{m = 1 , l = 1}^{m = Nr , l = Nc} \} \qquad Equation ( 10.1 )$$

$${M}_{H} ( k ) = min \{ 7 , ⌊ 20 log 10 ( \frac{max {\{ {m}_{H} ( z ) \}}_{z = - {N}_{S R}}^{z = {N}_{S R}}}{{m}_{H} ( k )} ) ⌋ \} \qquad Equation ( 10.2 )$$

N_{SR} indicates half the size of reported subcarriers excluding Nulls

$${M}_{H}^{l i n} ( k ) = \frac{max {\{ {m}_{H} ( z ) \}}_{z = - {N}_{S R}}^{z = {N}_{S R}}}{1 {0}^{{M}_{H} ( k )} / 20} \qquad Equation ( 10.3 )$$

$${P}_{( m , l )}^{q} ( k ) = ⌊ \frac{{P}_{( m , l )} ( k )}{{M}_{H}^{lin} ( k )} ( {2}^{N b - 1} - 1 ) + 0.5 ⌋ \qquad Equation ( 10.4 )$$

Since the phase values are in the range (−180 to 180 degrees) 2s complement encoding is used (same as 802.11n) and hence the quantized phase values are in the range of (2^{Nb-1}−1) to (2^{Nb-1}−1).

According to this embodiment of the present disclosure, each phase matrix is encoded using (3+N_{b}×N_{c}×Nᵣ) bits, as shown in Table 6, as compared to (3+2×N_{b}×N_{c}×Nᵣ) for 802.11n encoding rules. N_{c} and Nᵣ are the number of rows and columns, respectively, in the phase matrix estimate computed by the Sensing receiver.

Maximum Phase (Max_P)=max{m_{H}(z)}_{z=-N}_{_{SR}}^{z=N}^{_{SR}} in equation (6.2) is quantized as two unsigned integers (first 8-bits to carry the decimal part and second 16-bits to carry the fractional part rounded to 4 digits). For example, an 8-bits unsigned integer allows indication up to a value of (28-1)=255 which is enough to cover the maximum phase of 180°. While a 14-bits unsigned integer value allows indication of up to 4 digits of fractional part, i.e., up to 9999 (16-bits) are allocated to unify the field size with the Maximum Phase field in the Phase matrix. The fractional part is rounded to 4 digits, for example, a maximum phase value of 103.59273 is indicates as 103 and 5927.

TABLE 6
an example Measurement Report field (Phase), where scidx(n) is defined
to indicate the exact subcarrier index corresponding to the reported
subcarrier n; and Nₛ is the number of subcarriers for which the
phase matrix is reported and is a function of the grouping
parameter N_{g} (every N_{g} adjacent subcarrier is grouped
and a single value for each group of N_{g} adjacent subcarriers)

| Field | Size (bits) | Meaning |
|---|---|---|
| SNR in receive | 8 | SNR ratio in the first receive |
| chain 1 | | chain of the STA (chain 1) |
| | | sending the port |
| . . . | | |
| SNR in receive | 8 | SNR ratio in the Nᵣ -th |
| chain Nᵣ | | receive chain of the STA |
| | | (chain Nᵣ) sending the port |
| . . . | | |
| Maximum Phase | 14 + 10 = 24 | Maximum value over all |
| | | reported Amplitude values |
| | | (Max_P) quantized as two |
| | | unsigned integers (first 8-bits |
| | | to carry the decimal part and |
| | | second 16-bits to carry the |
| | | fractional part rounded to 4 |
| | | digits). |
| Phase matrix for | 3 + N_{b} × N_{c} × Nᵣ | Phase matrix according to |
| subcarrier | | FIG. 14 |
| k = scidx(0) | | |
| . . . | | |
| Phase matrix for | 3 + N_{b} × N_{c} × Nᵣ | Phase Matrix |
| subcarrier | | |
| k = scidx(Nₛ − 1) | | |

The 802.11n CSI Report can also be modified in similar manner such that instead of the Maximum Amplitude, it carries the max{m_{H}(z)}_{z=-N}_{_{SR}}^{z=N}^{_{SR}}=Maximum of all Mₕ(k) over all subcarriers (e.g., using 24 bits) and used to scaled back the recovered real and imaginary CSI values to the original CSI value range observed by the receiver. The Maximum Phase field may be omitted if 180° is fixed as the maximum absolute value of phases.

The following paragraphs explain the Sensing Initiator operation for phase value decoding according to the first embodiment of the present disclosure.

For phase value decoding by Sensing Initiator, the received, quantized phase matrix P^{q}(k) is decoded, as follows:
the decimal and fractional parts of the Maximum Phase indicated in the Measurement Report field are decoded as positive integers and the Maximum Amplitude ( [symbol] ) is recovered by combining the decimal and fractional parts. If the Maximum Phase field is omitted in the Measurement Report field, [symbol] =180°; [symbol]
each element of the Phase Matrix, P_{(m,l)}^{q}k), is decoded as a 2s complement number, where 1≤m≤Nᵣ and 1≤l≤N_{c}; and
each element of the Phase Matrix, P_{(m,l)}^{q}(k), is then scaled using the value in the carrier matrix amplitude field (3 bits), M_{H}(k), interpreted as a positive integer, in dB, by calculating a linear value according to equation (11.1) and a decoded value of the Phase matrix element according to equation (11.2).

$$r ( k ) = 1 {0}^{{M}_{H} ( k )} / 20 \qquad Equation ( 11.1 )$$

$${\tilde{P}}_{( m , l )}^{q} ( k ) = \frac{{P}_{( m , l )} ( k )}{r ( k )} \times \frac{( {2}^{N b - 1} - 1 )}{} \qquad Equation ( 11.2 )$$

In a simulation according to this embodiment which results are shown in Table 7, the 802.11n based decoding scheme is modified such that the recovered real (and imaginary) values are scaled according to the equation (8). It is noted that 24 bits are used to signal Max_m_{H}=max{m_{H}(z)}_{z=-N}_{_{SR}}^{z=N}^{_{SR}}. It is noted that If the Maximum Phase field is omitted, the feedback bits size is 8×Nᵣ+(3+N_{b}×N_{c}×Nᵣ)×Ns.

TABLE 7
simulation results for phase values recovered from original CSI of a measurement
signal transmitted in 20 MHz channel (56 subcarriers) with 3 columns and 3 rows
(N_{c} = 3, Nᵣ = 3), Ng = 1 and using the phase recovery scheme
as described in the first embodiment of the present disclosure

| | 802.11n rules based with | | | | | |
|---|---|---|---|---|---|---|
| | max(M_{H}(k)) scaling | | | | | |
| | | Total size of | This embodiment | | | |
| | | Feedback Bits | | Total size of | Difference | |
| | | 8 × Nᵣ + 24 + (3 + | | Feedback Bits | | Feedback |
| Feedback | SQNR | 2 × N_{b} × N_{c} × | SQNR | 8 × Nᵣ + 24 + (3 + | SQNR | Bit size |
| Bit size N_{b} | (dB) | Nᵣ) × Nₛ | (dB) | N_{b} × N_{c} × Nᵣ) × Nₛ | gain (dB) | reduction |
| 4 | 25.699 | 4248 | 23.262 | 2232 | −2.4376 | 47.46 |
| 6 | 38.008 | 6264 | 35.803 | 3240 | −2.2049 | 48.28 |
| 8 | 49.340 | 8280 | 47.823 | 4248 | −1.5176 | 48.70 |

It is observed that by only reporting the phase sub-component as described in this embodiment of the present disclosure, a feedback bit size reduction of close to 50% with just a small loss in SQNR can be achieved.

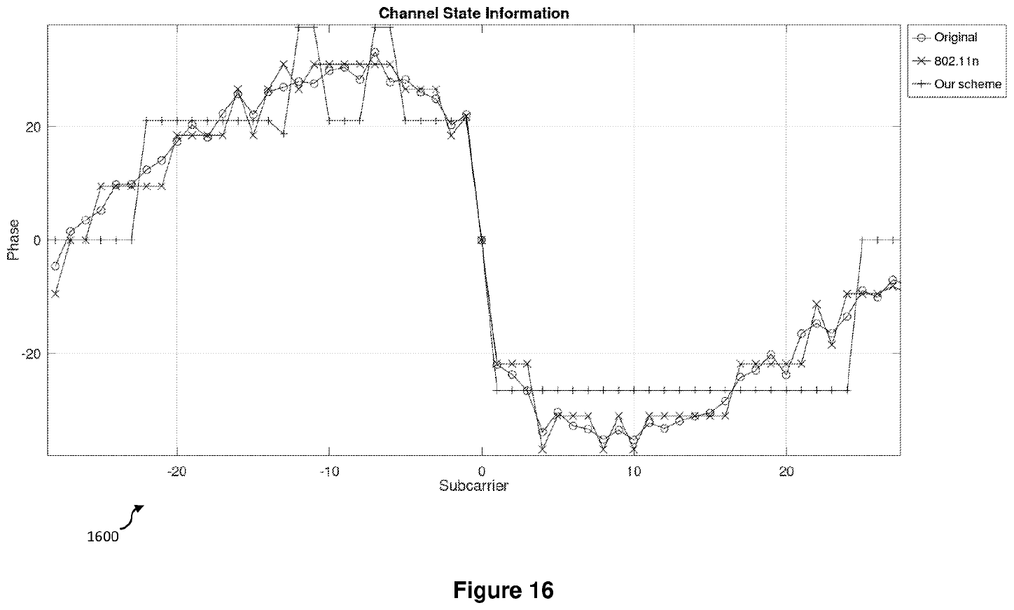

FIG. 16 shows a graph 1600 illustrating the simulation result of phase values recovered from CSI of a measurement signal according to the first embodiment of the present disclosure. The original CSI curve and the CSI curve recovered using conventional 802.11n rules (based with max(M_{H}(k)) scaling) with feedback bit size of 4248 are also shown. The number of bits (N_{b}) for each quantized value (I and Q for 802.11n, and phase values for our scheme) is 4. The phase curve (i.e., phase values over all 56 subcarriers) recovered from CSI according to the amplitude recovery scheme described in this embodiment has a feedback bit size of 2232.

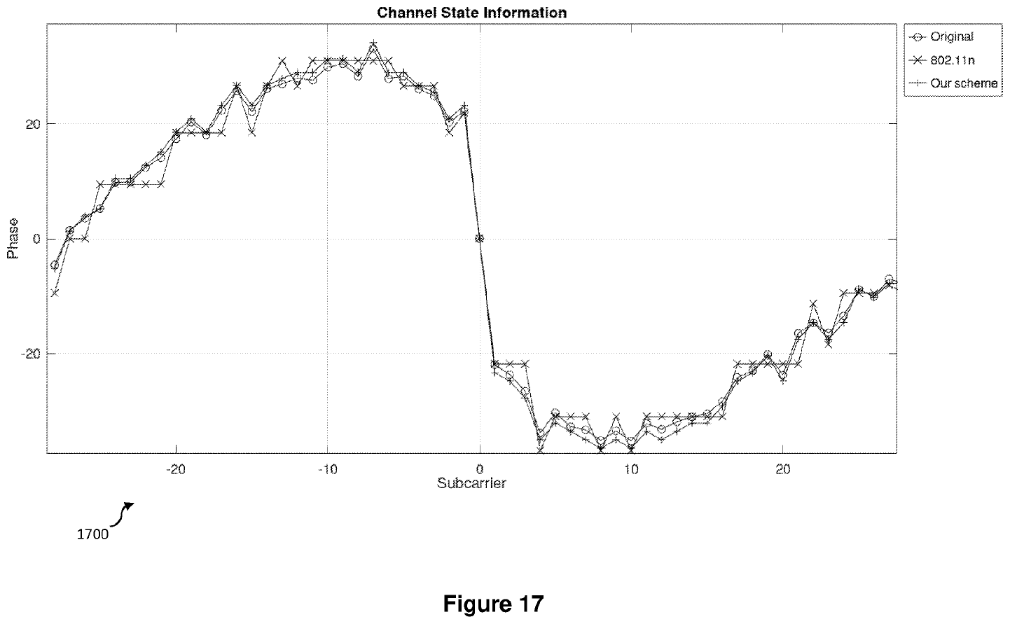

FIG. 17 shows a graph 1700 illustrating another simulation result of phase values recovered from CSI of a measurement signal with higher feedback bit size according to the first embodiment of the present disclosure. If the feedback bit size of the amplitude sub-component recovered using the phase recovery scheme described this embodiment is increased to 4248, matching that of 802.11n scheme, the phase curve (i.e., phases values over all 56 subcarriers) recovered from CSI according to the phase recovery scheme described in this embodiment is almost identical to the original curve as compared to the CSI curve recovered using the 802.11n scheme. In general, it is noted that for a given feedback bit size, our scheme provides twice the number of bits (2*N_{b}) per entry compared to 802.11n scheme (N_{b}). For example, for the same feedback bit size of 8280, while 802.11n uses N_{b}=8 for the real and imaginary part of each entry of the CSI Matrices, our scheme can use N_{b}=16 bits for each entry of the Phase Matrices, thereby providing twice the resolution.

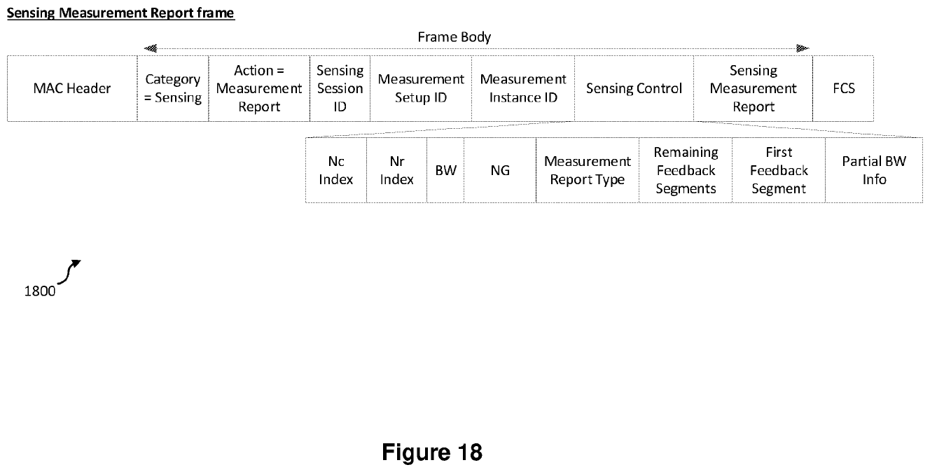

FIG. 18 shows an example Sensing Measurement Report frame 1800 according to the first embodiment of the present disclosure. As illustrated in FIGS. 6, 7 and 8 using blocks 616, 715, 726, 815, 827, such Sensing Measurement Report frame 1800 is used to report carry sensing feedback report. It is a new action frame, which comprises a MAC Header, a Category field (set to “Sensing”), an Action field (set to “Measurement Report”), a Sensing Session ID field, a Measurement Setup ID field, a Sensing Control field, a Sensing Measurement Report field and a FCS field. The Measurement Setup ID field carries a measurement setup ID, for example the measurement setup ID of the Sensing Measurement Setup Request/Response frame 900/1000. The Measurement Instance ID field carries a measurement instance ID, for example, the measurement instance ID of the Sensing NDPA frame 812, 814 (measurement signal). The Sensing Measurement Report frame carries the sensing feedback report in the format described in Table 3 or 6. The Sensing Control field further comprises a N_{c} Index field, a Nᵣ Index field, a Bandwidth (BW) field, a N_{g} field, a Measurement Report Type field, a Remaining Feedback Segment field, a First Feedback Segment field and a Partial BW Info field. The Measurement Report Type field indicates a measurement report type according to Table 2, for example the measurement report type corresponding to that indicated in the Sensing Measurement Setup Request/Response frame 900/1000 during the Setup phase. The Sensing Control field may further also carry a Measurement timestamp field (not shown) that contains the lower 4 octets of the timing synchronization function (TSF) timer sampled at the instant that the MAC received the PHY-CCA.indication(IDLE) primitive that corresponds to the end of the reception of the Measurement PPDU (e.g., an NDP) that was used to generate the feedback information contained in the frame. This is especially pertinent for the Delayed Reporting case.

In the following paragraphs, a second embodiment of the present disclosure which relates to a report type indication indicated in a measurement signal at each measurement instance is explained.

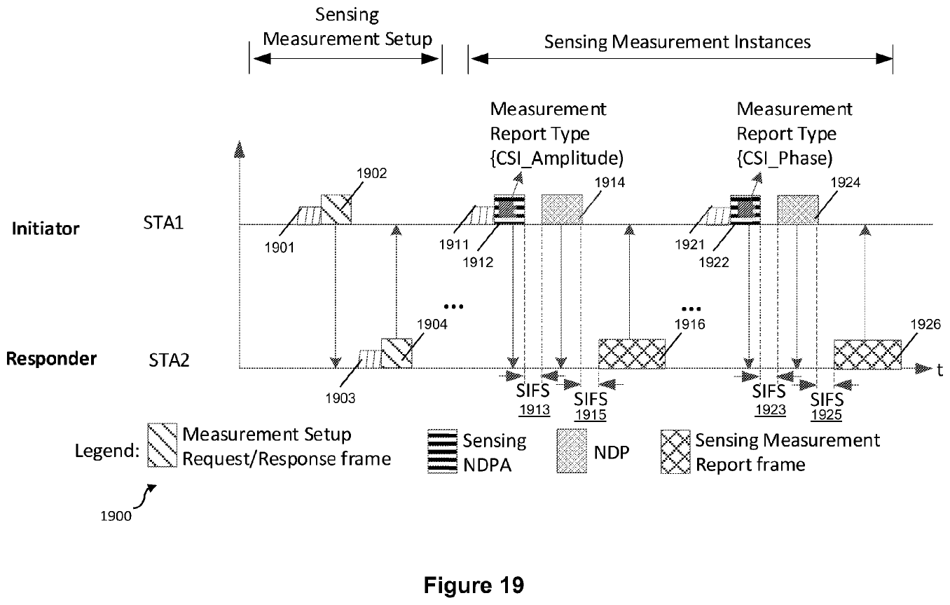

In this second embodiment, a Sensing Initiator is also a Sensing Transmitter, while a Sensing Responder is also a Sensing Receiver. FIG. 19 shows a flow diagram 1900 illustrating first exemplary communication for performing sensing measurements to obtain CSI sub-component information according to the second embodiment of the present disclosure. Contention based channel access procedures, e.g., Enhanced Distributed Channel Access (EDCA) procedures, illustrated by blocks 1901, 1903, 1911, 1921 are carried out prior to transmission of Measurement Setup Request/Response frames and Sensing NDPA frames. During Measurement Setup phase, a Sensing Initiator (STA1) exchanges Measurement Setup Request/Response frames 1902, 1904 with a Sensing Responder (STA2). Subsequently, at each sensing measurement instance, STA1 transmits a Sensing NDPA frame 1912, 1922, followed by a Sensing Measurement PPDU (in this case, an NDP 1914, 1924) after a SIFS 1913, 1923. According to the second embodiment, the Sensing NDPA frame 1912, 1922 carries the measurement report type indication indicating a CSI sub-component (amplitude, phase or CSI (I and Q) to be reported by the Sensing Responder. In this case, the Sensing NDPA frames 1912, 1922 at the first measurement instance and the second measurement instance indicate different measurement types, i.e., amplitude and phase measurement report types, respectively. Advantageously, such different measurement types indication and selection provides greater flexibility.

STA2 which receives the Sensing NDPA frame 1912, 1922 and the NDP 1914, 1924 then performs sensing measurements on the NDP 1914, 1924 to obtain the CSI. STA2 computes the indicated sub-component from the measured CSI (i.e., amplitude from the NDP 1914 received at the first measurement instance and phase from the NDP 1924 received at the second measurement instance) and reports the CSI information of the indicated sub-component to the Sensing Initiator in the Sensing Measurement Report frames 1916, 1926.

After a SIFS 1915, 1925 following the reception of the NDP 1914, 1924 by STA2, STA2 transmits a Sensing Measurement Report frame 1916, 1926 to STA1. In this embodiment, base-10 operations are replaced by base-2 operations in the CSI/Amplitude/Phase Matrices feedback encoding/decoding processes.

Similarly, in one alternative implementation, when supported/allowed, it is also possible that the Sensing Measurement Report frame carrying the CSI/Amplitude/Phase feedback for a Measurement Instance is not required to be transmitted immediately (after SIFS) after reception of the Measurement PPDU (e.g., NDP) but may be allowed to be transmitted after a delay, for example, SIFS after receiving the Measurement PPDU for the next measurement instance or even in the Responder STA's own transmission opportunity (TXOP).

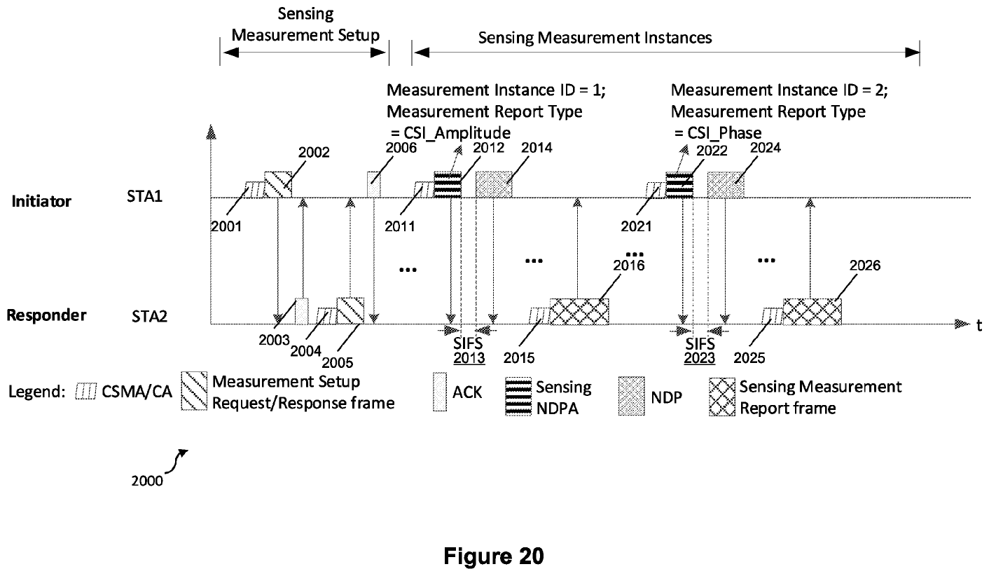

FIG. 20 shows a flow diagram 2000 illustrating second exemplary communication for performing sensing measurements to obtain CSI sub-component information according to the second embodiment of the present disclosure. Contention based channel access procedures, e.g. EDCA procedures, illustrated by blocks 2001, 2004, 2011, 2015, 2021, 2025 are carried out prior to transmission of Measurement Setup Request/Response frames and Sensing NDPA frame. During Measurement Setup phase, a Sensing Initiator (STA1) exchanges Measurement Setup Request/Response frames 2002, 2005 and ACK frames 2003, 2006 with a Sensing Responder (STA2) in an order illustrated in FIG. 20. Subsequently, at each sensing measurement instance, STA1 transmits a Sensing NDPA frame 2012, 2022, followed by a Sensing Measurement PPDU (in this case, an NDP 2014, 2024) after a SIFS 813, 823. Each Sensing NDPA frame 2012, 2022 indicates a Measurement Instance ID (1 or 2) identifying the sensing measurement instance of the NDPA frames 2012, 2022 as well as a measurement report type (e.g., amplitude, phase, I, Q or full CSI (I and Q)) to be reported by a Sensing Responder (STA2) for the measurement instance. In this case, the Sensing NDPA frames 2012, 20122 at the first measurement instance (ID=1) and the second measurement instance (ID=2) indicate different measurement types, i.e., amplitude and phase measurement report types, respectively.

STA2 which receives the Sensing NDPA frame 2012, 2022 and the NDP 2014, 2024 then performs sensing measurements on the NDP 2014, 2024 to obtain the CSI. STA2 computes the indicated sub-component from the measured CSI (i.e., amplitude from the NDP 2014 received at the first measurement instance and phase from the NDP 2024 received at the second measurement instance) and reports the CSI information of the indicated sub-component to the Sensing Initiator in the Sensing Measurement Report frames 2016, 2026.

After a SIFS 2015, 2025 following the reception of the NDP 2014, 2024 by STA2, STA2 transmits a Sensing Measurement Report frame 2016, 2026 to STA1.

In this implementation, STA2 transmits the respective Sensing Measurement Report frames 2016, 2026 carrying amplitude feedback report for the first measurement instance (ID=1 (and phase feedback report for the second measurement instance (ID=2) not immediately (after SIFS) after reception of the NDP 2014, 2024, but after a time delay.

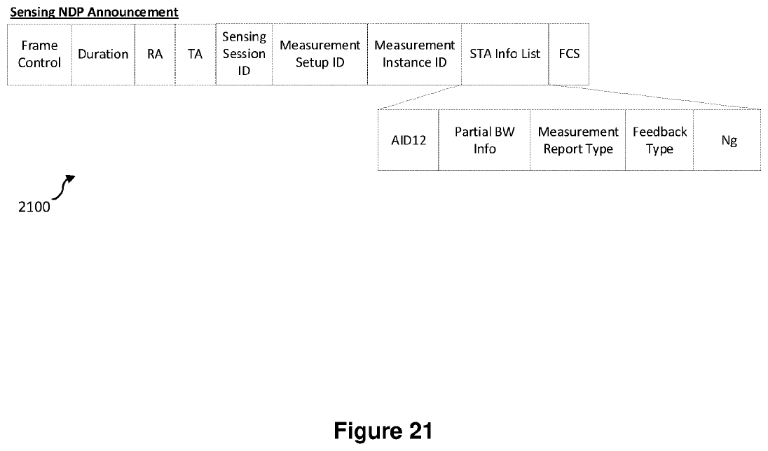

FIG. 21 shows an example Sensing NDPA frame 2100 according to the second embodiment of the present disclosure. The Sensing NDPA frame is a new control frame defined to announce the start of a sensing feedback sequence (i.e., to announce that the transmission of the sensing NDP will occur soon) and to solicit sensing feedback from indicated STAs). The Sensing NDPA frame comprises a Frame Control field, a Duration field, a Receiver Address (RA) field, a Transmitter Address (TA) field, a Sensing Session ID field, a Measurement Setup ID field, a Measurement Instance ID field, a STA Info List field and a FCS field. The Measurement Setup ID carries a measurement setup ID and the Measurement Instance ID field carries a measurement instance ID. The STA Info List field further comprises an AID12 field, a Partial BW Info field, a Measurement Report Type field, a Feedback Type field and a Ng field. The Measurement Report Type field indicates a measurement report type according to Table 2. Alternatively, existing NDPA frames (e.g., VHT, HE, EHT NDPA frame) may carry additional indication to announce the start of a sensing feedback sequence. In such case some reserved bits may be used to indicate the Measurement Report Type.

The following paragraphs explain the Sensing Receiver operation for CSI/amplitude/phase matrices reporting according to the second embodiment of the present disclosure.

The CSI matrices feedback encoding and decoding process in 802.11 uses log base-10 operations such as equations (6.2) and (10.2). In this embodiment, the base-10 operations in the CSI/amplitude/phase matrices feedback encoding/decoding processes are replaced with base-2 operations using equation (12.1). In particular,

$$6 {log}_{2} ( \frac{max {\{ {m}_{H} ( z ) \}}_{z = - {N}_{S R}}^{z = {N}_{S R}}}{m H ( k )} )$$

replaces

$$20 {log}_{10} ( \frac{max {\{ {m}_{H} ( z ) \}}_{z = - {N}_{S R}}^{z = {N}_{S R}}}{m H ( k )} )$$

so that the range is comparable to that of base-10. It is well-known that base-2 operations can be processed much more efficiency by programs (e.g., using bits shifting to achieve multiplication and divisions by 2 by shifting a binary number left and right respectively, assuming most significant bits is the leftmost bit.

$${M}_{H} ( k ) = min \{ 7 , ⌊ 6 log 2 ( \frac{max {\{ {m}_{H} ( z ) \}}_{z = - {N}_{S R}}^{z = {N}_{S R}}}{m H ( k )} ) ⌋ \} \qquad Equation ( 12.1 )$$

Floor(y log 2(x)) can also be found efficiently by bit shifting, e.g., using octave/MATLAB code, as follows, where “result” found in the below code is equal to floor(y log 2(x)):
result=0;
z=power(x,y); % y log(x)=log(x\hat{ }y)=>z=x\hat{ }y
while (z>1)
z=z>>1; //shift 1 bit to the right
result++;
endwhile

During amplitude/phase value encoding, besides log 10 equations (6.2) and (10.2) are replaced with log 2 equation (12.1), the equations (6.2) and (10.2) for calculating scaling ratio for each reported subcarrier k are replaced with equation (12.2), and the scaling ration is quantized to 3 bits (0-7). The equations (6.3) and (10.3) for linear scaler calculation are replaced with equation (12.3).

$${M}_{H} ( k ) = min \{ 7 , ⌊ Csr log 2 ( \frac{max {\{ {m}_{H} ( z ) \}}_{z = - {N}_{S R}}^{z = {N}_{S R}}}{m H ( k )} ) ⌋ \} \qquad Equation ( 12.2 )$$

$${M}_{H}^{l i n} ( k ) = \frac{max {\{ {m}_{H} ( z ) \}}_{z = - {N}_{S R}}^{z = {N}_{S R}}}{{2}^{{M}_{H} ( k )} / Csr} \qquad Equation ( 12.3 )$$

It is noted that Csr is a constant value used to control the dynamic range versus resolution tradeoff. As mentioned earlier, setting it as 6 makes the equation (12.2) comparable with equations (6.2) and (10.2). The value of Csr may be fixed by the 802.11bf specification, or it may also be negotiated between the initiator and responder and set to different values, e.g., 4 or 8, for example during the Sensing Setup negotiation. Further, equation (12.2) can be applied in lieu of equations (6.2) and (10.2) for the operations according to the first embodiment of the present disclosure to achieve more efficient encoding/decoding of CSI matrices using base-2 operations.

Similarly, during decoding, the equation (7.1) and (11.1) for linear value calculation is replaced with equation (13).

$$r ( k ) = {2}^{{M}_{H} ( k )} / Csr \qquad Equation ( 13 )$$

TABLE 8
simulation results for amplitude values recovered from original CSI of a
measurement signal transmitted in 20 MHz channel (56 subcarriers) with 3 columns and
3 rows (N_{c} = 3, Nᵣ = 3), Ng = 1 and using the amplitude
recovery scheme described in the second embodiment of the present disclosure

| | 802.11n rules based with | | | | | |
|---|---|---|---|---|---|---|
| | max(M_{H}(k)) scaling | | | | | |
| | | Total size of | This embodiment | | | |
| | | Feedback Bits | | Total size of | Difference | |
| | | 8 × Nᵣ + 24 + (3 + | | Feedback Bits | | Feedback |
| Feedback | SQNR | 2 × N_{b} × N_{c} × | SQNR | 8 × Nᵣ + 24 + (3 + | SQNR | Bit size |
| Bit size N_{b} | (dB) | Nᵣ) × Nₛ | (dB) | N_{b} × N_{c} × Nᵣ) × Nₛ | gain (dB) | reduction |
| 4 | 24.759 | 4248 | 31.035 | 2232 | 6.276 | 47.46 |
| 6 | 37.739 | 6264 | 43.524 | 3240 | 5.7858 | 48.28 |
| 8 | 50.359 | 8280 | 55.456 | 4248 | 5.0977 | 48.70 |

In a simulation according to this embodiment which results are shown in Table 8, The 802.11n based decoding scheme is modified such that the recovered real (and imaginary) values are scaled according to the equation (8). It is noted that 24 bits are used to signal Max_m_{H}=max{m_{H}(z)}_{z=-N}_{_{SR}}^{z=N}^{_{SR}}.

It is observed that by only reporting the amplitude recovery scheme as described in this embodiment of the present disclosure using base-2 operations is comparable to the amplitude recovery scheme using base-10 operations. Besides that, a feedback bit size reduction of close to 50% with around 5-6 dB gain in SQNR can be achieved as compared to the 802.11 scheme.

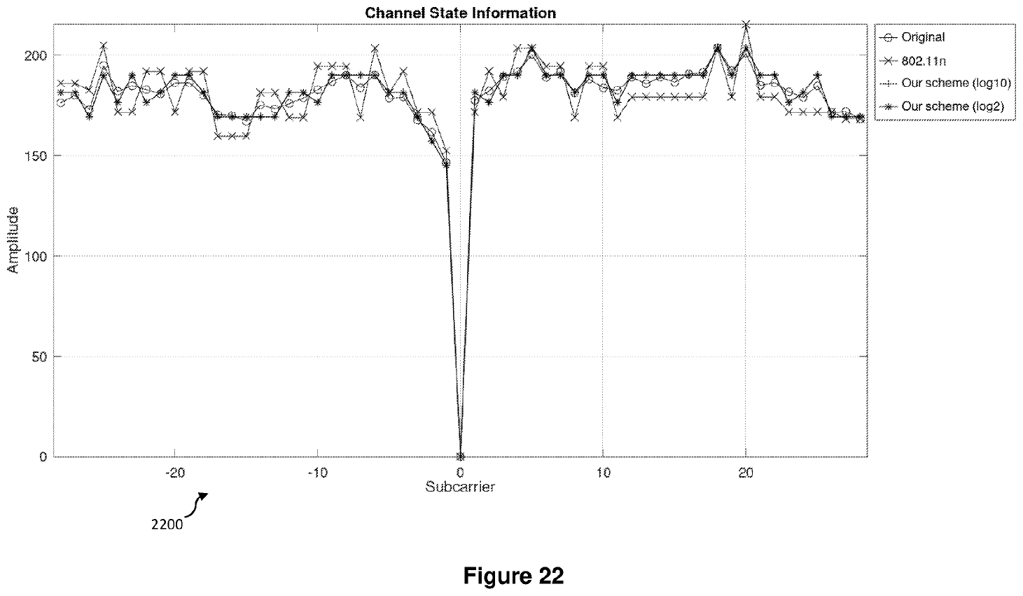

FIG. 22 shows a graph 2200 illustrating a simulation result of amplitude values recovered from CSI of a measurement signal according to the second embodiment of the present disclosure. The original CSI curve and the CSI curve recovered using conventional 802.11n scheme (based with max(M_{H}(k)) scaling) with feedback bit size of 4248 are also shown. The number of bits (N_{b}) for each quantized value (I and Q for 802.11n, and amplitude values for our scheme) is 4. The amplitude curve (i.e., amplitude values over all 56 subcarriers) recovered from CSI according to the amplitude recovery scheme described in this embodiment has a feedback bit size of 2232.

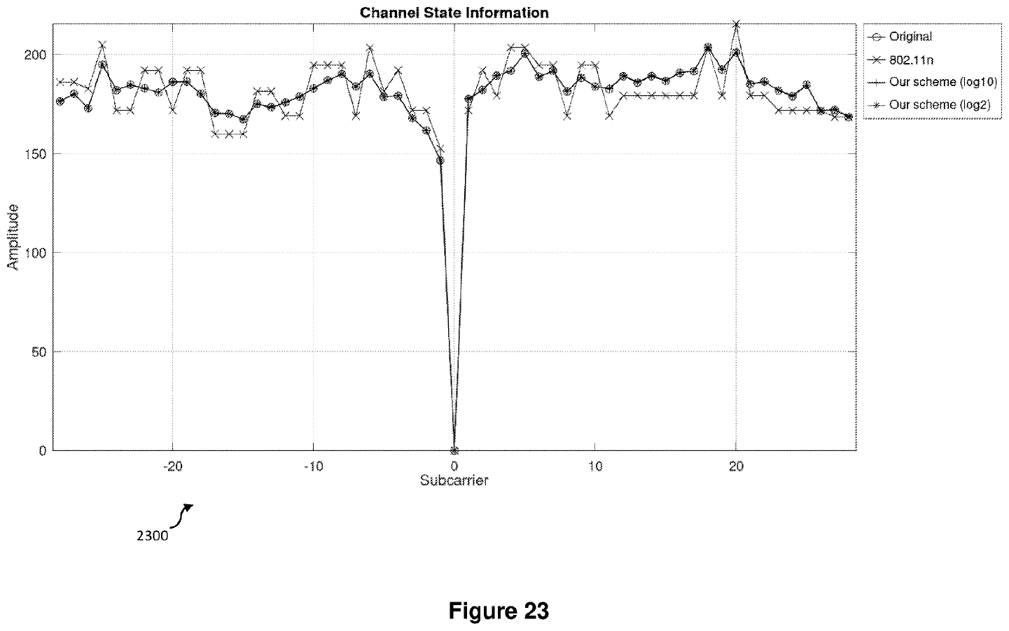

FIG. 23 shows a graph 2300 illustrating another simulation result of amplitude values recovered from CSI of a measurement signal with higher feedback bit size according to the second embodiment of the present disclosure. If the feedback bit size of the amplitude sub-component recovered using the amplitude recovery scheme described this embodiment is increased to 4248, matching that of 802.11n scheme, while 802.11n scheme uses N_{b}=4 for the real and imaginary parts of each entry of the CSI matrices, the amplitude recovery scheme described this embodiment can use N_{b}=8 bits for each entry of the amplitude matrices. For this given feedback size (4248), the base-2 amplitude sub-component recovery scheme of this embodiment generates an amplitude curve that is almost identical to the original CSI curve and achieves 30.697 dB gain in SQNR over the 802.11n scheme.

The following paragraphs explain a simplified Sensing Receiver operation for phase value encoding without relative scaling between subcarriers according to the second embodiment of the present disclosure.

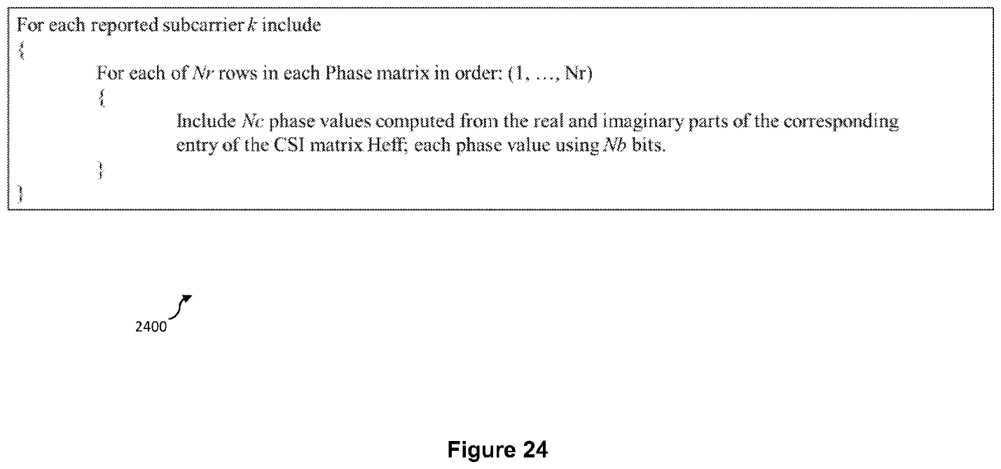

For phase sub-component, it is observed that at most time, the phase values are distributed over the whole ranges of −180° to 180°, which case the encoding and decoding process can be simplified by skipping the relative scaling between subcarriers that uses base-10 operations. The code structure of phase matrix P^{q}(k) for subcarrier k is illustrated in FIG. 24.

In order to signal the phase values using N_{b} bits, the following simplified phase matrices feedback encoding is used, namely:
Maximum phase values of the amplitude matrix in each subcarrier k are calculated using equation (14.1), where the largest phase value over phase matrix for that subcarrier is calculated and used in the equation;
a linear scaler is simplified and given by equation (14.2); and
Each element in the phase matrix is quantized to N_{b} bits in 2s complement encoding according to equation (14.3).

$${m}_{H} ( k ) = max \{ {\vert {P}_{( m , l )} ( k ) \vert}_{m = 1 , l = 1}^{m = Nr , l = Nc} \} \qquad Equation ( 14.1 )$$

$$Max\_P = max {\{ {m}_{H} ( z ) \}}_{z = - {N}_{S R}}^{z = {N}_{S R}} \qquad Equation ( 14.2 )$$

where N_{SR} indicates half the size of reported subcarriers excluding Nulls

$${P}_{( m , l )}^{q} ( k ) = ⌊ \frac{{P}_{( m , l )} ( k )}{Max\_P} ( {2}^{N b - 1} - 1 ) + 0.5 ⌋ \qquad Equation ( 14.3 )$$

Since the phase values are in the range of −180° to 180°, 2s complement encoding is used and hence the quantized phase values are in the range of −(2^{Nb-1}−1) to (2^{Nb-1}−1) If 180° is fixed as the maximum absolute value of phases, the encoding process can be further simplifying by setting Max_P as 180° and omitting equations (14.1) and (14.2) as well.

TABLE 9
an example Measurement Report field (Phase), where scidx(n) is defined
to indicate the exact subcarrier index corresponding to the reported
subcarrier n; and Nₛ is the number of subcarriers for which the
phase matrix is reported and is a function of the grouping parameter
N_{g} (every N_{g} adjacent subcarrier is grouped and a
single value for each group of N_{g} adjacent subcarriers)

| Field | Size (bits) | Meaning |
|---|---|---|
| SNR in receive chain 1 | 8 | SNR ratio in the first receive |
| | | chain of the STA (chain 1) |
| | | sending the port |
| . . . | | |
| SNR in receive chain Nᵣ | 8 | SNR ratio in the Nᵣ -th |
| | | receive chain of the STA |
| | | (chain Nᵣ) sending the port |
| . . . | | |
| Maximum Phase | 8 + 16 = 24 | Maximum value over the |
| | | absolute values of all |
| | | reported phase values |
| | | (Max_P) quantized as two |
| | | unsigned integers (first 8-bits |
| | | to carry the decimal part and |
| | | second 16-bits to carry the |
| | | fractional part rounded to 4 |
| | | digits). |
| Phase matrix for | N_{b} × N_{c} × Nᵣ | Phase matrix according to |
| subcarrier | | FIG. 24 |
| k = scidx(0) | | |
| . . . | | |
| Phase matrix for | N_{b} × N_{c} × Nᵣ | Phase Matrix |
| subcarrier | | |
| k = scidx(Nₛ − 1) | | |

According to this embodiment of the present disclosure, each phase matrix is encoded using (N_{b}×N_{c}×Nᵣ) bits, as shown in Table 9, as compared to (3+2×N_{b}×N_{c}×Nᵣ) for 802.11n encoding rules. N_{c} and Nᵣ are the number of rows and columns, respectively, in the channel matrix estimate computed by the Sensing receiver.

Maximum Phase (Max_P)=max{m_{H}(z)}_{z=-N}_{_{SR}}^{z=N}^{_{SR}}, in equation (14.2) is quantized as two unsigned integers (first 8-bits to carry the decimal part and second 16-bits to carry the fractional part rounded to 4 digits). For example, an 8-bits unsigned integer allows indication up to a value of (28-1)=255 which is enough to cover the maximum phase of 180°. While a 14-bits unsigned integer value allows indication of up to 4 digits of fractional part, i.e., up to 9999 (16-bits) are allocated to unify the field size with the Maximum Phase field in the Phase matrix. The fractional part is rounded to 4 digits, for example, a maximum phase value of 103.59273 is indicates as 103 and 5927.

The 802.11n CSI Report can also be modified in similar manner such that instead of the Maximum Amplitude, it carries the max{m_{H}(z)}_{z=-N}_{_{SR}}^{z=N}^{_{SR}}=Maximum of all Mₕ(k) over all subcarriers (e.g., using 24 bits) and used to scaled back the recovered real and imaginary CSI values to the original CSI value range observed by the receiver. The Maximum Phase field may be omitted if 180° is fixed as the maximum absolute value of phases.

The following paragraphs explain the Sensing Initiator operation for phase value decoding according to the second embodiment of the present disclosure.

For phase value decoding by Sensing Initiator, the received, quantized phase matrix P^{q}(k) is decoded, as follows:
the decimal and fractional parts of the Maximum Phase indicated in the Measurement Report field are decoded as positive integers and the Maximum Amplitude ( [symbol] ) is recovered by combining the decimal and fractional parts. If the Maximum Phase field is omitted in the Measurement Report field, [symbol] =180°;
each element of the Phase Matrix, P_{(m,l)}^{q}(k), is decoded as a 2s complement number, where 1≤m≤Nᵣ and 1≤l≤N_{c}; and
each element of the Phase Matrix, P_{(m,l)}^{q}(k), is calculated according to equation (15).

$${\tilde{P}}_{( m , l )}^{q} ( k ) = {P}_{( m , l )} ( k ) \times \frac{( {2}^{N b - 1} - 1 )}{} \qquad Equation ( 15 )$$

TABLE 10
simulation results for phase values recovered from original CSI of a measurement signal transmitted
in 20 MHz channel (56 subcarriers) with 3 columns and 3 rows (N_{c} = 3, Nᵣ = 3) using
the phase recovery scheme described in the second embodiment of the present disclosure

| | 802.11n rules based with | | | | | |
|---|---|---|---|---|---|---|
| | max(M_{H}(k)) scaling | | | | | |
| | | Total size of | This embodiment | | | |
| | | Feedback Bits | | Total size of | Difference | |
| | | 8 × Nᵣ + 24 + (3 + | | Feedback Bits | | Feedback |
| Feedback | SQNR | 2 × N_{b} × N_{c} × | SQNR | 8 × Nᵣ + 24 + (3 + | SQNR | Bit size |
| Bit size N_{b} | (dB) | Nᵣ) × Nₛ | (dB) | N_{b} × N_{c} × Nᵣ) × Nₛ | gain (dB) | reduction |
| 4 | 25.699 | 4248 | 23.262 | 2064 | −2.4376 | 54.41 |
| 6 | 38.008 | 6264 | 35.803 | 3072 | −2.2049 | 50.95 |
| 8 | 49.340 | 8280 | 47.823 | 4080 | −1.5176 | 50.72 |

In a simulation according to this embodiment which results are shown in Table 10, the 802.11n based decoding scheme is modified such that the recovered real (and imaginary) values are scaled according to the equation (8). It is noted that 24 bits are used to signal Max_m_{H}=max{m_{H}(z)}_{z=-N}_{_{SR}}^{z=N}^{_{SR}}. It is noted that If the Maximum Phase field is omitted, the feedback bits size is 8×Nᵣ+(N_{b}×N_{c}×Nᵣ)×Ns.

It is observed that by only reporting the phase sub-component as described in this embodiment of the present disclosure, a feedback bit size reduction of close to 50% with just a small loss in SQNR can be achieved.

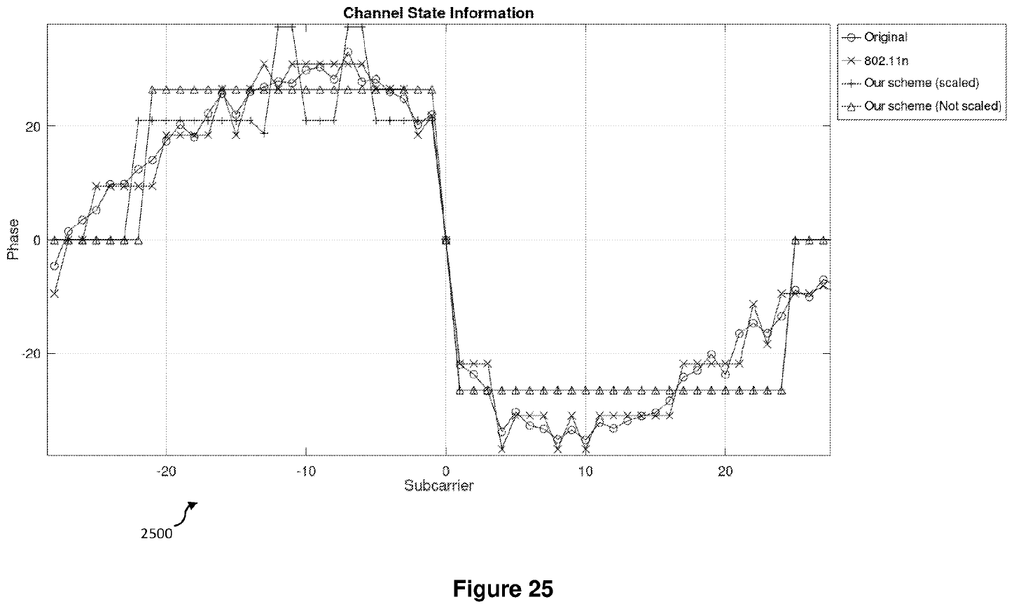

FIG. 25 shows a graph 2500 illustrating simulation results of phase values recovered from CSI of a measurement signal with and without scaling according to the second embodiment of the present disclosure. The original CSI curve and the CSI curve recovered using conventional 802.11n rules (based with max(M_{H}(k)) scaling) with feedback bit size of 4248 are also shown. The number of bits (N_{b}) for each quantized value (I and Q for 802.11n, and phase values for our scheme) is 4. The phase curves (i.e., phase values over all 56 subcarriers) recovered from CSI with and without scaling are exactly the same and have a feedback bit size of 2064.

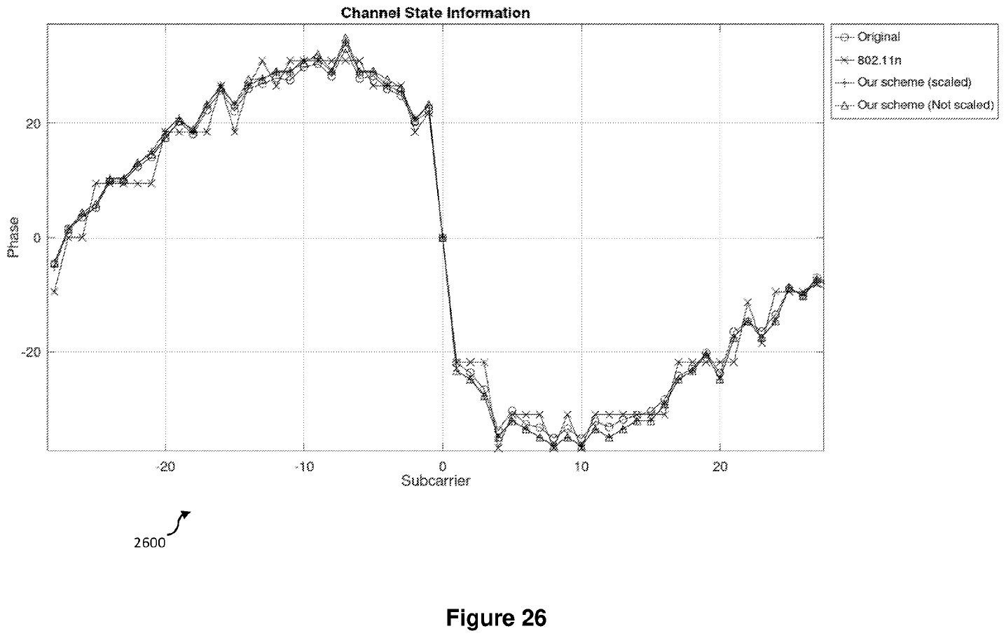

FIG. 26 shows a graph 2600 illustrating another simulation result of phase values recovered from CSI of a measurement signal with higher feedback bit size according to the second embodiment of the present disclosure. If the feedback bit size of the phase sub-component recovered using the phase recovery scheme described this embodiment is increased to 4248, matching that of 802.11n scheme, while 802.11n scheme uses N_{b}=4 for the real and imaginary parts of each entry of the CSI matrices, the phase recovery scheme described this embodiment can use N_{b}=8 bits for each entry of the phase matrices. The phase curve recovered without scaling also performs better, that is, fit better with the original curve than the CSI curve recovered using the 802.11n scheme. In general, it is noted that for a given feedback bit size, the phase recovery scheme described this embodiment provides twice the number of bits (2*N_{b}) per entry compared to 802.11n scheme (N_{b}). For example, for the same feedback bit size of 8280, while 802.11n uses N_{b}=8 for the real and imaginary part of each entry of the CSI Matrices, our scheme can use N_{b}=16 bits for each entry of the Phase Matrices, thereby providing twice the resolution.

In the following paragraphs, a third embodiment of the present disclosure which relates to a measurement report type indication that is split into a course report type indication (or referred to as measurement report course-type) and a fine report type indication (or is referred to as measurement report fine-type) is explained.

In this embodiment, a measurement report type indication is split into a measurement report coarse-type indication indicating whether full or a partial CSI is solicited and a measurement report fine-type indication which indicates the specific sub-component of the partial CSI to be reported or full CSI is to be compressed, the coarse report type indication and the fine report type indication being indicated separately during Setup phase (e.g., measurement setup phase or session setup phase) and measurement instances, respectively.

Partial CSI refers to a breakdown of each entry of the CSI matrix into amplitude and phase sub-components (or could also refer to the I and Q sub-components). It does not refer to selective feedback based on other parameters, for example partial bandwidth feedback where CSI feedback is only reported for a sub-section of the frequency range of the measured channel. Each CSI matrix can be measured, determined on each subcarrier (also known as tone in 802.11); the CSI matrix on a tone consists of many elements (Nᵣ×N_{c} elements, each element consists of I and Q sub-components (or amplitude and phase sub-components)).

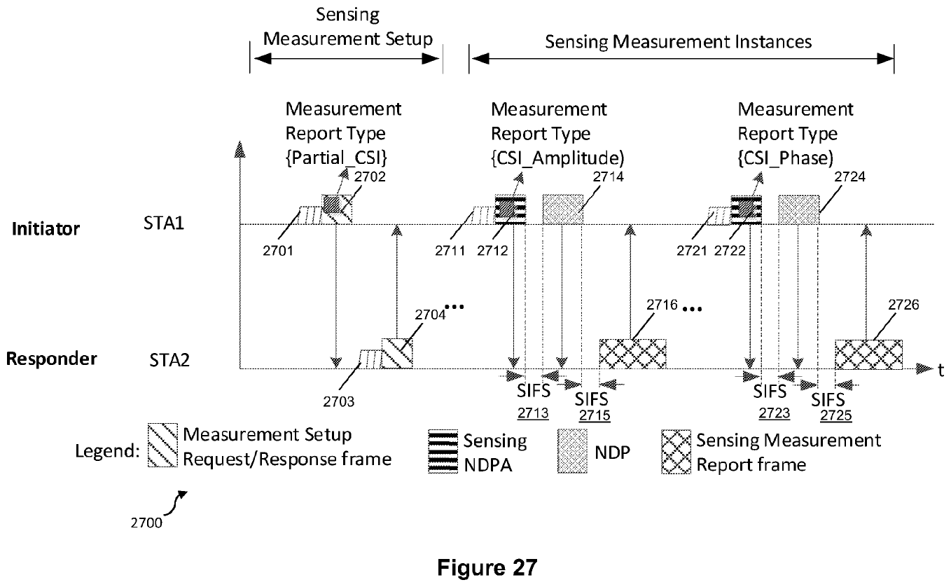

FIG. 27 shows a flow diagram 2700 illustrating exemplary communication for performing sensing measurements to obtain CSI sub-component information according to the third embodiment of the present disclosure. Contention based channel access procedures, e.g. EDCA procedures, illustrated by blocks 2701, 2703, 2711, 2712 are carried out prior to transmission of Measurement Setup Request/Response frames and Sensing NDPA frames. During Measurement Setup phase, a Sensing Initiator (STA1) exchanges Measurement Setup Request/Response frames 2702, 2704 with a Sensing Responder (STA2). According to this embodiment, a measurement report course-type indication is included in the Measurement Setup Request frame 2702 transmitted by STA1 indicating whether full or a partial CSI is solicited. Subsequently, at each sensing measurement instance, STA1 transmits a Sensing NDPA frame 2712, 2722, followed by a Sensing Measurement PPDU (in this case, an NDP 2714, 2724) after a SIFS 2713, 2723. According to the third embodiment, the Sensing NDPA frame 2712, 2722 carries the fine-type measurement report type indication indicating a CSI sub-component (amplitude, phase or CSI (I and Q) to be reported by the Sensing Responder or, if full CSI is solicited, whether the full CSI is to be compressed. In this case, the Measurement Setup Request frame 2702 indicates partial CSI is solicited and the Sensing NDPA frames 2712, 2722 at the first measurement instance and the second measurement instance indicate different fine-type measurement report types, i.e., amplitude and phase subcomponents to be reported, respectively.

STA2 which receives the Sensing NDPA frame 2712, 2722 and the NDP 2714, 2724 then performs sensing measurements on the NDP 2714, 2424 to obtain the CSI. In particular, STA2 computes the indicated sub-component from the measured CSI (i.e., amplitude from the NDP 2714 received at the first measurement instance and phase from the NDP 2724 received at the second measurement instance) and reports the CSI information of the indicated sub-component to the Sensing Initiator in the Sensing Measurement Report frames 2716, 2726. After a SIFS 2715, 2725 following the reception of the NDP 2714, 2724 by STA2, STA2 transmits a Sensing Measurement Report frame 2716, 2726 to STA1.

Alternatively, the Measurement Report coarse-Type may be negotiated during the Session Setup, while the Measurement Report fine-Type may be indicated during the Measurement Setup and/or Measurement Instances.

TABLE 11
two-levels of measurement report type (course-type and
fine type) indicated during setup phase and measurement
instances respectively according to this embodiment

| Coarse-Type | | Fine-type | |
|---|---|---|---|
| Encoding | Meaning | Encoding | Meaning |
| 0 | CSI | 0 | Uncompressed CSI |
| | | 1 | Compressed CSI |
| 1 | Partial CSI | 0 | Amplitude |
| | | 1 | Phase |
| | | 2 | Real part of CSI (I) |
| | | 3 | Imaginary part of CSI (Q) |

The following paragraph explain the Sensing Receiver operation for amplitude/phase matrices reporting according to the third embodiment of the present disclosure.

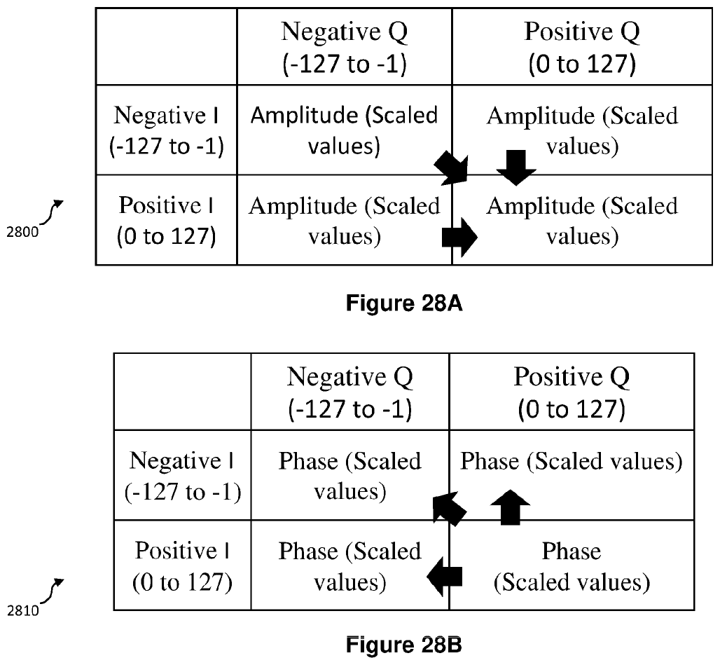

It is noted that square root and tan⁻¹ computations may be relatively expensive, hence it is proposed to use a lookup table for converting I and Q values to pre-calculated quantized amplitude and phase values. FIGS. 28A and 28B show example simplified Q-I lookup tables 2800, 2810 for amplitude and phase sub-components according to the third embodiment of the present disclosure, respectively. From equation (5.1), it can be observed that the four quadrants of the derived amplitude values will be the same and therefore by knowing the amplitude value of one quadrant (e.g., 4^{th} quadrant), the amplitude values of other three quadrants can be derived. As such, the lookup table for amplitude values can be reduced to one fourth of the size, containing only amplitude values of only one quadrant (e.g., 4^{th} quadrant). Similarly, by knowing the phase value of one quadrant (e.g., 4^{th} quadrant) and the signs of I and Q, the phase values of other three quadrants can be derived. As such, the lookup table for phase values can also be reduced to one fourth of the size. Advantageously, the complexity of amplitude and phase values can be reduced.

The following paragraphs explain the Sensing Receiver operation for amplitude reporting according to the third embodiment of the present disclosure.

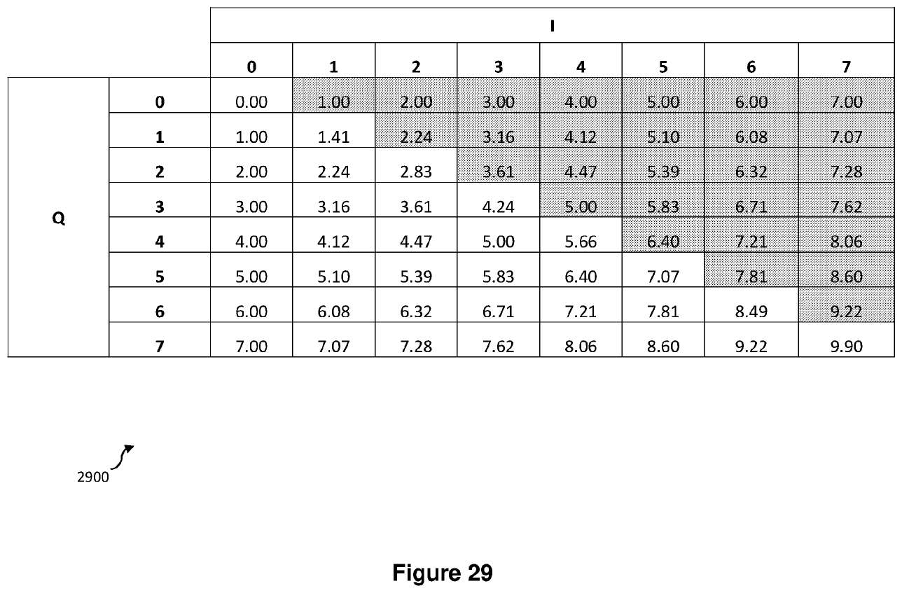

FIG. 29 shows an example amplitude lookup table 2900 according to the third embodiment of the present disclosure. It is noted that the original I and Q values at the Sensing Receiver uses Nₚ bits word size (implementation specific size) and uses two's complement format. Each entry is encoded using an implementation specific size (Nₚ bits), which may be larger than N_{b}_max. For example, Nₚ=10 bits is used in this example.

For the largest allowed value of N_{b} in the 802.11bf specification, N_{b}_max (e.g., 8), the receiver maintains a lookup table of pre-computed amplitude values, corresponding to the positive values of I (real part of CSI) and Q (imaginary part of CSI), each in the range (0 to (2^{(Nb_max-1)}−1)) and computed as follows:
The supported values of I and Q are normalized (against the largest supported I and Q values, e.g., (2^{(Np-1)}−1)) and quantized using (N_{b}_max−1) bits, in the range of 0 to (2^{(Nb_max-1)}−1)); and
For each supported combination of the quantized I and Q values, the corresponding amplitude value is computed using equation (5.1).

Alternatively, the largest N_{b} value supported by the device is used as N_{b}_max, if it is smaller than the largest allowed value of N_{b} in the 802.11bf specification.

Such lookup table 2900 may be pre-computed and stored in the device during manufacturing itself and stored in a non-volatile memory, or it may be pre-computed once for example at the start of a Sensing Session and stored in temporary memory for reference during the rest of the Sensing sessions. It is noted that the amplitude lookup table 2900 is symmetrical around the diagonal, so the total number of unique entries required for number of subcarrier n=2^{(Nb_max-1)} is n(n+1)/2 For example, where N_{b}_max is 4, 36 entries are required. To save memory space, only entries in one half of the table (e.g., corresponding to I>=Q) and the diagonal entries may be maintained, e.g., the entries in the table shaded in grey may be omitted.

Assuming only entries in one half of the table are maintained, the following operations are carried out by Sensing Receiver for amplitude reporting:
For each entry of the CSI matrix corresponding to a reported subcarrier k, I and Q values are calculated using equations (16.1) and (16.2) respectively;
The I and Q values are normalized (against the largest supported I and Q values, e.g., (2^{(Np-1)}−1), and quantized using (N_{b}_max−1) bits in the range of 0 to 2^{(Nb_max-1)-}1;
The corresponding amplitude value is then retrieved from the Lookup Table as: A(m, l)(k)=Amplitude Lookup Table (I, Q); and
Amplitude value is encoded using options 1 or option 2 described below.

$$I = min \{ \vert Re ( {H}_{eff ( m , l )} ( k ) ) \vert , \vert Im ( {H}_{eff ( m , l )} ( k ) ) \vert \} \qquad Equation ( 16.1 )$$

$$Q = max \{ \vert Re ( {H}_{eff ( m , l )} ( k ) ) \vert , \vert Im ( {H}_{eff ( m , l )} ( k ) ) \vert \} ; \qquad Equation ( 16.2 )$$

The following paragraphs explain the Sensing Initiator operation for amplitude value encoding according to the third embodiment of the present disclosure.

Regarding amplitude value encoding under option 1, the amplitude values are scaled and quantized to N_{b} bits using equations (6.1) to (6.4) and the amplitude value encoding scheme described in the first embodiment, namely:
Maximum amplitude values of the amplitude matrix in each subcarrier k are calculated using equation (6.1), where the largest real/imaginary absolute value over H matrix for that subcarrier is calculated and used in the equation;
A scaling ratio is calculated for each reported subcarrier k based on a based-ten logarithm of a ratio of the largest m_{H}(k) over all subcarriers to the m_{H}(k) of this specific subcarrier k in decibel (dB) using equation (6.2) and quantized to 3 bits (0 to 7), and a linear scaler is given by equation (6.3) with the largest m_{H}(k) over all subcarriers in the numerator; and
Each element in the amplitude matrix is quantized to N_{b} bits as unsigned integers (i.e., positive integers) according to equation (6.4).

The amplitude values are then reported to the Sensing Initiator using a Measurement Report frame according to Table 3.

For decoding the amplitude value encoded under option 1 by the Sensing Initiator, the received amplitude values are decoded using equations (7.1) and (7.2) and the amplitude value decoding scheme described in the first embodiment, namely:
The decimal and fractional parts of the Maximum Amplitude indicated in the Measurement Report field are decoded as positive integers and the Maximum Amplitude ( [symbol] ) is recovered by combining the decimal and fractional parts;
Each element of the Amplitude Matrix, A_{(m,l)}^{q}(k), is decoded as a positive integer, where 1≤m≤Nᵣ and 1≤l≤N_{c}; and
Each element of the Amplitude Matrix, A_{(m,l)}^{q}(k), is then scaled using the value in the carrier matrix amplitude field (3 bits), M_{H}(k), interpreted as a positive integer, in dB, by calculating a linear value according to equation (7.1) and a decoded value of the Amplitude matrix element according to equation (7.2).

It is noted that the Sensing Initiator needs not be aware that the amplitude values are encoded using a lookup table.

Amplitude value encoding option 2 utilizes bit shifting, namely:
The largest amplitude value for each reported subcarrier k, m_{H}(k), is determined using equation (6.1) and Maximum Amplitude Max_A which is calculated from max{m_{H}(z)}_{z=-N}_{_{SR}}^{z=N}^{_{SR}};
Scaling factor sf(k) is selected in the range 0 to 7 according to equations (17.1) and (17.2), allowing a multiplication of up to 128 (or 2⁷);
Each element in matrix is quantized to N_{b} bits as unsigned integers (i.e., positive integers) according to equation (17.3); and
The amplitude values, Max_A and the scaling factors (sf) are reported to the Sensing Initiator using a Measurement Report frame according to Table 3. The scaling factors (sf(k)) are reported as the Carrier Matrix Amplitude of 3 bits (m_{H}(k)) as shown in FIG. 11.

$$if mH ( k ) > ( {2}^{Nb} - 1 ) , sf ( k ) = 0 ; \qquad Equation ( 17.1 )$$

$$else sf ( k ) is determined such that ( {2}^{Nb - 1} - 1 ) \leq {2}^{sf ( k )} \times {m}_{H} ( k ) \leq ( {2}^{Nb} - 1 )$$

$${M}_{H}^{lin} ( k ) = \frac{max {\{ {m}_{H} ( z ) \}}_{z = - {N}_{SR}}^{z = {N}_{SR}}}{{2}^{sf ( k )}} \qquad Equation ( 17.2 )$$

$${A}_{( m , l )}^{q} ( k ) = ⌊ \frac{{A}_{( m , l )} ( k )}{{M}_{H}^{lin} ( k )} ( {2}^{Nb} - 1 ) + 0.5 ⌋ \qquad Equation ( 17.3 )$$

It is noted that (2^{Nb-1}−1)≤2^{sf(k)}*m_{H}(k)≤(2^{Nb}−1) can be calculated as min(7, floor(log₂(2^{Nb-1})−log₂ (m_{H}(k))). In one implementation, equation (17.2) can be achieved by shifting bits (e.g., shifting left when multiplying by 2) if sf(k) is greater than zero, assuming the most significant bit is the left most bit, and rounding.

For decoding the amplitude value encoded under option 2 by the Sensing Initiator, the received amplitude values are decoded using equations (18) and (7.2) and the amplitude value decoding scheme described in the first embodiment, namely:
The decimal and fractional parts of the Maximum Amplitude indicated in the Measurement Report field are decoded as positive integers and the Maximum Amplitude ( [symbol] ) is recovered by combining the decimal and fractional parts;
Each element of the Amplitude Matrix, A_{(m,l)}^{q}(k), is decoded as a positive integer, where 1≤m≤Nᵣ and 1≤l≤N_{c}; and
Each element of the Amplitude Matrix, A_{(m,l)}^{q}(k), is then scaled using the value in the carrier matrix amplitude field (3 bits), M_{H}(k), interpreted as a positive integer, in dB, by calculating a linear value according to equation (18) and a decoded value of the Amplitude matrix element according to equation (17.2);

$$r ( k ) = {2}^{sf ( k )} \qquad Equation ( 18 )$$

In an implementation, amplitude values secoding using equation (17.2) and (18) can be achieved by shifting bits (shifting right (division by 2) if sf(k) is greater than zero, assuming the MSB is the left-most bit).

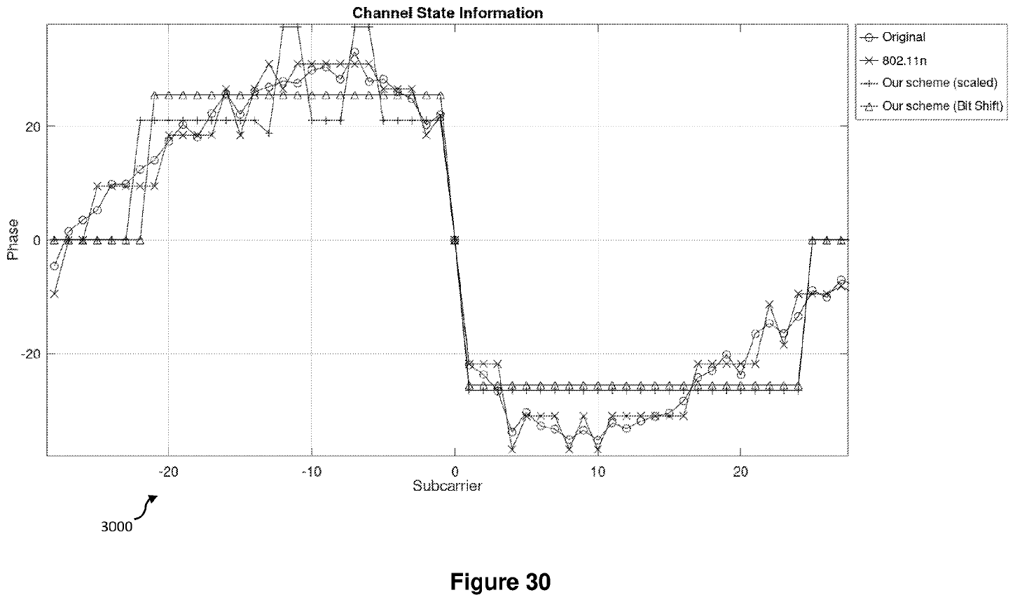

FIG. 30 shows a graph 3000 illustrating a simulation result of phase values recovered from CSI of a measurement signal using bit shifting according to third embodiment of the present disclosure. The original CSI curve and the CSI curve recovered using conventional 802.11n rules (based with max(M_{H}(k)) scaling) with feedback bit size of 4248 are also shown. The number of bits (N_{b}) for each quantized value (I and Q for 802.11n, and phase values for our scheme) is 4. The phase curve (i.e., phase values over all 56 subcarriers) recovered from CSI according to the phase recovery scheme described in this embodiment has a feedback bit size of 2064.

The following paragraph explains the Sensing Receiver operation for phase reporting according to the third embodiment of the present disclosure.

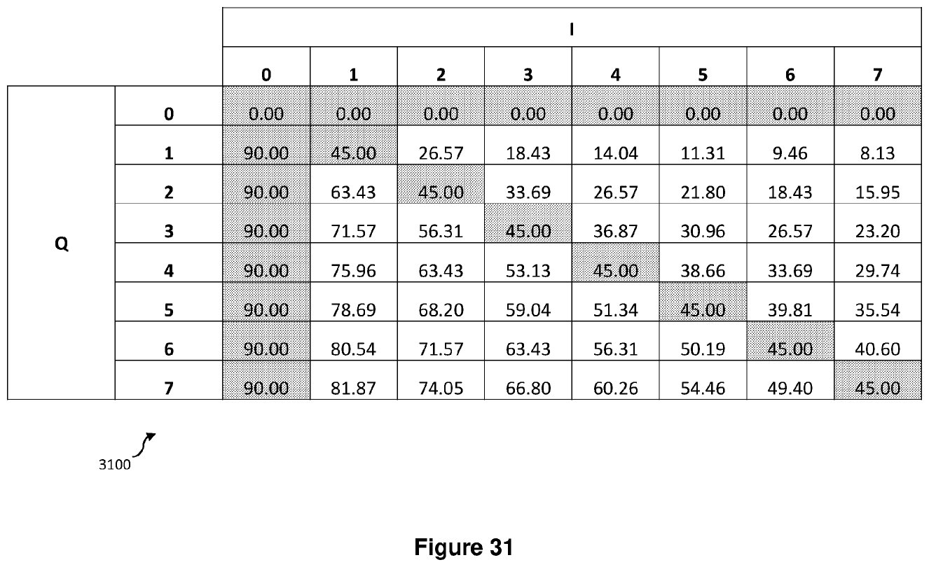

FIG. 31 shows an example phase lookup table 3100 according to the third embodiment of the present disclosure. Similar to the amplitude lookup table, a Sensing Receiver may maintain a lookup table of pre-computed phase values corresponding to positive quantized I and Q values, and for each supported combination of the quantized I and Q values, the corresponding phase value (in degrees) is calculated using equation (9).

Such lookup table 3100 may be pre-computed and stored in the device during manufacturing itself and stored in a non-volatile memory, or it may be pre-computed once for example at the start of a Sensing Session and stored in temporary memory for reference during the rest of the Sensing sessions. It is noted that all entries of the 1^{st} row, where Q=0 is 0°; all entries of the 1^{st} column (I=0), except the 1^{st} row (Q=0), is 90°; and all diagonal entries (I=Q), except the 1^{st} entry (I=0 or Q=0), is always 45°. Therefore, if a single entry is kept for each of the above 3 cases, the total number of unique entries for n=2^{(Nb_max-1)} is (n−1)×(n−1)−(n−1)+3 or (n−1)×(n−2)+3. For example, for N_{b_max} is 4, 45 entries are required.

In actual implementations, both lookup tables (for amplitude and phase) may be maintained as a single table with each combination of I and Q containing both the amplitude and phase values, however in such case, entries for the entire I and Q value ranges need to be maintained.

The following operations are carried out by a Sensing Receiver for phase reporting:
For each entry of the CSI matrix corresponding to a reported subcarrier k, I and Q values are calculated using equations (19.1) and (19.2) respectively;
The I and Q values are normalized (against the largest supported I and Q values, e.g., (2^{(Np-1)}−1), and quantized using (N_{b}_max−1) bits in the range of 0 to 2^{(Nb_max-1)}−1;
The phase values are recovered as follows:
   If (Q=0), P_{(m,l)}(k)=0°; else
   If (I=0), P_{(m,l)}(k)=90°; else
   If (I=Q), P_{(m,l)}(k)=45°; else
   The corresponding phase value is retrieved from the Lookup Table as: P(m, l)(k)=Phase Lookup Table(I, Q); and
As the Phase Lookup Table returns a phase value within a range of 0° to 90°, adjustments to the phase value to their correct quadrant are required based on the following conditions such that the phase value is in the range of −180° to 180°:
   If Re (H_{eff(m,l)}(k)) is negative and Im (H_{eff(m,l)}(k)) is positive, P_{(m,l)}(k)=P_{(m,l)}(k)+90°; else
   If Re (H_{eff(m,l)}(k)) is negative and Im (H_{eff(m,l)}(k)) is positive, P_{(m,l)}(k)=P_{(m,l)}(k)−180°; else
   If Re (H_{eff(m,l)}(k)) is positive and Im (H_{eff(m,l)}(k)) is negative, P_{(m,l)}(k) P_{(m,l)}(k)−90°.

$$I = \vert Re ( {H}_{eff} ( m , l ) ( k ) ) \vert \qquad Equation ( 19.1 )$$

$$Q = \vert Im ( {H}_{eff} ( m , l ) ( k ) ) \vert \qquad Equation ( 19.2 )$$

The following paragraphs explain the Sensing Receiver operation for phase value encoding according to the third embodiment of the present disclosure.

There are two options to encode phase values. Regarding phase value encoding under option 1, the phase values are scaled and quantized to N_{b} bits using equations (10.1) to (10.4), and the phase value encoding scheme described in the first embodiment, namely:
Maximum phase values of the amplitude matrix in each subcarrier k are calculated using equation (10.1), where the largest real/imaginary absolute value over H matrix for that subcarrier is calculated and used in the equation;
A scaling ratio is calculated for each reported subcarrier k based on a based-ten logarithm of a ratio of the largest m_{H}(k) over all subcarriers to the m_{H}(k) of this specific subcarrier k in decibel (dB) using equation (10.2) and quantized to 3 bits (0 to 7), and a linear scaler is given by equation (10.3) with the largest m_{H}(k) over all subcarriers in the numerator; and
Each element in the phase matrix is quantized to N_{b} bits in 2s complement encoding according to equation (10.4).

The phase values are then reported to the Sensing Initiator using a Measurement Report frame according to Table 6.

For decoding the phase values encoded under option 1 by the Sensing Initiator, the received phase values are decoded using equations (11.1) and (11.2) and the phase decoding scheme described in the first embodiment, namely:
the decimal and fractional parts of the Maximum Phase indicated in the Measurement Report field are decoded as positive integers and the Maximum Amplitude ( [symbol] ) is recovered by combining the decimal and fractional parts. If the Maximum Phase field is omitted in the Measurement Report field, [symbol] =180°;
each element of the Phase Matrix, P_{(m,l)}^{q})(k), is decoded as a 2s complement number, where 1≤m≤Nᵣ and 1≤l≤N_{c};
each element of the Phase Matrix, P_{(m,l)}^{q}(k), is then scaled using the value in the carrier matrix amplitude field (3 bits), M_{H}(k), interpreted as a positive integer, in dB, by calculating a linear value according to equation (11.1) and a decoded value of the Phase matrix element according to equation (11.2).

It is noted that the Sensing Initiator needs not be aware that the phase values are encoded using a lookup table.

Phase value encoding option 2 utilizes bit shifting, namely:
The largest amplitude value for each reported subcarrier k, m_{H}(k), is determined using equation (10.1) and Maximum Phase Max_P which is calculated from max{m_{H}(z)}_{z=-N}_{_{SR}}^{z=N}^{_{SR}};
Scaling factor sf(k) is selected in the range 0 to 7 according to equations (20.1) and the linear scaling value is found using equation (20.2). The scaling factor allows a multiplication of up to 128 (or 2⁷);
Each element in matrix is quantized to N_{b} bits in 2s complement encoding according to equation (20.3); and
The phase values, the scaling factors (sf) and Nₚ are reported to the Sensing Initiator using a Measurement Report frame according to Table 12 except one additional field is required to carry Nₚ. In this case, 8 bits should be enough to carry Nₚ. The scaling factors (sf(k)) are reported as the Carrier Matrix Amplitude of 3 bits (m_{H}(k)) as shown in FIG. 14.

$$( {2}^{Np - 2} - 1 ) \leq {2}^{sf ( k )} \times {m}_{H} ( k ) \leq ( {2}^{Np - 1} - 1 ) \qquad Equation ( 20.1 )$$

where Nₚ is an implementation specific value and represents the number of bits used to encode the original I and Q values as well as the computed amplitude and phase values.

$${M}_{H}^{lin} ( k ) = \frac{{2}^{Np}}{{2}^{sf ( k )}} \qquad Equation ( 20.2 )$$

$${P}_{( m , l )}^{q} ( k ) = ⌊ \frac{{P}_{( m , l )} ( k )}{{M}_{H}^{lin} ( k )} ( {2}^{Nb} ) + 0.5 ⌋ \qquad Equation ( 20.3 )$$

In one implementation, equation (20.2) can be achieved by shifting bits (e.g., shifting left when multiplying by 2) sf(k) is greater than zero, assuming the most significant bit is the left most bit, and rounding. In another implementation, the phase value encoding and decoding scheme described in Option 2 can also be used for full CSI feedback (i.e., to encode I and Q), or it may also be used for encoding/decoding of amplitude values by substituting the phase value with I/Q or amplitude value. In case of amplitude, since amplitude is always positive, equation (20.1) may be modified as {(2^{Np-1}−1)≤2sf(k)×m_{H}(k)≤(2^{Np}−1)}, and the Maximum Phase field is replaced by Maximum Amplitude/I/Q, while the remaining process remains the same. When used to encode/decode amplitude or I and Q values, the Received Signal Strength Indicator (RSSI) values of each receive chain may be signalled instead of the SNR values per receive chain and used instead of the Maximum Amplitude/I/Q value to scale back the recovered values.

It is noted that if the value of Nₚ used by the responder to encode the phase value is larger than the value used by the initiator to store the recovered phase values, loss of one or more MSBs of the recovered values could occur. For example, if the responder used 16 bits to encode the phase values, but the initiator uses 12 bits, up to 4 MSBs could be lost due to the bit shift operations during the phase value decoding.

As such, it is recommended that the value of Nₚ be fixed in the 802.11bf standard, or it should be negotiated between the initiator and the responder, e.g., during sensing setup negotiation (e.g., using Sensing Setup Request/Response frame as shown in slide-71). If so the field for Nₚ can be omitted in the measurement report. This will ensure that both peers use the same number of bits and no loss of bits will occur.

TABLE 12
an example Measurement Report field (Phase), where scidx(n)
is defined to indicate the exact subcarrier index corresponding
to the reported subcarrier n; and Nₛ is the number
of subcarriers for which the phase matrix is reported
and is a function of the grouping parameter N_{g} (every
N_{g} adjacent subcarrier is grouped and a single value
for each group of N_{g} adjacent subcarriers)

| Field | Size (bits) | Meaning |
|---|---|---|
| RSSI in receive | 8 | Average RSSI in the first |
| chain 1 | | receive chain of the STA |
| | | sending the report. |
| . . . | | |
| RSSI in receive | 8 | Average RSSI in the Nᵣ -th |
| chain Nᵣ | | receive chain of the STA |
| | | (chain Nᵣ) sending the port |
| Maximum Phase | 8 + 16 = 24 | Maximum value over the |
| | | absolute values of all |
| | | reported phase values |
| | | (Max_P) quantized as two |
| | | unsigned integers (first 8-bits |
| | | to carry the decimal part and |
| | | second 16-bits to carry the |
| | | fractional part rounded to 4 |
| | | digits). |
| Nₚ | 8 | The number of bits used to |
| | | encode the original phase |
| | | values i.e., the value of Nₚ |
| Phase matrix for | 3 + N_{b} × N_{c} × Nᵣ | Phase matrix according to |
| subcarrier | | FIG. 24 |
| k = scidx(0) | | |
| . . . | | |
| Phase matrix for | 3 + N_{b} × N_{c} × Nᵣ | Phase Matrix |
| subcarrier | | |
| k = scidx(Nₛ − 1) | | |

The following paragraphs explain the Sensing Receiver operation for phase value encoding without relative scaling between subcarriers according to the third embodiment of the present disclosure.

Each phase matrix is encoded using (N_{b}×N_{c}×Nᵣ) bits, as shown in Table 6, as compared to (3+2×N_{b}×N_{c}×Nᵣ) for 802.11n encoding rules. N_{c} and Nᵣ are the number of rows and columns, respectively, in the channel matrix estimate computed by the Sensing receiver.

Maximum Phase (Max_P)=max{m_{H}(z)}_{z=-N}_{_{SR}}^{z=N}^{_{SR}}, in equation (14.2) is quantized as two unsigned integers (first 8-bits to carry the decimal part and second 16-bits to carry the fractional part rounded to 4 digits). For example, an 8-bits unsigned integer allows indication up to a value of (28-1)=255 which is enough to cover the maximum phase of 180°. While a 14-bits unsigned integer value allows indication of up to 4 digits of fractional part, i.e., up to 9999 (16-bits) are allocated to unify the field size with the Maximum Phase field in the Phase matrix. The fractional part is rounded to 3 digits, for example, a maximum phase value of 103.59273 is indicates as 103 and 5927.

The Maximum Phase field may be omitted if 180° is fixed as the maximum absolute value of phases.

For decoding the phase values encoded under option 2 by the Sensing Initiator, the received amplitude values are decoded in a similar process described in the first embodiment except that equations (11.1) and (11.2) are replaced with equations (21.1) and (21.2), namely:
the decimal and fractional parts of the Maximum Phase indicated in the Measurement Report field are decoded as positive integers and the Maximum Amplitude ( [symbol] ) is recovered by combining the decimal and fractional parts. If the Maximum Phase field is omitted in the Measurement Report field, [symbol] =180°;
each element of the Phase Matrix, P_{(m,l)}^{q}(k), is decoded as a 2s complement number, where 1≤m≤Nᵣ and 1≤l≤N_{c}; and
each element of the Phase Matrix, P_{(m,l)}^{q}(k), is then scaled using the value in the carrier matrix amplitude field (3 bits), M_{H}(k), interpreted as a positive integer, in dB, by calculating a linear value according to equation (21.1) and a decoded value of the Phase matrix element according to equation (21.2);

$$r ( k ) = \frac{{2}^{sf ( k )}}{{2}^{Np}} \qquad Equation ( 21.1 )$$

$${\tilde{P}}_{( m , l )}^{q} ( k ) = \frac{{P}_{( m , l )} ( k )}{r ( k )} \times \frac{1}{( {2}^{Nb} )} \qquad Equation ( 21.2 )$$

In order to ensure that the recovered phase values are in the same range as the original phase values, equation (21.3) is also applied.

$${\tilde{P}}_{( m , l )}^{q} ( k ) = {\tilde{P}}_{( m , l )}^{q} ( k ) \times \frac{Max\_ {\tilde{P}}^{q}}{} \qquad Equation ( 21.3 )$$

where [symbol] is Maximum Phase value received in the measurement report, while Max_\tilde{P}^{q} is the absolute value of the maximum phase value among all the phase values recovered using equation (21.2) for all valuers of m, l and k

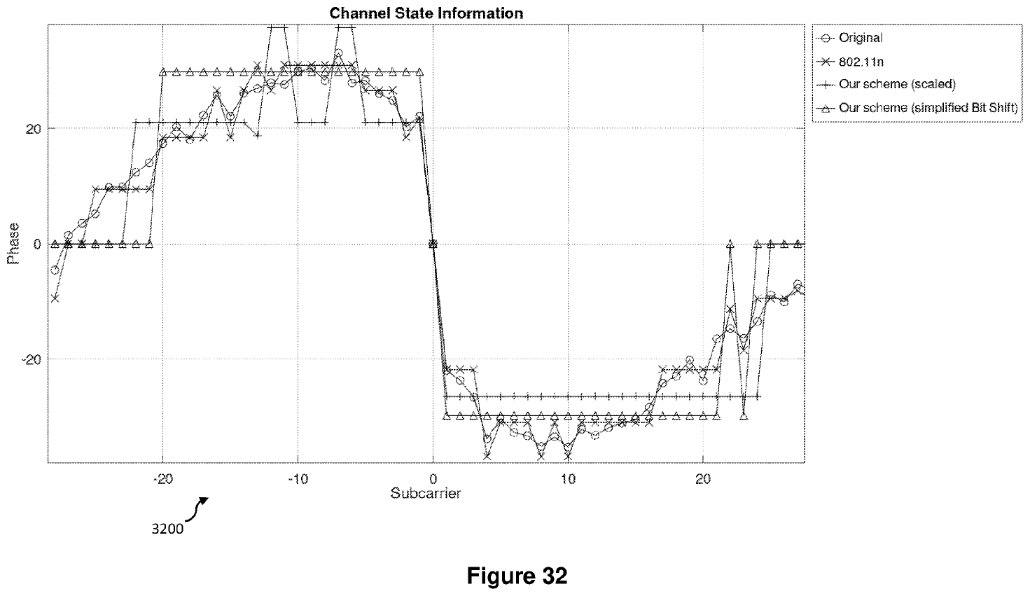

FIG. 32 shows a graph 3200 illustrating a simulation result of phase values recovered from CSI of a measurement signal with simplified bit shifting according to third embodiment of the present disclosure. The original CSI curve and the CSI curve recovered using the 802.11n scheme (based with max(M_{H}(k)) scaling) with feedback bit size of 4248 are also shown. The number of bits (N_{b}) for each quantized value (I and Q for 802.11n, and phase values for our scheme) is 4. The phase curve (i.e., phase values over all 56 subcarriers) recovered from CSI according to the phase recovery scheme described in this embodiment has a feedback bit size of 2064.

In the following paragraphs, a fourth embodiment of the present disclosure which relates to codebook based reporting is explained.

In this embodiment, instead of reporting the amplitude/phase values of an entry in a lookup table, a Sensing Receiver reports I and Q indices of the entry in a combined lookup table. Both the Sensing initiator and the Sensing receiver maintain a lookup table of pre-computed amplitude and phase values, corresponding to the positive quantized values of I and Q (similar to the amplitude lookup table 2900 in FIG. 29). For each combination of the quantized I and Q values, the corresponding amplitude and phase value (in degrees) are calculated using equations (5.1) and (9), respectively.

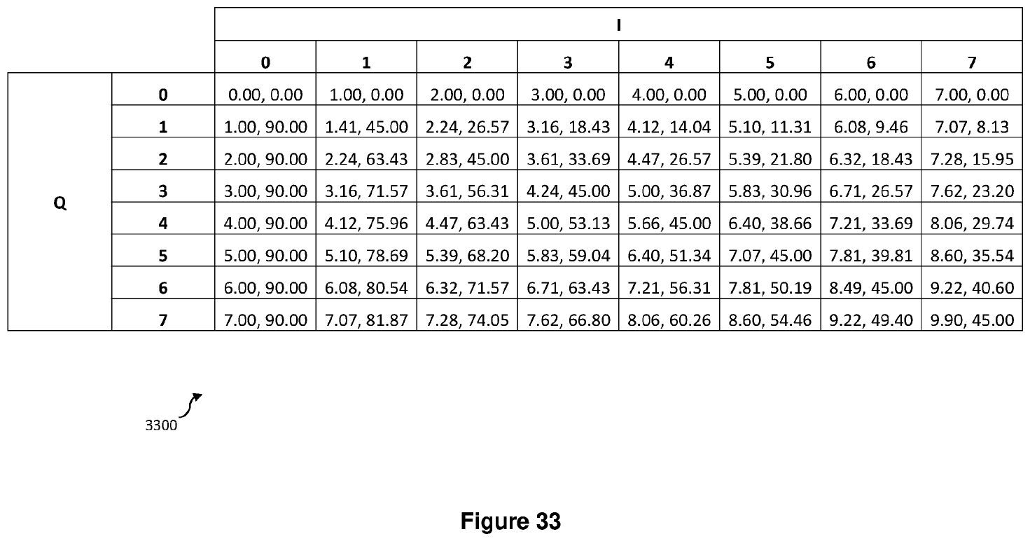

FIG. 33 shows an example combined lookup table 3300 according to the fourth embodiment of the present disclosure. Each entry of the lookup table contains both the amplitude and phase values corresponding to the positive values I and Q values as {amplitude, phase}. The size of the lookup table is (2^{(Nb_max-1)})×(2^{(Nb_max-1)}) octets, where N_{b}_max is the largest allowed value of N_{b} in the 802.11bf specification (assuming N_{b}_max is 4 in this example). The amplitude and phase values of each entry is encoded using an implementation specific size (Nₚ bits), which may be larger than N_{b}_max. In this example, the Nₚ is 10 bits.

The following paragraphs explain the Sensing Receiver operation for codebook reporting according to the fourth embodiment of the present disclosure.

The following operations are carried out by Sensing Receiver for codebook reporting:
For each entry of the CSI matrix corresponding to a reported subcarrier k, I and Q values are calculated using equations (19.1) and (19.2) respectively;
The I and Q values are normalized (against the largest supported I and Q values, e.g., (2^{(Np-1)}−1), and quantized using (N_{b}−1) bits in the range of 0 to 2^{(Nb-1)}-1. If the N_{b} used for the codebook feedback reporting is less than N_{b}_max, the portion of the lookup table referenced will be a sub-section of the table, with I and Q in the range 0 to 2^{(Nb-1)}−1;
A two bits variable that represents the I/Q quadrant, q(k), is computed as follows:
   If Re (H_{eff(m,l)}(k)) is positive and Im (H_{eff(m,l)}(k)) is positive, q(k)=‘b00’; else
   If Re(H_{eff(m,l)}(k)) is negative and Im(H_{eff(m,l)}(k)) is positive, q(k)=‘b01’; else
   If Re (H_{eff(m,l)}(k)) is negative and Im (H_{eff(m,l)}(k)) is negative, q(k)=‘b10’; else
   If Re (H_{eff(m,l)}(k)) is positive and Im (H_{eff(m,l)}(k)) is negative, q(k) ‘b11’; and
The Codebook indices (I, Q), q(k), are reported to the initiator using the Measurement Report frame according to Table 13. In particular, each codebook matrix is encoded using (2×N_{b}×N_{c}×Nᵣ) bits.

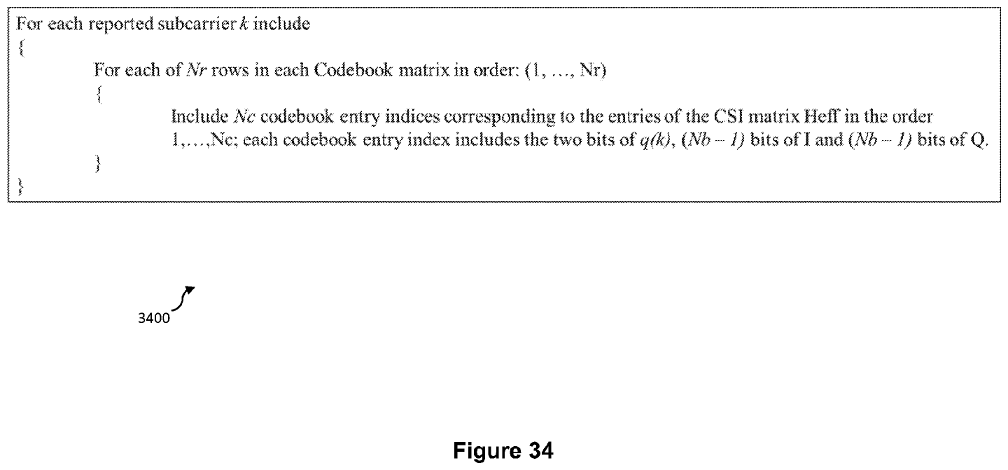

TABLE 13
an example Measurement Report field (Codebook), where scidx(n)
is defined to indicate the exact subcarrier index corresponding to
the reported subcarrier n; and Nₛ is the number
of subcarriers for which the phase matrix is reported and is
a function of the grouping parameter N_{g} (every
N_{g} adjacent subcarrier is grouped and a single
value for each group of N_{g} adjacent subcarriers)

| Field | Size (bits) | Meaning |
|---|---|---|
| SNR in receive chain 1 | 8 | SNR ratio in the first receive |
| | | chain of the STA sending the |
| | | report. |
| . . . | | |
| SNR in receive | 8 | SNR ratio in the Nᵣ -th |
| chain Nᵣ | | receive chain of the STA |
| | | (chain Nᵣ) sending the port |
| Codebook matrix for | 2 × N_{b} × N_{c} × Nᵣ | Codebook matrix according |
| subcarrier k = scidx(0) | | to FIG. 34 |
| . . . | | |
| Codebook matrix for | 2 × N_{b} × N_{c} × Nᵣ | Codebook Matrix |
| subcarrier k = | | |
| scidx(Nₛ − 1) | | |

The 3 bits per reported subcarrier for M_{H}(k) is not required since scaling is not performed. If a separate codebook is maintained only for Amplitude, q (k) indicating the I/Q quadrant is not required and bit-size of each codebook matrix can be further reduced to (2×(N_{b}−1)×N_{c}×Nᵣ) bits. The code structure of Codebook matrix C(k) for subcarrier k is illustrated in FIG. 34.

The following paragraphs explain the Sensing Initiator operation for codebook decoding according to the fourth embodiment of the present disclosure.

The decoding of codebook feedback is as follows:
If the N_{b} used for the codebook feedback is less than N_{b_max}, the received values of codebook entry indices I and Q are scaled to a range of 0 to 2^{(Nb_max-1)}−1 by multiplying I and Q by (2^{Nb_max}−2^{Nb});
The amplitude and phase values are retrieved from the lookup table based on the received codebook entry indices as A_{(m,l)}(k)=Lookup Table(I, Q) and P_{(m,l)}(k)=Lookup Table(I, Q), respectively; and
The phase value is adjusted as follows:
   If q(k)=‘b01’, P_{(m,l)}(k)=P_{(m,l)}(k)+90; else
   If q(k)=‘b10’, P_{(m,l)}(k)=P_{(m,l)}(k)−180; else
   If q(k)=‘b11’, P_{(m,l)}(k)=P_{(m,l)}(k)−90.

According to the fourth embodiment of the present disclosure, if 802.11bf allows the largest N_{b} value supported by a device to be variable, Codebook size negotiation may also take place during a Sensing Session Setup negotiation. In this case the Lookup table is computed once by both the Initiator and the Responder, at the start of a Sensing Session and stored in temporary memory for reference during the rest of the Sensing sessions. Else, if the parameters of the codebook are fixed in the 802.11bf specification, the lookup table may be pre-computed and stored in the device during manufacturing itself and stored in a non-volatile memory.

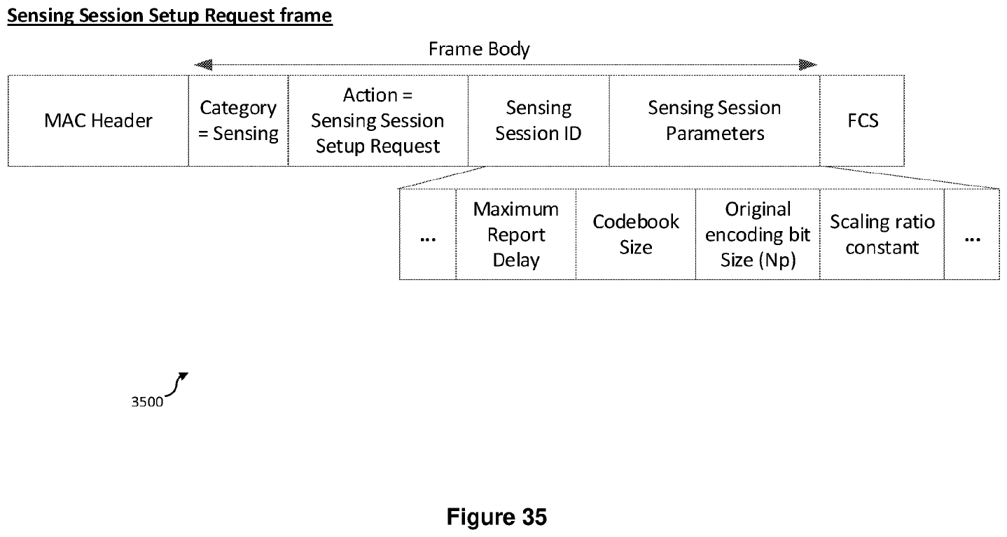

FIG. 35 shows an example Sensing Session Setup Request frame 3500 for codebook size negotiation according to the fourth embodiment of the present disclosure. The Sensing Setup Request frame 3500 comprises a MAC Header, a Category field (set to “Sensing”), an Action field (set to “Sensing Session Setup Request”), a Sensing Session ID field, a Sensing Session Parameters field and a FCS field. The Sensing Session Parameters field comprises a Maximum Report Delay field, a Codebook Size field, an Original Encoding Bit Size (Nₚ) field, a Scaling Ratio Constant field. The Maximum Report Delay field indicates the maximum time allowed between the reception of a Measurement PPDU (e.g., NDP) and transmission of a corresponding Measurement Report frame. The Codebook Size field indicates the number of rows or columns of the codebook, i.e., N_{b_max}. The Original Encoding Bit Size (Nₚ) field indicates the number of bits used to encode the original amplitude/phase or I & Q values i.e., Nₚ, and in case of a codebook, it refers to the number of bits used to encode each entry of the codebook. The Scaling Ratio Constant field indicates a scaling constant e.g., Csr as described in the second embodiment of the present disclosure.

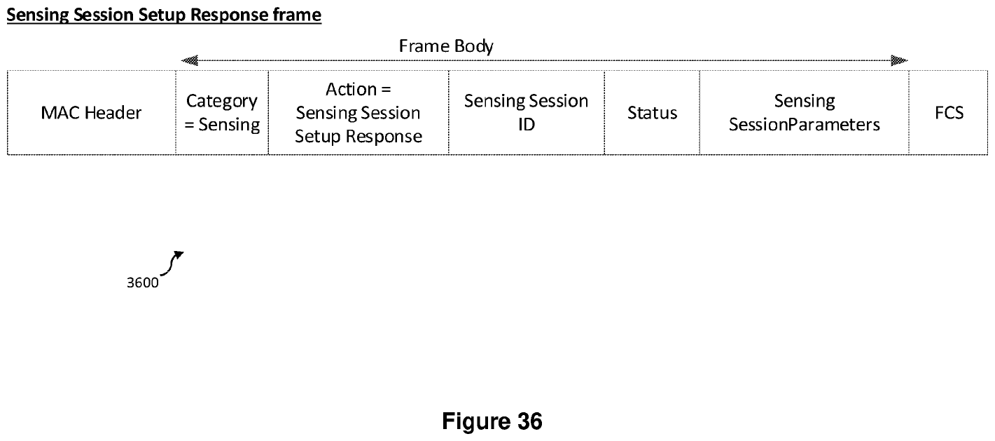

FIG. 36 shows an example Sensing Session Setup Response frame 3600 for codebook size negotiation according to the fourth embodiment of the present disclosure. The Sensing Setup Response frame 3600 comprises a MAC Header, a Category field (set to “Sensing”), an Action field (set to “Sensing Session Setup Response”), a Sensing Session ID field, a Status field, a Sensing Session Parameters field and a FCS field. Advantageously, encoding the decoding operations described in this embodiment are simpler since scaling of values are not required. This also saves 3 bits per reported subcarrier.

In the following paragraphs, a fifth embodiment of the present disclosure which relates to trigger-based sensing measurements is explained.

Instead of feedback-based sensing measurements, when the Sensing Initiator is an AP, it is possible to use a Trigger-based (TB) sensing measurement. According to this embodiment, a TB sensing measurement instance comprises three phases:
A polling phase, in which an AP sends a trigger frame to check the availability of STAs. If a STA is available, it responds with a CTS-to-self frame;
A TF sounding phase (uplink (UL) sensing sounding phase), in which the AP transmits a trigger frame to solicit NDP transmission(s) from STA(s) followed by transmission of an NDP by STA(s) a SIFS after receiving the trigger frame. The NDP is used by AP to measure the uplink channel; and
An NDPA sounding phase (downlink (DL) sensing sounding phase), in which the AP transmits a NDPA frame followed by the transmission of an NDP a SIFS after the transmission of the NDPA frame. The NDP is used by non-AP STA(s) to measure the downlink channel.

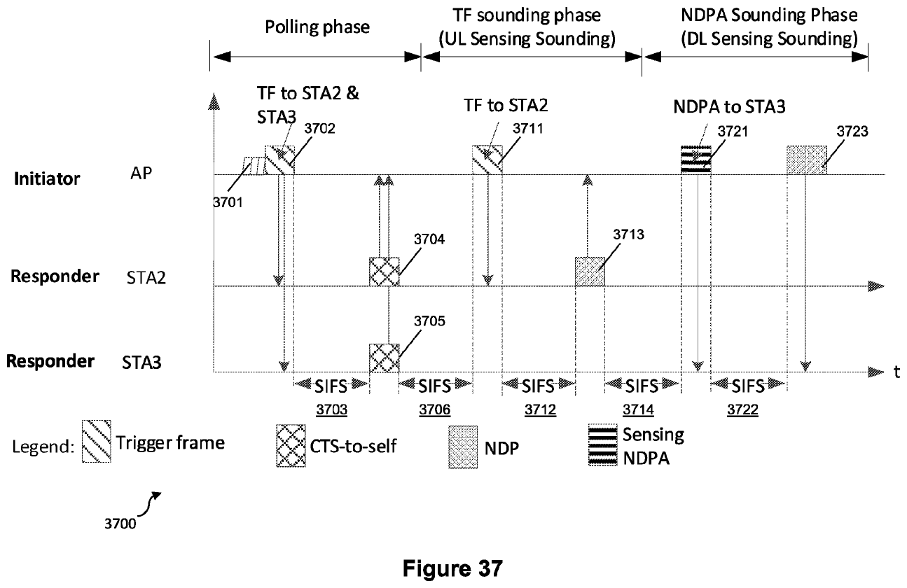

FIG. 37 shows a flow diagram 3700 illustrating exemplary communication for performing trigger-based sensing measurements to obtain CSI sub-component information according to the fifth embodiment of the present disclosure. Contention based channel access procedures, e.g. EDCA procedures, illustrated by blocks 3701 are carried out prior to transmission of trigger frames. During a polling phase, a Sensing Initiator (AP) transmits a trigger frame 3702 to two Sensing Responders (STA2, STA3). Upon receipt of the trigger frame 3702, after a SIFS 3703, both STA2 and STA3 transmits a CTS-to-self frame back to AP to indicate that they are available for trigger-based sensing measurements.

Subsequently, after a SIFS 3706, a TF sounding phase is carried out for measuring an uplink channel. In this example, AP transmits another Trigger frame 3711 to STA2 to solicit an NDP and measures its uplink channel. Upon receipt of the Trigger frame 3711, after a SIFS 3712, STA2 then transmit an NDP 3713. AP then measures its uplink channel between STA2 and AP through measuring CSI of the NDP 3713.

Subsequently, after a SIFS 3714, a NDPA sounding phase is carried out for measuring a downlink channel. In this example, AP transmits an NDPA frame 3721 followed by an NDP 3723 to STA3 after a SIFS 3722. The non-AP STA3 then measures the downlink channel between AP and STA3 through measuring CSI of the NDP 3723. Advantageously, by using trigger-based sensing measurement, the overhead in conveying CSI information to upper layer application is reduced.

In particular, during TB sensing measurements, STA(s) does not need to send Sensing Measurement Report frame to peer STA(s). Instead, it performs the sensing measurements for its own use based on a received NDP(s). In this case, the sensing measurement results are passed up to upper layer applications.

The sensing service access point (Sensing SAP) in the Sensing Initiator (AP) may use the following Message Authentication Code sublayer management entity (MLME) primitive to initiate a TB sensing measurement:

```
MLME-TB-Sensing.request(
  Responder MAC Address,
  Member ID List,
  Sensing Session ID,
  Measurement Setup ID,
  Measurement Instance ID,
  Number of Streams,
  Bandwidth,
  Measurement Report Type,
  NDPA Information,
  )
```

TABLE 14
example MLME-TB-Sensing.request( ) parameters

| Parameter | Type | Valid range | Description |
|---|---|---|---|
| Responder | MACAddress | Any valid MAC | The MAC Address of the sensing |
| MAC | | Address | responder. If response is solicited from |
| Address | | | multiple responders, this is set to |
| | | | broadcast MAC address. |
| Member ID | List of Integers | | Indicates a list of IDs (e.g., AIDs) of |
| List | | | one or more STAs from which |
| | | | response is solicited. |
| Sensing | Integer | 0-255 | ID of a sensing session |
| Session ID | | | |
| Measurement | Integer | 0-255 | ID of a Measurement Setup |
| Setup ID | | | |
| Measurement | Integer | 0-255 | ID of a Measurement Instance |
| Instance ID | | | |
| Number of | Integer | 0-16 | Number of space time streams to be |
| Streams | | | used for the NDP |
| Bandwidth | Integer | 1-16 | Indicates the channel bandwidth to be |
| | | | used for the response PPDU in units of |
| | | | 20 MHz |
| Measurement | Enumeration | CSI, | The measurement report type to be |
| Report Type | | CSI_Amplitude, | passed up to the upper layer upon |
| | | CSI_Phase, | reception of an NDP |
| | | CSI_I, | |
| | | CSI_Q | |
| NDPA | Structure | | Carries the information (RA, AID12 |
| Information | | | etc.) to be included in the NDPA frame |
| | | | during the NDPA Sounding phase |

Upon receipt of this primitive, the MLME initiates a TB sensing measurement and constructs a Trigger frame for transmission to one or more Sensing Responders. More details about each parameter of the MLME-TB-Sensing.request( ) primitive are further elaborated in Table 14.

Upon receiving NDP(s), the following primitive is generated and the sensing measurement results are passed up to upper layer sensing applications using the following MLME primitive to notify the station management entity (SME) of the channel measurement results: More details of each parameter of the MLME-TB-Sensing.confirm ( ) are elaborated in Table 15.

```
MLME-TB-Sensing.confirm(
  MAC Address,
  Member ID,
  Sensing Session ID,
  Measurement Setup ID,
  Measurement Instance ID,
  Bandwidth,
  Measurement Report Type,
  NumberOfSubcarriers_Ns,
  NumberOfColumns_Nc,
  NumberOfReceiveChains_Nr,
  NumberOfBitsPerElement_Nb,
  FeedbackMatrix,
  SNRList
  )
```

TABLE 15
example MLME-TB-Sensing.confirm( ) parameters

| Parameter | Type | Valid range | Description |
|---|---|---|---|
| Responder MAC Address | MACAddress | Any valid MAC | The MAC Address of |
| | | Address | the STA from which |
| | | | the NDP is received. |
| Member ID | List of | | Indicates a list of IDs |
| | Integers | | (e.g., AIDs) of the STA |
| | | | from which the NDP is |
| | | | received. |
| Sensing Session ID | Integer | 0-255 | ID of a sensing session |
| Measurement Setup ID | Integer | 0-255 | ID of a Measurement |
| | | | Setup |
| Measurement Instance ID | Integer | 0-255 | ID of a Measurement |
| | | | Instance |
| Bandwidth | Integer | 1-16 | Indicates the channel |
| | | | bandwidth of the NDP |
| | | | in units of 20 MHz. |
| Measurement Report Type | Enumeration | CSI, | Indicates the format of |
| | | CSI_Amplitude, | the FeedbackMatrix. |
| | | CSI_Phase, | |
| | | CSI_I, | |
| | | CSI_Q | |
| NumberOfSubcarrier_Ns | Integer | 1-1023 | Number of subcarriers |
| | | | for which channel |
| | | | measurements are |
| | | | reported |
| NumberOfColumns_Nc | Integer | 1-16 | Number of columns in |
| | | | the reported |
| | | | FeedbackMatrix |
| NiumberOfReceiveChains_Nr | Integer | 1-16 | Number of rows in the |
| | | | reported |
| | | | FeedbackMatrix |
| NumberOfBitsPerElement_Nb | Integer | 1-16 | Number of bits used |
| | | | for each complex |
| | | | element of the |
| | | | FeedbackMatrix |
| FeedbackMatrix | Matrix | | When the |
| | | | Measurement Report |
| | | | Type indicates |
| | | | CSI_Amplitude or |
| | | | CSI_Phase, the format |
| | | | of the FeedbackMatrix |
| | | | is the same as shown in |
| | | | any of Tables 3, 6, 9 |
| | | | and 12. For CSI, CSI_I |
| | | | and CSI_Q, similar |
| | | | format may be used, |
| | | | except that for CSI_I |
| | | | and CSI_Q, only the |
| | | | indicated sub- |
| | | | component is present |
| | | | instead of both I and Q. |
| SNRList | | List | List of SNR in the |
| | | | Nᵣ receiver chains |
| | | | (8 bits per chain). |

In the following paragraphs, a sixth embodiment of the present disclosure which relates to phase values scaling according to each Transmitter-Receiver (Tx-Rx) pair is explained.

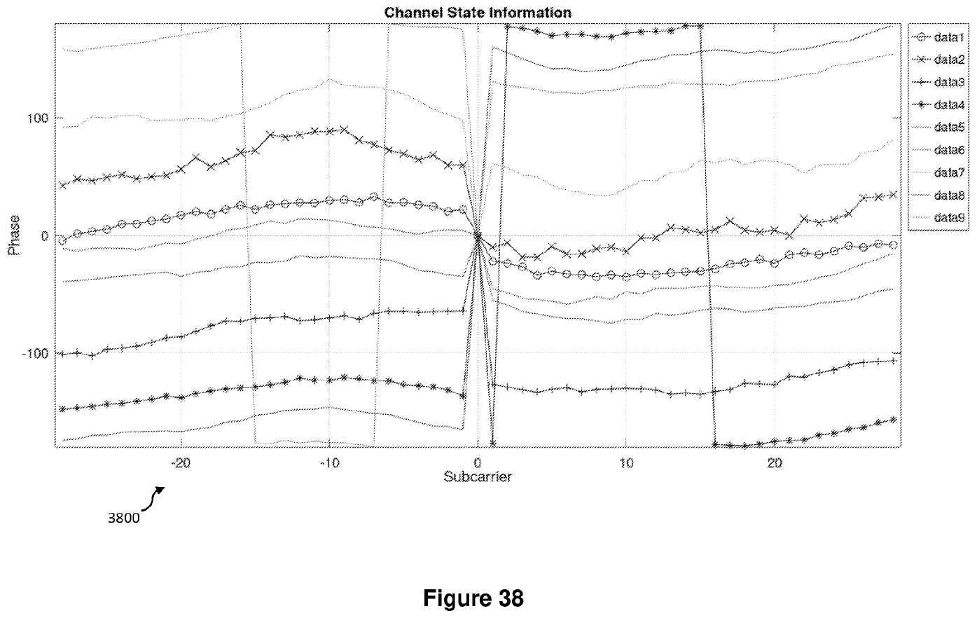

FIG. 38 shows a graph 3800 illustrating a result of phase values recovered from CSI of a measurement signal plotted according to subcarriers for a 3×3 MIMO system comprising 3 Tx antennas and 3 Rx antennas that has a total of 9 Tx-Rx antenna pairs and each curve in the graph 3800 shows the phase value curve of each Tx-Rx antenna pairs. The Tx-Rx antenna pair may also be seen as a row (1 to Nᵣ) and column (1 to N_{c}) pair in the corresponding feedback matrix (e.g., amplitude/phase/CSI matrix). It is observed that, for phase value encoding, when the phase values of each subcarrier is close to the maximum (180°) or minimum (−180°) for one or more combinations of Tx (1 to N_{c})−Rx (1 to Nᵣ) antenna pair, the 802.11n scaling does not work well and in fact may be skipped altogether.

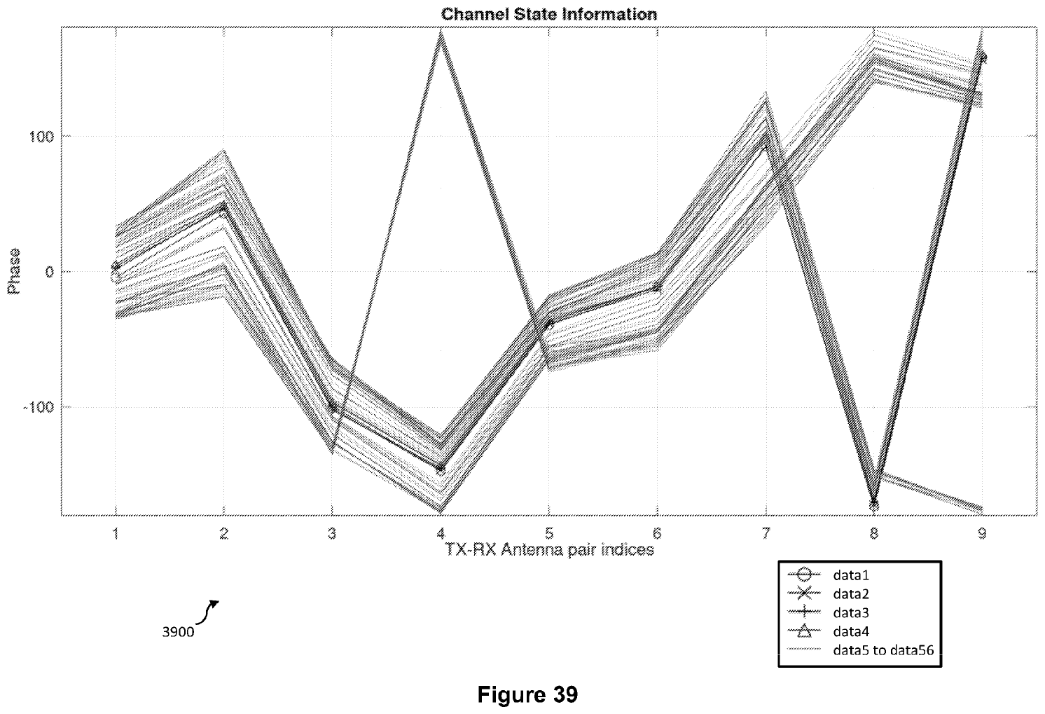

FIG. 39 shows another graph 3900 illustrating the same phase values recovered from CSI of the measurement signal of FIG. 38, but this time plotted according to Tx-Rx antenna pair indices. Each curve in the graph 3900 shows the phase value curve of each subcarrier hence there are a total of 56 curves. It is noted that if the same phase values data is plotted against each antenna pairs rather than against subcarrier, only the phase values of Tx-Rx pairs 4, 8 and 9 reach or are close to the maximum/minimum phase values of 180°/−180°. In such case, scaling the phase values according to Tx-Rx pair (instead of per subcarrier) would be more effective.

The following paragraphs explain the Sensing Receiver operation for phase value encoding without relative scaling between subcarriers according to the sixth embodiment of the present disclosure.

In order to signal the phase values using N_{b} bits, the following simplified phase matrices feedback encoding is used, namely:
Maximum phase values of the phase matrix for each combination of m and l over all reported subcarrier k are calculated using equation (22.1);
a scaling ratio for each combination of m and l is calculated using equation (22.2) and quantized to 3 bits (0 to 7), and a linear scaler is given by equation (22.3); and
Each element in the phase matrix is quantized to N_{b} bits in 2s complement encoding according to equation (22.4).

$${m}_{H} ( m , l ) = max \{ {\vert {P}_{( m , l )} ( z ) \vert}_{z = - {N}_{SR}}^{z = {N}_{SR}} \} \qquad Equation ( 22.1 )$$

where N_{SR} indicates half the size of reported subcarriers excluding Nulls

$${M}_{H} ( m , l ) = min \{ 7 , ⌊ 20 log 10 ( \frac{max {\{ {m}_{H} ( m , l ) \}}_{m = 1 , l = 1}^{m = Nr , l = Nc}}{{m}_{H} ( m , l )} ) ⌋ \} \qquad Equation ( 22.2 )$$

$${M}_{H}^{lin} ( m , l ) = \frac{max {\{ {m}_{H} ( m , l ) \}}_{m = 1 , l = 1}^{m = Nr , l = Nc}}{{10}^{mH ( m , l ) / 20}} \qquad Equation ( 22.3 )$$

$${P}_{( m , l )}^{q} ( k ) = ⌊ \frac{{P}_{( m , l )} ( k )}{Max\_P} ( {2}^{Nb - 1} - 1 ) + 0.5 ⌋ \qquad Equation ( 22.4 )$$

Since the phase values are in the range of −180° to 180°, 2s complement encoding is used and hence the quantized phase values are in the range of −(2^{Nb-1}−1) to (2^{Nb-1}−1).

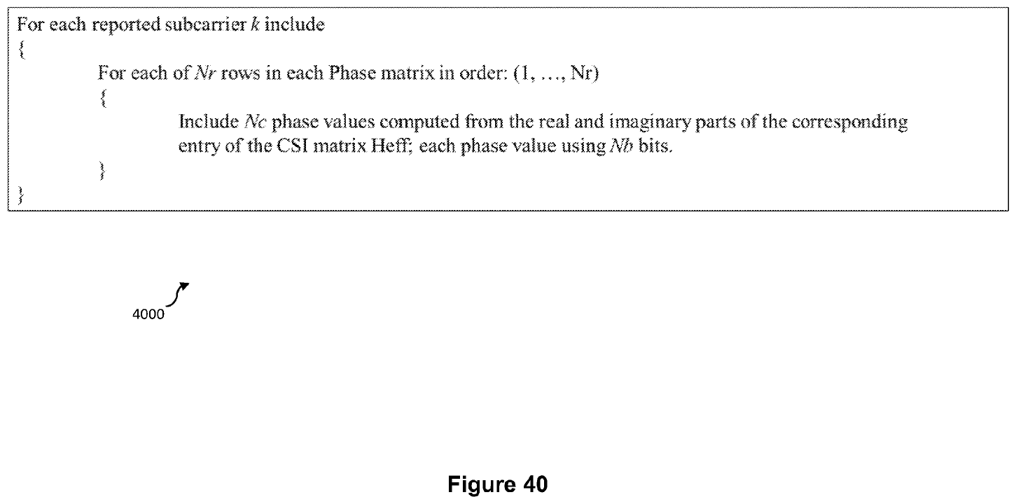

The code structure of the phase matrix P^{q}(k) (for subcarrier k) is illustrated in FIG. 40. In addition, 3 bits are used for scaling ratio for each combination of m (1 to N_{c}) and l (1 to Nᵣ). Such field is called Phase Scaling Ratio field. Advantageously, as the total number of Tx-Rx pairs (Nᵣ×N_{c}) is typically smaller than the number of reported subcarriers, such encoding method will further reduce the overhead.

The following paragraphs explain the Sensing Receiver operation for phase matrix reporting according to the sixth embodiment of the present disclosure.

Each phase matrix is encoded using (N_{b}×N_{c}×Nᵣ) bits, as shown in Table 16, as compared to (3+2×N_{b}×N_{c}×Nᵣ) for 802.11n encoding rules. N_{c} and Nᵣ are the number of rows and columns, respectively, in the channel matrix estimate computed by the Sensing receiver.

Maximum Phase (Max_P)=max{m_{H}(m,l)}_{z=-N}_{_{SR}}^{z=N}^{_{SR}} in equation (22.2) is quantized as two unsigned integers (first 8-bits to carry the decimal part and second 16-bits to carry the fractional part rounded to 4 digits). According to this embodiment, 3 bits are used for scaling ratio (phase scaling ratio) for each combination of m and l, starting with m=1 and l increasing in range from 1 to N_{c}, and then to the next m value until m=Nᵣ.

TABLE 16
an example Measurement Report field (Phase) according to the sixth
embodiment of the present disclosure, where scidx(n) is defined to
indicate the exact subcarrier index corresponding to the reported
subcarrier n; and Nₛ is the number of subcarriers for which
the phase matrix is reported and is a function of the grouping
parameter N_{g} (every N_{g} adjacent subcarrier
is grouped and a single value for each group of
N_{g} adjacent subcarriers is transmitted)

| Field | Size (bits) | Meaning |
|---|---|---|
| SNR in receive chain 1 | 8 | SNR in the first receive chain |
| | | of the STA sending the |
| | | report. |
| . . . | | |
| Maximum Phase | 8 + 16 = 24 | Maximum value over the |
| | | absolute values of all |
| | | reported phase values |
| | | (Max_P) quantized as two |
| | | unsigned integers (first 8-bits |
| | | to carry the decimal part and |
| | | second 16-bits to carry the |
| | | fractional part rounded to 4 |
| | | digits). |
| Phase matrix for | N_{b} × N_{c} × Nᵣ | Phase matrix according to |
| subcarrier | | FIG. 14 |
| k = scidx(0) | | |
| . . . | | |
| Phase matrix for | N_{b} × N_{c} × Nᵣ | Phase Matrix |
| subcarrier | | |
| k = scidx(Nₛ − 1) | | |
| 1^{st} Phase Scaling | 3 | Scaling Ratio for 1^{st} |
| Ratio field | | combination of m and l |
| . . . | | |
| (Nr × Nc)^{th} Phase | 3 | Scaling Ratio for the last |
| Scaling Ratio field | | combination of m and l |

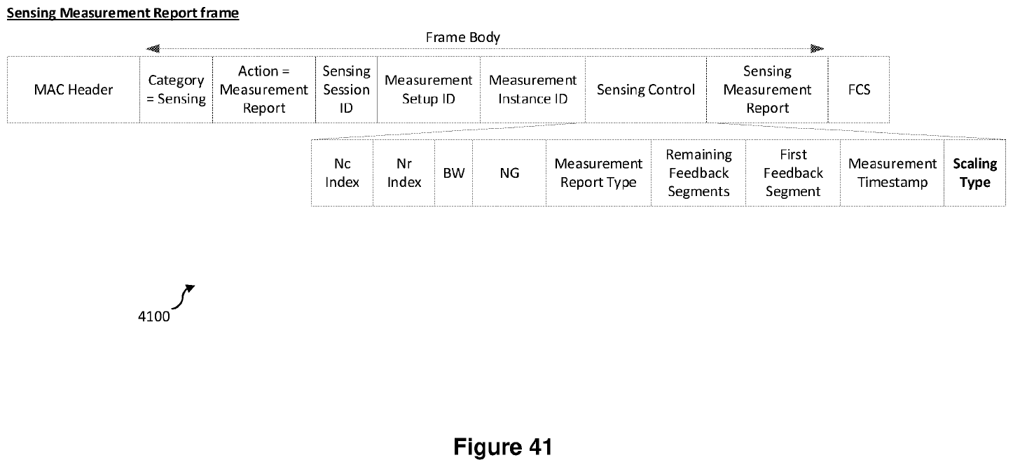

For scaling indication, the Sensing Responder may transmit a Sensing Measurement Report frame to indicate the scaling method used (per Tx-Rx pair or per subcarrier). FIG. 41 shows an example Sensing Measurement Report frame 4100 according to the sixth embodiment of the present disclosure. The Sensing Measurement Report frame 4100 comprises a MAC Header, a Category field (set to “Sensing”), an Action field (set to “Measurement Report”, a Sensing Session ID field, a Measurement Setup ID field, a Measurement Instance ID field, a Sensing Control field, a Sensing Measurement Report field and a FCS field. The Sensing Measurement Report field further comprises a N_{c} Index field, a Nᵣ Index field, a BW field, a N_{g} field, a Measurement Report Type field, a Remaining Feedback Segment field, a First Feedback Segment field, a Measurement Timestamp field and a Scaling Type field. The Scaling Type field indicates the scaling type or method used: per Tx-Rx pair or per subcarrier.

The following paragraphs explain the Sensing Initiator operation for phase matrix decoding according to the sixth embodiment of the present disclosure.

For phase value decoding by Sensing Initiator, the received, quantized phase matrix P^{q}(k) (for subcarrier k) is decoded, as follows:
the decimal and fractional parts of the Maximum Phase indicated in the Measurement Report field are decoded as positive integers and the Maximum Amplitude ( [symbol] ) is recovered by combining the decimal and fractional parts. If the Maximum Phase field is omitted in the Measurement Report field, [symbol] =180°;
each element of the Phase Matrix, P_{(m,l)}^{q}(k), is decoded as a 2s complement number, where 1≤m≤Nᵣ and 1≤l≤N_{c}; and
each element of the Phase Matrix, P_{(m,l)}^{q}(k), is scaled using the value in the Phase Scaling Ratio field (3 bits), M_{H}(m, l), interpreted as a positive integer, in dBs by calculating the linear value and the decoded value of the Phase matrix elements according to equations (23.1) and (23.2) respectively.

$$r ( m , l ) = 1 {0}^{{M}_{H} ( m , l ) / 20} \qquad Equation ( 23.1 )$$

$${\tilde{P}}_{( m , l )}^{q} ( k ) = \frac{{P}_{( m , l )} ( k )}{r ( m , l )} \times \frac{( {2}^{Nb - 1} - 1 )}{} \qquad Equation ( 23.2 )$$

According to the simulation results of this embodiment shown in Table 17, it is observed that by scaling according to Tx-Rx pair as described in this embodiment of the present disclosure, an even higher feedback bit size reduction of close to 50% with some gain in SQNR can be achieved as compared to the 802.11n scaling scheme. This provides the effect and advantage of higher accuracy with slight improvement in overhead reduction.

TABLE 17
simulation results for phase values recovered from original CSI of a measurement signal transmitted
in 20 MHz channel (56 subcarriers) with 3 columns and 3 rows (N_{c} = 3, Nᵣ = 3)
using the phase recovery scheme described in the sixth embodiment of the present disclosure

| | 802.11n rules based with | | | | | |
|---|---|---|---|---|---|---|
| | max(M_{H}(k)) scaling | | This embodiment | | | |
| | | Total size of | | Total size of | | |
| | | Feedback Bits | | Feedback Bits | Difference | |
| | | 8 × Nᵣ + 24 + (3 + | | 8 × Nᵣ + 24 + (N_{b} × | | Feedback |
| Feedback | SQNR | 2 × N_{b} × N_{c} × | SQNR | N_{c} × Nᵣ) × Nₛ + | SQNR | Bit size |
| Bit size N_{b} | (dB) | Nᵣ) × Nₛ | (dB) | 3 × (N_{c} × Nᵣ) | gain (dB) | reduction |
| 4 | 25.699 | 4248 | 25.873 | 2091 | 0.1734 | 50.77 |
| 6 | 38.008 | 6264 | 38.378 | 3099 | 0.3706 | 50.53 |
| 8 | 49.340 | 8280 | 40.356 | 4107 | 1.0158 | 50.40 |

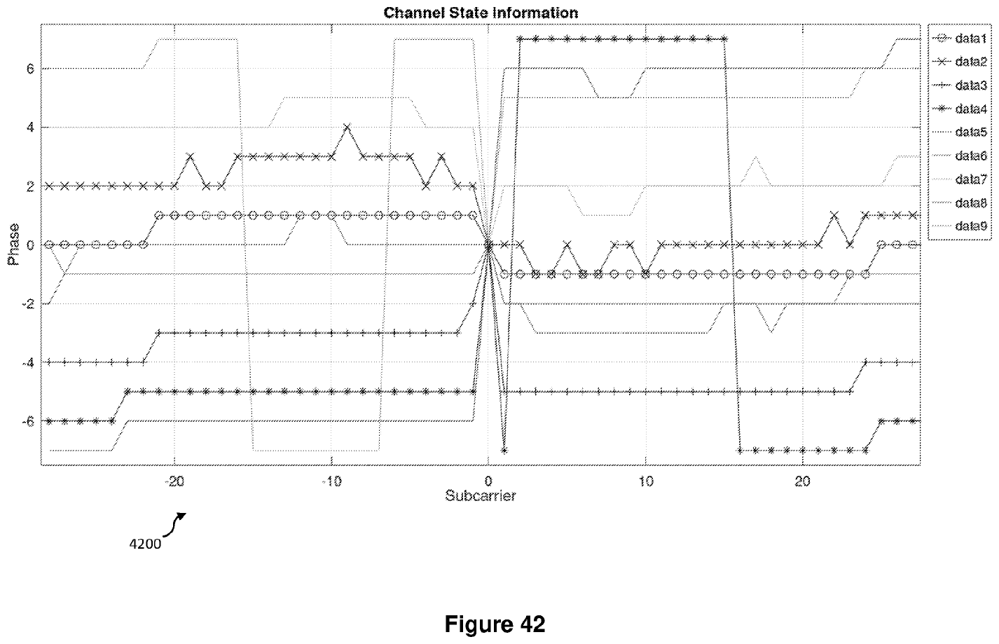

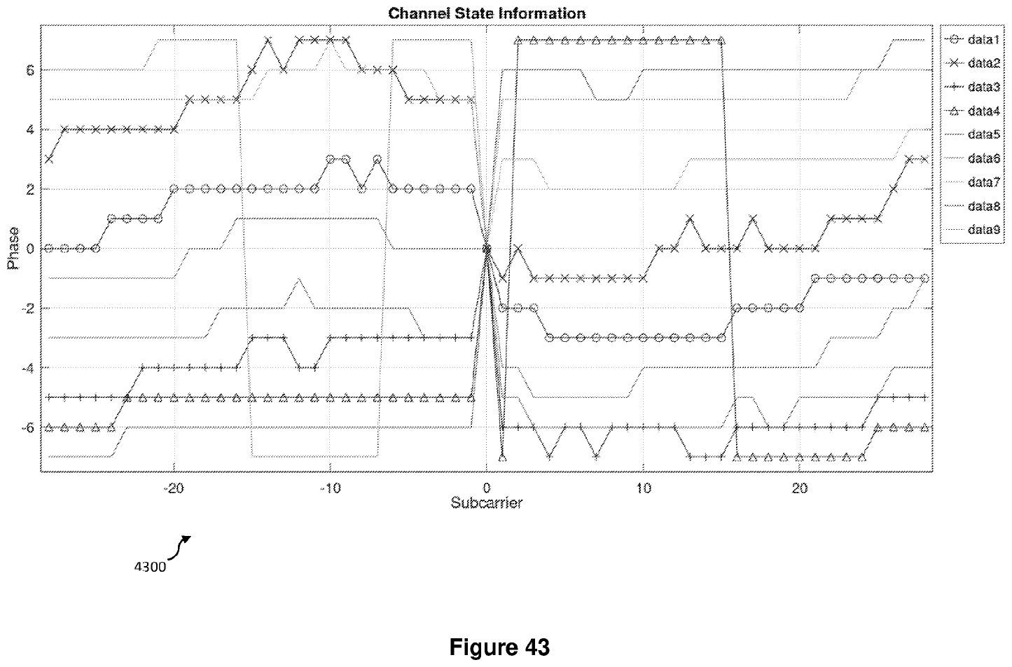

FIG. 42 shows a graph 4200 illustrating a simulation result of quantized phase values of CSI of a measurement signal where scaling per subcarrier is applied according to 802.11n method, and FIG. 43 shows a graph 4300 illustrating a simulation result of quantized phase values of CSI of a measurement signal where scaling per Tx-Rx antenna pair is applied according to the sixth embodiment of the present disclosure. The number of bits (N_{b}) for each quantized value (I and Q for 802.11n, and phase values for our scheme) is 4. By comparing the quantized phase values of the two scaling methods in FIGS. 42 and 43, it is observed that the scaling per Tx-Rx pair is more effective for Tx-Rx pairs in which the subcarriers do not reach 180°/−180°.

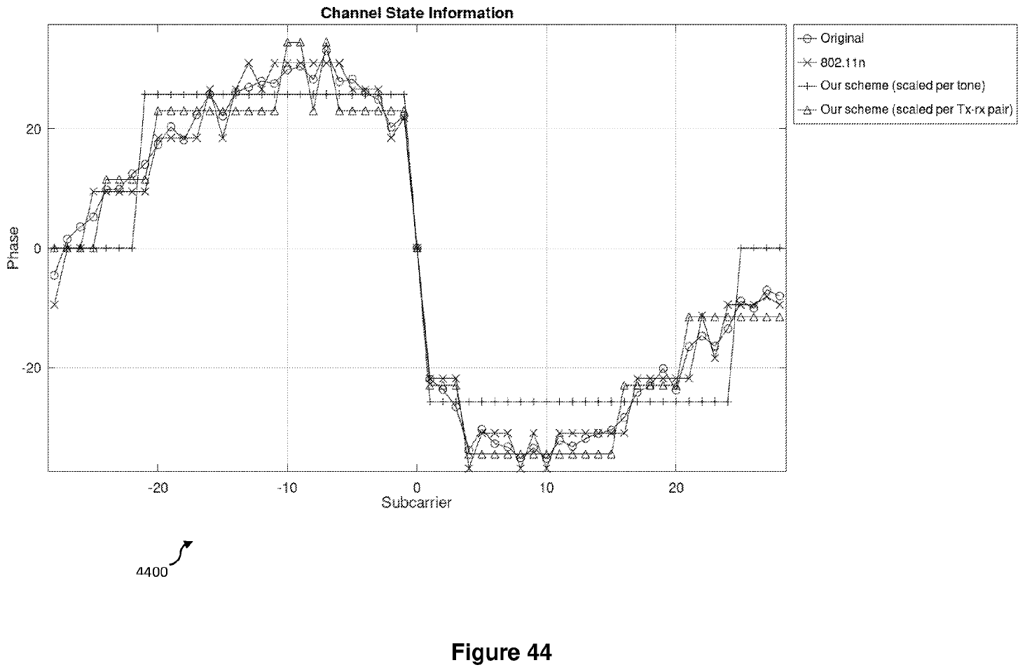

FIG. 44 show a graph 4400 illustrating a simulation result of phase values recovered from CSI of a measurement signal and scaled per Tx-Rx pair according to the sixth embodiment of the present disclosure. The original CSI curve, the CSI curve recovered using conventional 802.11n scheme (based with max(M_{H}(k)) scaling) with feedback bit size of 4248, and the phase curve recovered according to the phase recover scheme described in the second embodiment (scaled per subcarrier) are also shown. The phase curve (i.e., phase values over all 56 subcarriers) recovered from CSI according to the phase recovery scheme described in this embodiment (scaled per Tx-Rx pair) has a feedback bit size of 2091.

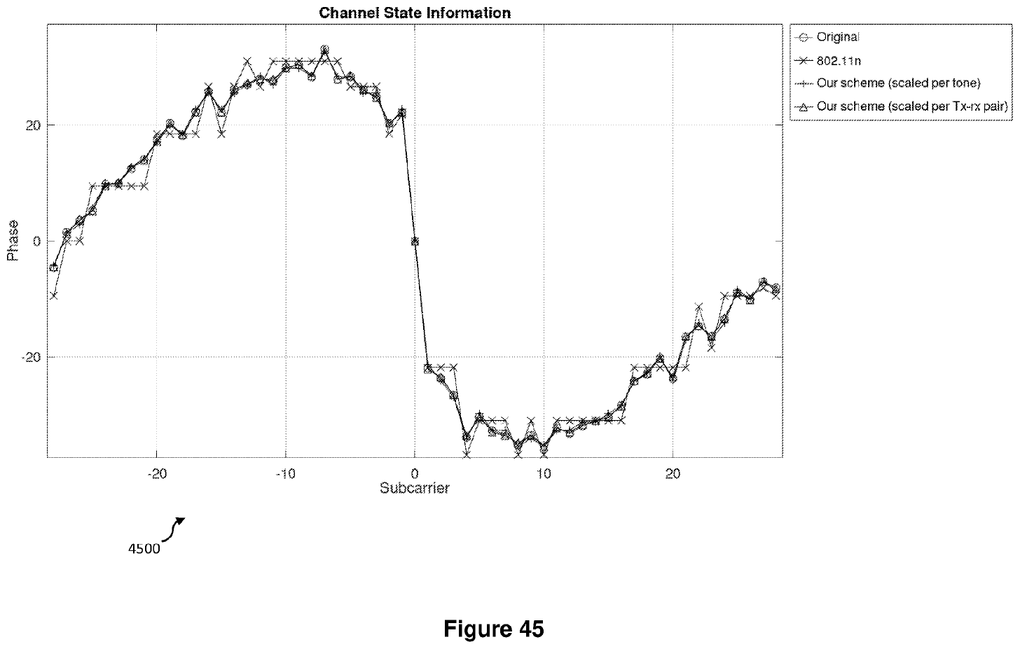

FIG. 45 show a graph 4500 illustrating a simulation result of phase values recovered from CSI of a measurement signal and scaled per Tx-Rx pair with higher feedback bit size according to the sixth embodiment of the present disclosure. If the feedback bit size of the phase sub-component recovered using the phase recovery scheme described this embodiment is increased to 4248, matching that of 802.11n scheme, while 802.11n scheme uses N_{b}=4 for the real and imaginary parts of each entry of the CSI matrices, the phase recovery scheme described this embodiment can use N_{b}=8 bits for each entry of the phase matrices. The phase curve recovered from CSI and scaled per Tx-Rx pair according to the phase recovery scheme described in this embodiment is almost identical to the original curve.

In the following paragraphs, a seventh embodiment of the present disclosure which relates to phase values recovered using differential encoding scheme is explained.

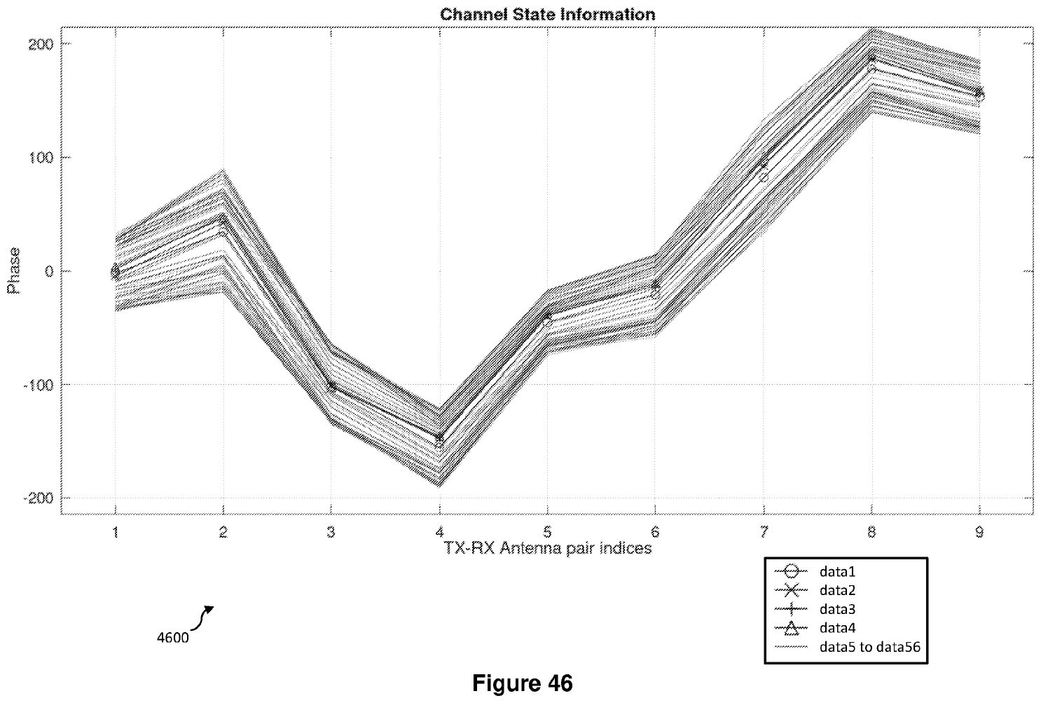

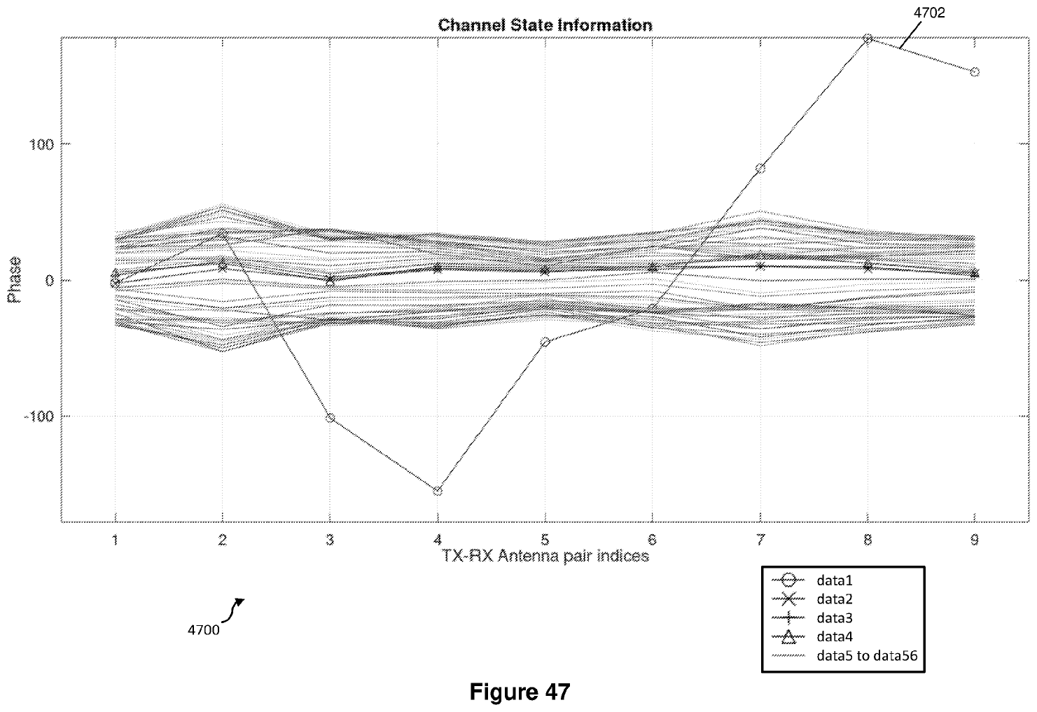

FIG. 46 shows a graph 4600 illustrating of unwrapped phase sub-components of FIG. 39 according to the embodiment and scaled per Tx-Rx pair, for example, by either adding or subtracting 360° as appropriate to remove phase value discontinuities. A mean (e.g., arithmetic mean in this example) is then computed using the unwrapped phase values to calculate the variances (difference from the mean value) of phase values per each Tx-Rx pair. FIG. 47 shows a graph 4700 illustrating mean values 4702 of unwrapped phase values of FIG. 45 and phases differences from the mean values according to the embodiment. It can be observed that the variance of the phase values are not large when compared to the original phase values.

According to this embodiment, when the curves of CSI values (I, Q, amplitude or phase) are relative flat, i.e., do not vary much from a reference value (e.g., means) or the variance is not large, differential encoding (i.e., signaling the differences instead of the absolute values) may result in higher accuracy. The differential encoding scheme for phase values is carried out, prior to the encoding scheme described in the sixth embodiment as follows:
Unwrap the vector of P_{(m,l)} over all reported subcarriers, for each Tx-Rx pair;
Let, P_{av(m,l)} be the arithmetic mean of P_{(m,l)}(k) over all reported subcarriers for each Tx-Rx pair. Alternatively, P_{av(m,l)} is calculated using equation (24);
Let, P_{diff(m,l)}(k)=P_{(m,l)}(k)−P_{av(m,l)};
Encode P_{diff(m,l)} following the encoding steps described using equations (22.1) to (22.4) and the phase value encoding scheme described in the sixth embodiment. Since P_{diff(m,l)}(k) are relatively small values (compared to the original phase values), scaling is much more effective for P_{diff(m,l)}(k);
Wrap P_{av(m,l)} to the range of −180° to 180°; and
P_{av(m,l)} are separately encoded (e.g., by rounding to the nearest integer using 9 bits in the range (−180, 180)) and transmitted in measurement report field along with the scaled P_{diff(m,l)} and corresponding scale factors.

$${P}_{av ( m , l )} = \frac{max ( {P}_{( m , l )} ( k ) ) + min ( {P}_{( m , l )} ( k ) )}{2} \qquad Equation ( 24 )$$

The quantized Phase difference matrix P_{diff(m,l)}^{q}(k)(for subcarrier k) in this case has similar structure as shown in FIG. 40, except that, for each combination of m (1 to Nᵣ) and l (1 to Nc), additional 9 bits are used for each P_{av(m,l)}. Such field is called Mean Phase field. Total feedback bit size is 8×Nᵣ+24+(N_{b}×N_{c}×Nᵣ)×Nₛ+(3+9)×(N_{c}×Nᵣ).

It is noted that prior to using the differential encoding scheme, the Sensing Receiver may compute the sum of variance of the phase values over all subcarriers for each Tx-Rx pair and the sum of variance of the phase values over all Tx-Rx pair for each subcarrier. If the sum of variance of the phase values over all subcarriers for each Tx-Rx pair is smaller, differential encoding is used per Tx-Rx pair, and if the sum of variance of the phase values over all Tx-Rx pair for each subcarrier is smaller, differential encoding per subcarrier is used, in which case in the mean (Pₐᵥ(k)) is calculated over all Tx-Rx pairs for each subcarrier. The Sensing Receiver may further compare the sum of variance against a threshold value to determine whether to use differential coding based on a result of the comparison. For example, differential coding scheme is performed if the variance is less than the threshold value.

In one implementation, feedback overhead may be further reduced (albeit with some loss in accuracy) if a single mean value Pₐᵥ is computed over P_{av(m,l)} of all TX-RX pairs and P_{diff(m,l)}(k)=P_{(m,l)}(k)−Pₐᵥ. In this case only a single Pₐᵥ needs to be included in the measurement report field.

The following paragraphs explain the Sensing Initiator operation for phase value decoding according to the seventh embodiment of the present disclosure.

For phase value decoding according to this embodiment, the received, quantized phase difference matrix P_{diff(m,l)}^{q}(k) for subcarrier k is decoded, as follows:
Decoding P_{diff(m,l)}^{q}(k) as \tilde{P}_{diff(m,l)}^{q}(k) following the equations (23.1) and (23.2) and the phase value decoding scheme described in the sixth embodiment of the present disclosure;
Read P_{av(m,l)} from the corresponding Mean Phase fields;
The phase values are recovered according to equation (25); and
Wrap \tilde{P}_{(m,l)}^{q}(k) to the range of −180°, 180°.

$${\tilde{P}}_{( m , l )}^{q} ( k ) = {P}_{av ( m , l )} + {\tilde{P}}_{diff ( m , l )}^{q} ( k ) \qquad Equation ( 25 )$$

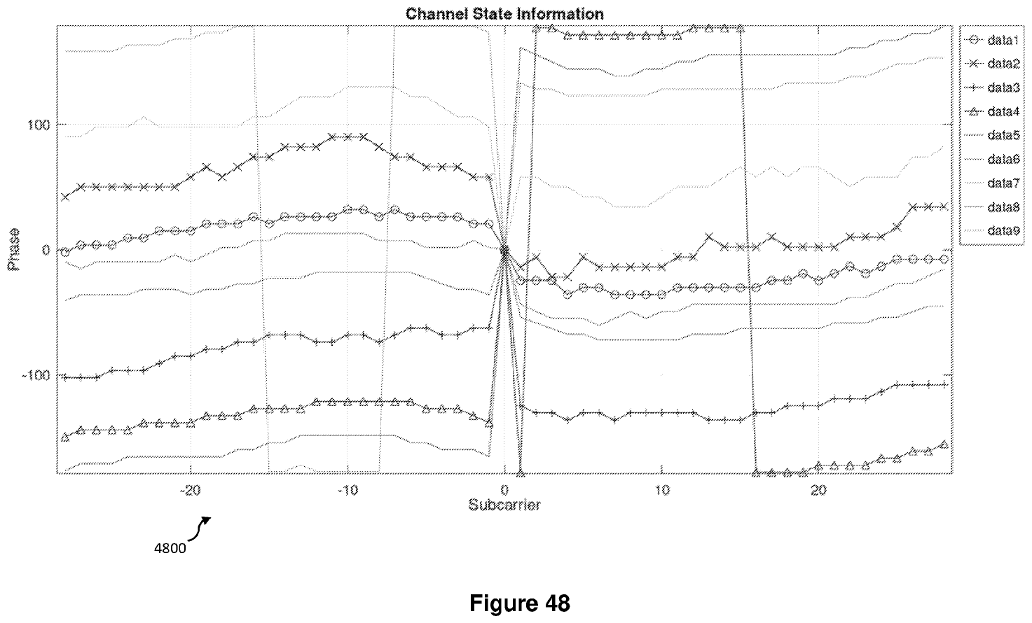

FIG. 48 shows a graph 4800 illustrating a simulation result of phase values recovered from CSI of a measurement signal using differential encoding scheme according to the seventh embodiment of the present disclosure. It can be observed that the phase curves recovered according to the phase recovery scheme described in this embodiment is very close to the original phase curve as shown in FIG. 43.

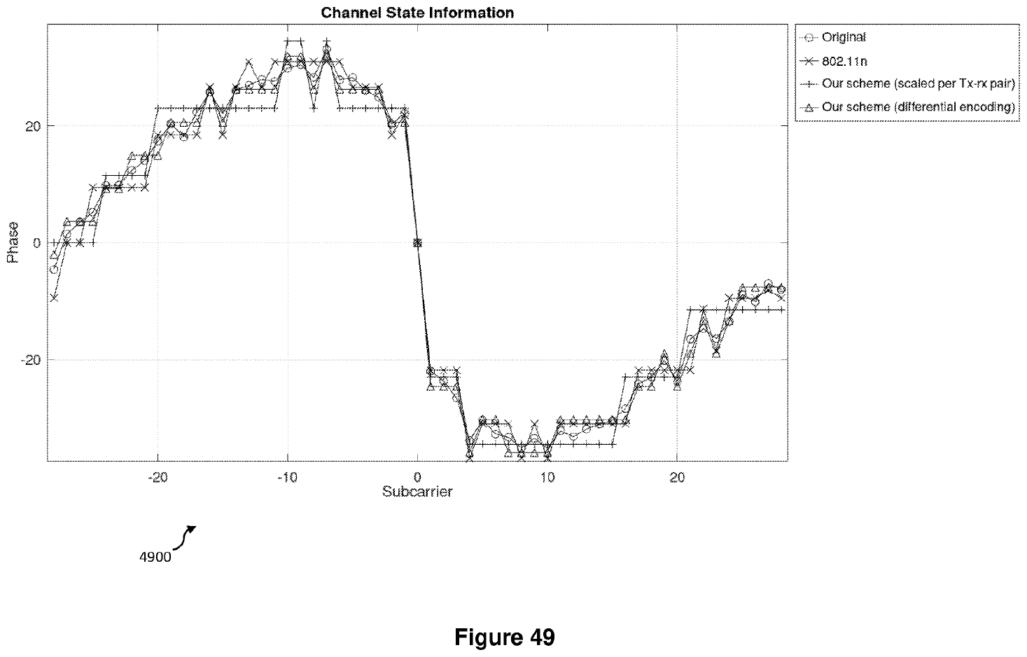

FIG. 49 shows a graph 4900 illustrating another simulation result of phase values recovered from CSI of a measurement signal using differential encoding scheme according to the seventh embodiment of the present disclosure. The original CSI, the CSI curve recovered using conventional 802.11n rules (based with max(M_{H}(k)) scaling) with feedback bit size of 4248, and the phase curve recovered according to the phase recover scheme described in the sixth embodiment (scaled per Tx-Rx pair) are also shown. The number of bits (N_{b}) for each quantized value (I and Q for 802.11n, and phase values for our scheme) is 4. The phase sub-component curve recovered according to the phase recovery scheme described in this embodiment using different encoding both have a slightly larger feedback bit size of 2172 but the curve recovered from differential encoding scheme is much closer to the original curve as compared to that scaled per Tx-Rx pair and the CSI curve recovered from 802.11n scheme.

TABLE 18
simulation results for phase values recovered using differential encoding scheme
from original CSI of a measurement signal transmitted in 20 MHz channel (56
subcarriers) with 3 columns and 3 rows (N_{c} = 3, Nᵣ = 3) using the phase
recovery scheme described in the seventh embodiment of the present disclosure

| | 802.11n rules based with | | | | | |
|---|---|---|---|---|---|---|
| | max(M_{H}(k)) scaling | | This embodiment | | | |
| | | Total size of | | Total size of | | |
| | | Feedback Bits | | Feedback Bits | Difference | |
| | | 8 × Nᵣ + 24 + (3 + | | 8 × Nᵣ + 24 + (N_{b} × | | Feedback |
| Feedback | SQNR | 2 × N_{b} × N_{c} × | SQNR | N_{c} × Nᵣ) × Nₛ + | SQNR | Bit size |
| Bit size N_{b} | (dB) | Nᵣ) × Nₛ | (dB) | (3 + 9) × (N_{c} × Nᵣ). | gain (dB) | reduction |
| 4 | 25.699 | 4248 | 35.262 | 2172 | 9.5621 | 48.870 |
| 6 | 38.008 | 6264 | 46.849 | 3099 | 8.8411 | 49.234 |
| 8 | 49.340 | 8280 | 50.770 | 4107 | 1.4295 | 49.420 |

According to the simulation results of this embodiment shown in Table 18, it is observed that by using differential encoding, a higher SQNR gain with a feedback bit size reduction of close to 50% can be achieved as compared to the 802.11n scheme. This provides the effect and advantage of higher accuracy with slight decrease in overhead reduction.

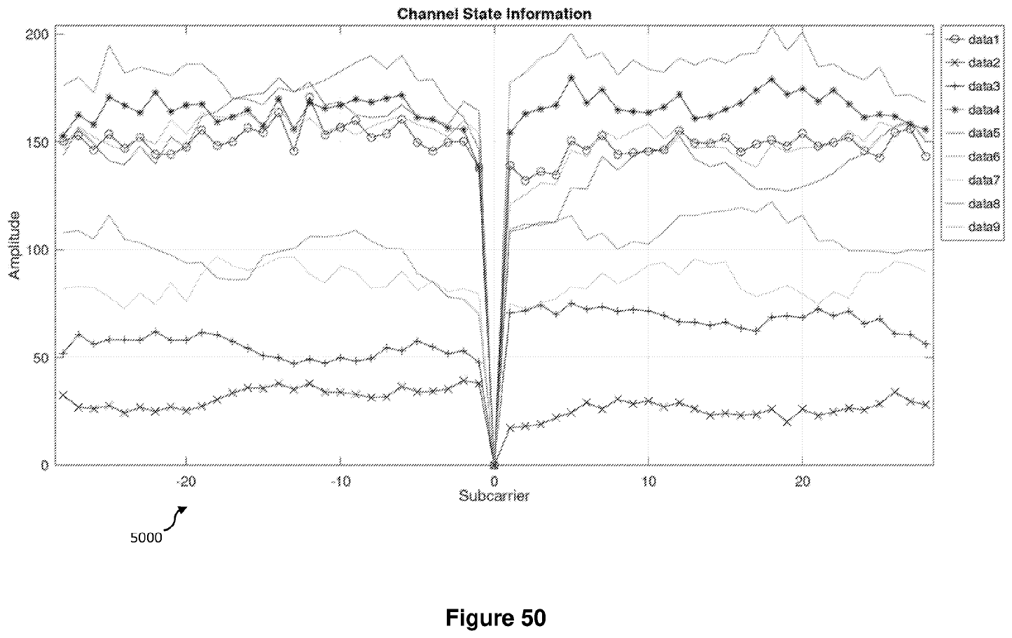

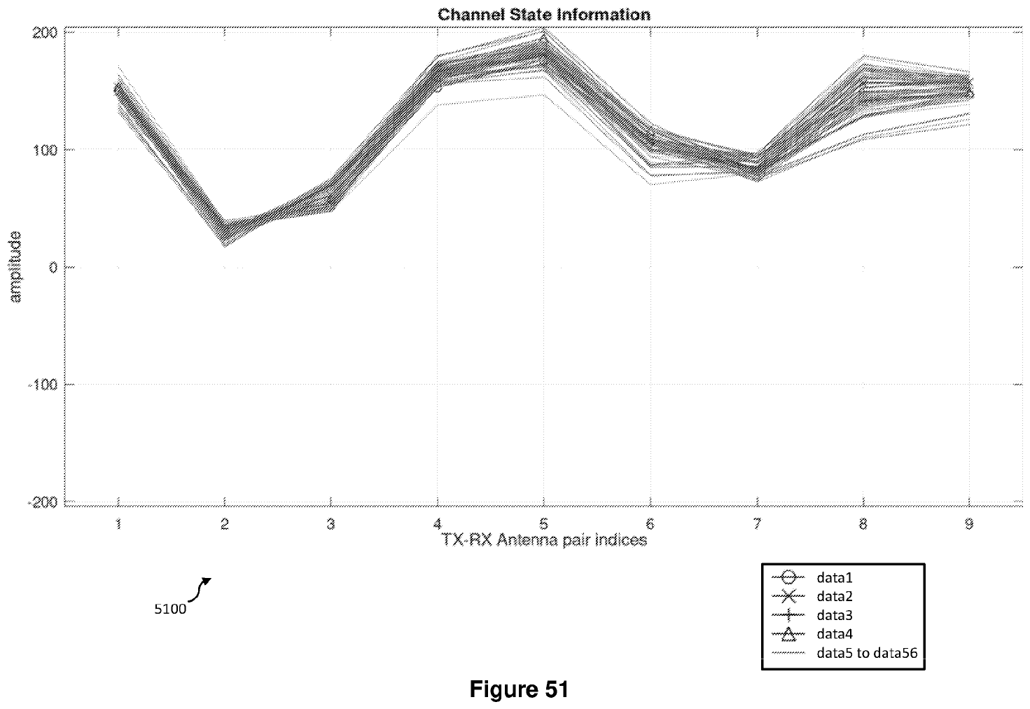

FIGS. 50 and 51 show a graph 5000, 5100 illustrating original amplitude values recovered from CSI of a measurement signal per subcarrier and per Tx-Rx pair according to the seventh embodiment of the present disclosure, respectively. It can be observed that the variance in amplitude value across subcarriers for each Tx-Rx pair is not high.

Accordingly, differential encoding scheme can also be applied for amplitude values prior to amplitude value encoding scheme described in the first embodiment, as follows:
Let, A_{av(m,l)} be the arithmetic mean of A_{(m,l)}(k) over all reported subcarriers for each Tx-Rx pair. Alternatively, we can also use A_{av(m,l)} is calculated using equation (26);
Let, A_{diff(m,l)}(k)=A_{(m,l)}(k)−A_{av(m,l)};
Encode A_{diff(m,l)} following the encoding steps described using equations (22.1) to (22.4) and the phase value encoding scheme described in the sixth embodiment except that P_{(m,l)}(k) are replaced with A_{(m,l)}(k). Since A_{diff(m,l)}(k) are relatively small values (compared to the original amplitude values), scaling is much more effective for A_{diff(m,l)}(k); and
A_{av(m,l)} are separately encoded (e.g., by rounding to the nearest integer using 12 bits in the range (0, 4095)) and transmitted in measurement report field along with the scaled A_{diff(m,l)} and corresponding scale factors.

$${A}_{av ( m , l )} = \frac{max ( {A}_{( m , l )} ( k ) ) + min ( {A}_{( m , l )} ( k ) )}{2} \qquad Equation ( 26 )$$

The quantized Amplitude difference matrix A_{diff(m,l)}^{q}(k)(for subcarrier k) in this case has similar structure as E6-F1 in slide 80, except that amplitude matrices are carried instead of phase matrices and for each combination of m (1 to Nr) and l (1 to Nc) additional 12 bits are used for each A_{av(m,l)}. Such field is called Mean Amplitude field. Total feedback bit size is 8×Nᵣ+24+(N_{b}×N_{c}×Nᵣ)×Nₛ+(3+12)×(N_{c}×Nᵣ).

It is noted that prior to using the differential encoding scheme, the Sensing Receiver may compute the sum of variance of the amplitude values over all subcarriers for each Tx-Rx pair and the sum of variance of the amplitude values over all Tx-Rx pair for each subcarrier. If the sum of variance of the amplitude values over all subcarriers for each Tx-Rx pair is smaller, differential encoding is used per Tx-Rx pair, and if the sum of variance of the amplitude values over all Tx-Rx pair for each subcarrier is smaller, differential encoding per subcarrier is used, in which case in the mean (Aₐᵥ(k)) is calculated over all Tx-Rx pairs for each subcarrier. The Sensing Receiver may further compare the sum of variance may also be compared against a threshold value to determine whether to use differential coding based on a result of the comparison. For example, differential coding scheme is performed if the variance is less than the threshold value

In one implementation, feedback overhead may be further reduced (albeit with some loss in accuracy) if a single mean value Aₐᵥ is computed over A_{av(m,l)} of all Tx-Rx pairs and A_{diff(m,l)}(k)=A_{(m,l)}(k)−Aₐᵥ. In this case only a single Aₐᵥ needs to be included in the measurement report field.

For amplitude value decoding according to this embodiment, the received, quantized amplitude difference matrix A_{diff}^{q}(ml)(k) for subcarrier k is decoded, as follows:
Decoding P_{diff(m,l)}^{q}(k) as Ã_{diff(m,l)}^{q}(k) following the equations (23.1) and (23.2) and the phase value decoding scheme described in the sixth embodiment of the present disclosure except that P_{(m,l)}^{q}(k) are replaced with Ã_{(m,l)}^{q}(k) and [symbol] is replaced with [symbol] ;
Read A_{av(m,l)} from the corresponding Mean Amplitude fields;
The amplitude values are recovered according to equation (27); and

$${Ã}_{( m , l )}^{q} ( k ) = {A}_{av ( m , l )} + {Ã}_{diff ( m , l )}^{q} ( k ) \qquad Equation ( 27 )$$

It is further noted that if only one or a few subcarriers have values which are much different from other subcarriers, it affects the scaling and channel estimation. Such case may happen by narrow-band interference (in this case, its amplitude is much larger) or null frequency by multipath (in this case, the amplitude is smaller and the phase may have large error due to low SNR). In either case, the values of such subcarrier is unreliable. The scaling can be improved if such subcarriers are excluded to determine the range for scaling. In this case, the value of excluded subcarriers are clipped and not recovered, but it may be allowable because these values are probably unreliable.

Alternatively, instead of removing data of such subcarriers from the feedback, the CSI feedback may also include a 1-bit as a reliability flag per subcarrier (e.g., set to 1 to indicate an unreliable subcarrier). The usage can be left to applications, for example, applications may choose to discard the data of the feedback entries for the subcarriers indicated as unreliable.

In some embodiments, the phase and amplitude sub-components are described in conjunction with a specific scaling method, however, the scaling methods such as per Tx-Rx pair or per subcarrier can be used for any CSI sub-component including the real and imaginary sub-component.

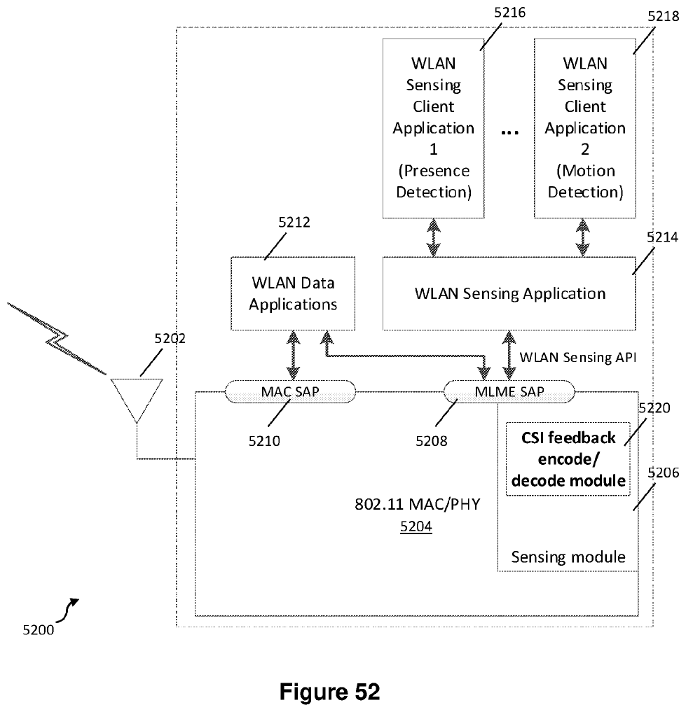

FIG. 52 shows a block diagram 5200 illustrating configuration of a communication apparatus which may be implemented as an initiating communication apparatus (Sensing Initiator) and a reporting communication apparatus (Sensing Responder) according to various embodiments of the present disclosure. The communication apparatus may include at least one antenna 5202 for transmission and receipt of signals (for the sake of simplicity, only one antenna is shown in FIG. 52). The communication apparatus 5200 further comprises 802.11 MAC/PHY sublayers 5204 comprising a Sensing module 5206 for channel measurements; layer management service interfaces such as MLME SAP 5208 and MAC SAP 5210 through which defined primitives are exchanged to pass information and layer management functions such as WLAN sensing may be invoked; and higher layer applications (e.g. WLAN Data Applications 5212 and WLAN Sensing Application 5214) communicating with the 802.11 MAC/PHY 5204 through MLME SAP 5208.

Further, the 802.11 MAC/PHY sublayers 5204 may communicate with WLAN Data Applications 5212 through MAC SAP 5210 and MLME SAP 5208. In this example, the Sensing module 5206 performs channel measurements and provides raw results to WLAN Sensing Application 5214 via WLAN Sensing API. The WLAN Sensing Application 5214 collects and consolidates the channel measurement results from 802.11 device and may process the results (e.g., smoothing compression etc.) before passing the processed results to WLAN Sensing Client Applications like 5216, 5218. The WLAN Sensing Client Applications like 5216, 5218 may perform WLAN Sensing based on the channel measurements (e.g., using application specific machine learning algorithms etc.) and provides the results of the WLAN sensing, in this case, presence/absence of human detection and human motion detection.

The communication apparatus further comprises a layer-dependent entity Station Management Entity (SME) (not shown) which perform functions on behalf of general system management entities and would implement standard management protocol such as to ensure correct MAC operation. The layer-dependent entity provides interfaces such as MLME SAP 5208 and PLME SAP (not shown) for exchanging primitives and communicating with MLME and PLME, respectively.

In one embodiment, the higher layer applications may request a MLME primitive (not shown), e.g., using MLME-Sensing.request primitive, through Sensing Service Access Point (SENSE SAP) (not shown) to initiate a channel measurement.

The MAC/PHY Sublayer 5204 may be configured to receive information or WLAN sensing related MAC/PHY parameters to form a trigger frame or physical layer protocol data unit (PPDU), e.g., Sounding PPDU (NDP), NDP Announcement frame, PPDU comprising a Request frame or an Announcement frame. The trigger frame or PPDU is then transmitted to one or more communication apparatuses (e.g., reporting communication apparatus), via at least one radio transmitter (not shown) through the antenna 5202.

The MAC/PHY Sublayer 5204 may also be configured to unpack response or measurement PPDU, e.g., Response frame, Sounding PPDUs or NDPs, or trigger frame received from another communication apparatus and pass the information related to the received PPDU or trigger frame to the Sensing module 5216

The Sensing module 5220 further comprises a CSI feedback encode/decode module configured to decode and encode CSI information, e.g., information of a CSI sub-component (e.g., amplitude, phase, I and Q) indicated by a report type indicator, according to various embodiments above in the present disclosure.

As described above, the embodiments of the present disclosure provide communication methods and communication apparatuses for partial channel state information feedback.

The present disclosure can be realized by software, hardware, or software in cooperation with hardware. Each functional block used in the description of each embodiment described above can be partly or entirely realized by an LSI (large-scale integration) such as an integrated circuit, and each process described in each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra LSI depending on a difference in the degree of integration. However, the technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing. If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred as a communication device.

The communication apparatus may comprise a transceiver and processing/control circuitry. The transceiver may comprise and/or function as a receiver and a transmitter. The transceiver, as the transmitter and receiver, may include a radio frequency (RF) module including amplifiers, RF modulators/demodulators and the like, and one or more antennas.

Some non-limiting examples of such communication device include a phone (e.g., cellular (cell) phone, smart phone), a tablet, a personal computer (PC) (e.g., laptop, desktop, netbook), a camera (e.g., digital still/video camera), a digital player (digital audio/video player), a wearable device (e.g., wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication device is not limited to be portable or movable, and may also include any kind of apparatus, device or system being non-portable or stationary, such as a smart home device (e.g., an appliance, lighting, smart meter, control panel), a vending machine, and any other “things” in a network of an “Internet of Things (IoT)”.

The communication may include exchanging data through, for example, a cellular system, a wireless LAN system, a satellite system, etc., and various combinations thereof.

The communication device may comprise an apparatus such as a controller or a sensor which is coupled to a communication apparatus performing a function of communication described in the present disclosure. For example, the communication device may comprise a controller or a sensor that generates control signals or data signals which are used by a communication apparatus performing a communication function of the communication device.

The communication device also may include an infrastructure facility, such as a base station, an access point, and any other apparatus, device or system that communicates with or controls apparatuses such as those in the above non-limiting examples.

While exemplary embodiments have been presented in the foregoing detailed description of the present embodiments, it should be appreciated that a vast number of variations exist. It should further be appreciated that the exemplary embodiments are examples, and are not intended to limit the scope, applicability, operation, or configuration of this disclosure in any way. Rather, the foregoing detailed description will provide those skilled in the art with a convenient road map for implementing exemplary embodiments, it being understood that various changes may be made in the function and arrangement of steps and method of operation described in the exemplary embodiments and modules and structures of devices described in the exemplary embodiments without departing from the scope of the subject matter as set forth in the appended claims.

1. A reporting communication apparatus comprising:
a receiver, which in operation, receives a measurement signal;
circuitry, which in operation, is configured to measure channel state information (CSI) of the received measurement signal; and
a transmitter, which in operation, transmits a report frame including information of a sub-component of the CSI.

2. The reporting communication apparatus according to claim 1, wherein the receiver is connected to one or more receive antennas and receives the measurement signal from an initiating communication apparatus; and
the information of a sub-component of the CSI has a scaled value using a scaling factor that is calculated for each transmit and receive antenna pair.

3. The reporting communication apparatus according to claim 2, wherein the report frame further includes the scaling factor that is calculated for each transmit and receive antenna pair.

4. The reporting communication apparatus according to claim 1, further comprising:
the receiver further receives a frame, from an initiating communication apparatus, carrying a report type indication indicating a sub-component of the CSI, wherein the transmitter transmits the report frame carrying the information of the indicated sub-component of the CSI to the initiating communication apparatus.

5. The reporting communication apparatus according to claim 1, wherein the sub-component of the CSI is one of an amplitude, a phase, a real part and an imaginary part of the CSI.

6. The reporting communication apparatus according to claim 4, wherein the frame carrying the report type indication is received during one of a sensing session setup phase and a sensing measurement setup phase, the report type indication for different measurement instances corresponding to the one of the sensing session setup phase and the sensing measurement setup phase is identical.

7. The reporting communication apparatus according to claim 1, wherein the transmitter transmits the report frame immediately after a short interframe space of the received measurement signal.

8. The reporting communication apparatus according to claim 1, wherein the transmitter transmits the report frame at a time delay after the measurement signal is received, the time delay after the measurement signal is received being one of immediately after a short interframe space of a subsequently received measurement signal and in a subsequent transmission opportunity.

9. The reporting communication apparatus according to claim 1, wherein the transmitter/receiver further transmits/receives a sensing session setup request/response frame to/from an initiating communication apparatus during a sensing session setup phase to set a maximum time delay to transmit the report frame after the measurement signal is received, respectively.

10. The reporting communication apparatus according to claim 5, wherein the sub-component is the amplitude, the information of the sub-component of the CSI is encoded as an unsigned integer(s).

11. The reporting communication apparatus according to claim 1, wherein the information comprises a maximum absolute value of measured values of the sub-component of the CSI.

12. The reporting communication apparatus according to 1, wherein the information comprises a single matrix of values of the sub-component corresponding to a group of subcarriers which are grouped based on a grouping parameter, the grouping parameter having a value different from that for reporting a beamforming feedback matrix.

13. The reporting communication apparatus according to claim 4, wherein the frame is a null data packet announcement frame received immediately prior to the received measurement signal.

14. The reporting communication apparatus according to claim 13, wherein the frame carrying the report type indication is received during each measurement instance corresponding to a sensing measurement setup, and the report type indication for different CSI measurement instances corresponding to the sensing measurement setup phase is different.

15. The reporting communication apparatus according to claim 1, wherein the information of the sub-component comprises measured values of the sub-component of the CSI, the measured values being encoded using a base-2 numeral system.

16. The reporting communication apparatus according to claim 1, the receiver further receives a first frame and a second frame from an initiating communication apparatus, the first frame being received during one of a sensing session setup phase and a sensing measurement setup phase and carrying a coarse report type indication indicating whether a full CSI or a partial CSI is to be reported, the second frame carrying a fine report type indication indicating whether the full CSI being compressed/uncompressed or a sub-component of the partial CSI, respectively, wherein the transmitter transmits the report frame carrying information of the indicated compressed/uncompressed full CSI or the indicated sub-component of the partial CSI to the initiating communication apparatus, respectively.

17. The reporting communication apparatus according to claim 1, wherein the information of the sub-component is retrieved based on lookup tables.

18. The reporting communication apparatus according to claim 1, wherein the information comprises a parameter relating to a number of bits used to encode original values of the CSI of the received measurement signal.

19. The reporting communication apparatus according to claim 1, wherein the information comprises an index of a lookup table which corresponds to a measured value of the sub-component.

20. A reporting communication method comprising:
receiving a measurement signal;
measuring channel state information (CSI) of the received measurement signal; and
transmitting a report frame carrying information of a sub-component of the CSI.

21. An initiating communication apparatus comprising:
circuitry, which in operation, generates a frame carrying a report type indication indicating a sub-component of CSI to a reporting communication apparatus; and
a receiver, which in operation, receives a report frame carrying information of the sub-component of the CSI of a measurement signal from the reporting communication apparatus.

22. An initiating communication method comprising:
generating a frame carrying a report type indication indicating a sub-component of CSI to a reporting communication apparatus;
receiving a report frame carrying information of the sub-component of the CSI of a measurement signal from the reporting communication apparatus.
